(19) United States
(12) Patent Application Publication
(10) Pub. No.: US 2023/0254095 A1
(43) Pub. Date: Aug. 10, 2023

(54) METHOD AND DEVICE FOR HARQ-ACK TRANSMISSION IN WIRELESS COMMUNICATION SYSTEM

(71) Applicant: Samsung Electronics Co., Ltd., Suwon-si (KR)

(72) Inventors: Kyungjun CHOI, Suwon-si (KR); Hyoungju JI, Suwon-si (KR)

(21) Appl. No.: 18/167,563

(22) Filed: Feb. 10, 2023

(30) Foreign Application Priority Data
Feb. 10, 2022 (KR) 10-2022-0017264

(51) Int. Cl. H04L 5/00; H04L 1/1812

(52) U.S. Cl. CPC H04L 5/0055; H04L 1/1812

(57) ABSTRACT

A fifth generation (5G) or sixth generation (6G) communication system for supporting a higher data transmission rate and a method performed by a user equipment (UE) in a communication system are provided. The method includes receiving, from a base station, information on a list of timing values associated with a physical downlink shared channel (PDSCH) to hybrid automatic repeat request acknowledgement (HARQ-ACK), receiving a PDSCH from the base station, determining a set of slot timing values based on the information, wherein an inapplicable value in the list of timing values is excluded from the set of slot timing values, transmitting, to the base station, a physical uplink control channel (PUCCH) including a Type-1 HARQ-ACK codebook associated with the PDSCH based on the set of slot timing values.

### CROSS-REFERENCE TO RELATED APPLICATION(S)

This application is based on and claims priority under 35 U.S.C. § 119(a) of a Korean patent application number 10-2022-0017264, filed on Feb. 10, 2022, in the Korean Intellectual Property Office, the disclosure of which is incorporated by reference herein in its entirety.

### BACKGROUND

### 1. Field

The disclosure relates to operations of a terminal and a base station in a wireless communication system. Specifically, the disclosure relates to a hybrid automatic repeat request acknowledgement (HARQ-ACK) transmission method of, when a terminal receives multiple physical downlink shared channels via single piece of downlink control information, indicating whether the reception is successful, and a device capable of performing the same.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for schemes to effectively provide these services.

The above information is presented as background information only to assist with an understanding of the disclosure. No determination has been made, and no assertion is made, as to whether any of the above might be applicable as prior art with regard to the disclosure.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and a method capable of effectively providing a service in a mobile communication system.

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes receiving, from a base station, information on a list of timing values associated with a physical downlink shared channel (PDSCH) to hybrid automatic repeat request acknowledgement (HARQ-ACK), receiving a PDSCH from the base station, determining a set of slot timing values based on the information, wherein an inapplicable value in the list of timing values is excluded from the set of slot timing values, transmitting, to the base station, a physical uplink control channel (PUCCH) including a Type-1 HARQ-ACK codebook associated with the PDSCH based on the set of slot timing values.

In accordance with another aspect of the disclosure, a method performed by a base station in a communication system is provided. The method includes transmitting, to a user equipment (UE), information on a list of timing values associated with a physical downlink shared channel (PDSCH) to hybrid automatic repeat request acknowledgement (HARQ-ACK), transmitting a PDSCH to the UE, and receiving, from the UE, a physical uplink control channel (PUCCH) including a Type-1 HARQ-ACK codebook associated with the PDSCH based on the set of slot timing values based on the set of information, wherein an inapplicable value in the list of timing values is excluded from the set of slot timing values.

In accordance with another aspect of the disclosure, a user equipment (UE) in a communication system is provided. The UE includes a transceiver, and at least one processor configured to receive, from a base station, information on a list of timing values associated with a physical downlink shared channel (PDSCH) to hybrid automatic repeat request acknowledgement (HARQ-ACK), receive a PDSCH from the base station, determine a set of slot timing values based on the information, wherein an inapplicable value in the list of timing values is excluded from the set of slot timing values, and transmit, to the base station, a physical uplink control channel (PUCCH) including a Type-1 HARQ-ACK codebook associated with the PDSCH based on the set of slot timing values.

In accordance with another aspect of the disclosure, a base station in a communication system is provided. The base station includes a transceiver, and at least one processor configured to transmit, to a user equipment (UE), information on a list of timing values associated with a physical downlink shared channel (PDSCH) to hybrid automatic repeat request acknowledgement (HARQ-ACK), transmit a PDSCH to the UE, and receive, from the UE, a physical uplink control channel (PUCCH) including a Type-1 HARQ-ACK codebook associated with the PDSCH based on the set of slot timing values based on the set of information, wherein an inapplicable value in the list of timing values is excluded from the set of slot timing values.

Disclosed embodiments can provide a device and a method capable of efficiently providing a service in a mobile communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a basic structure of a time-frequency domain in a wireless communication system according to an embodiment of the disclosure;

FIG. 2 is a diagram illustrating a frame, a subframe, and a slot structure in the wireless communication system according to an embodiment of the disclosure;

FIG. 3 is a diagram illustrating an example of a bandwidth part configuration in the wireless communication system according to an embodiment of the disclosure;

FIG. 4 is a diagram illustrating an example of a control resource set configuration of a downlink control channel in the wireless communication system according to an embodiment of the disclosure;

FIG. 5 is a diagram illustrating a structure of a downlink control channel in the wireless communication system according to an embodiment of the disclosure;

FIG. 6 is a diagram for illustrating a method of transmitting or receiving data by a base station and a terminal in consideration of a downlink data channel and a rate matching resource in the wireless communication system according to an embodiment of the disclosure;

FIG. 7 is a diagram illustrating an example of frequency axis resource allocation of a physical downlink shared channel (PDSCH) in the wireless communication system according to an embodiment of the disclosure;

FIG. 8 is a diagram illustrating an example of time axis resource allocation of a PDSCH in the wireless communication system according to an embodiment of the disclosure;

FIG. 9 is a diagram illustrating an example of time axis resource allocation according to subcarrier spacings of a data channel and a control channel in the wireless communication system according to an embodiment of the disclosure;

FIG. 10 is a diagram illustrating radio protocol structures of a terminal and a base station in single cell, carrier aggregation, and dual connectivity situations in the wireless communication system according to an embodiment of the disclosure;

FIG. 11 is a diagram illustrating an example of scheduling one or more PDSCHs according to various embodiments of the disclosure;

FIG. 12 is a diagram illustrating DCI for single-PDSCH scheduling and multi-PDSCH scheduling according to various embodiments of the disclosure;

FIG. 13 is a diagram illustrating a method of transmitting HARQ-ACKs of multiple PDSCHs according to an embodiment of the disclosure;

FIG. 14 is a diagram illustrating an example for describing a pseudo-code for generating an HARQ-ACK codebook for a PDSCH received in one slot, according to various embodiments of the disclosure;

FIG. 15 is a diagram illustrating an example for describing a pseudo-code for generating an HARQ-ACK codebook for a PDSCH repeatedly received in multiple slots, according to various embodiments of the disclosure;

FIG. 16A is a diagram illustrating an example of describing PDSCHs based on a TDRA table including multiple pieces of scheduling information according to an embodiment of the disclosure;

FIG. 16B is a diagram illustrating an example for describing extension of K1 values according to consideration of single-PDSCH scheduling for PDSCHs based on a TDRA table including multiple pieces of scheduling information, according to an embodiment of the disclosure;

FIG. 16C is a diagram illustrating another example for describing a pseudo-code for generating an HARQ-ACK codebook according to an embodiment of the disclosure;

FIG. 16D is a diagram illustrating another example for describing a pseudo-code for generating an HARQ-ACK codebook according to an embodiment of the disclosure;

FIG. 17 is a diagram illustrating an example for describing a pseudo-code for generating an HARQ-ACK codebook by configuring/applying time-domain bundling for PDSCHs repeatedly received in multiple slots, according to various embodiments of the disclosure;

FIG. 18 is a diagram illustrating that a terminal transmits, via an uplink, HARQ-ACK information indicating successful reception of a PDSCH according to an embodiment of the disclosure;

FIG. 19 is a diagram illustrating that a terminal receives multiple PDSCHs scheduled in multiple DCI formats according to an embodiment of the disclosure;

FIG. 20 is a diagram illustrating type-3 HARQ-ACK codebook transmission of a terminal configured with a downlink serving cell (DL CC) and an uplink serving cell (UL CC) according to an embodiment of the disclosure;

FIG. 21 is a diagram illustrating enhanced type-3 HARQ-ACK codebook transmission of a terminal, in which an enhanced type-3 HARQ-ACK codebook is configured according to an embodiment of the disclosure;

FIG. 22 is a diagram illustrating a procedure of generating a Type-1 HARQ-ACK codebook if a non-numerical K1 value is included in set K1 according to various embodiments of the disclosure;

FIG. 23 is a diagram illustrating an operation of a terminal according to an embodiment of the disclosure;

FIG. 24 is a diagram illustrating a structure of a terminal in the wireless communication system according to an embodiment of the disclosure; and

FIG. 25 is a diagram illustrating a structure of a base station in the wireless communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Furthermore, in the following description, long term evolution (LTE) or long term evolution advanced (LTE-A) systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the embodiments of the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Further, in the embodiments, the “unit” may include one or more processors.

A wireless communication system is advancing to a broadband wireless communication system for providing high-speed and high-quality packet data services using communication standards, such as high-speed packet access (HSPA) of third generation partnership project (3GPP), LTE {long-term evolution or evolved universal terrestrial radio access (E-UTRA)}, LTE-Advanced (LTE-A), LTE-Pro, high-rate packet data (HRPD) of 3GPP2, ultra-mobile broadband (UMB), Institute of Electrical and Electronics Engineers (IEEE) 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) {or a mobile station (MS)} transmits data or control signals to a base station (BS) (eNode B), and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

First of all, eMBB aims at providing a data rate higher than that supported by existing LTE, LTE-A, or LTE-Pro. For example, in the 5G communication system, eMBB must provide a peak data rate of 20 gigabits per second (Gbps) in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 megahertz (MHz) in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time, such as 10 to 15 years, because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and may also require a design for assigning a large number of resources in a frequency band in order to secure reliability of a communication link.

Three services in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. Of course, the 5G is not limited to the above-described three services.

[NR Time-Frequency Resources]

Hereinafter, a frame structure of a 5G system will be described in more detail with reference to the drawings.

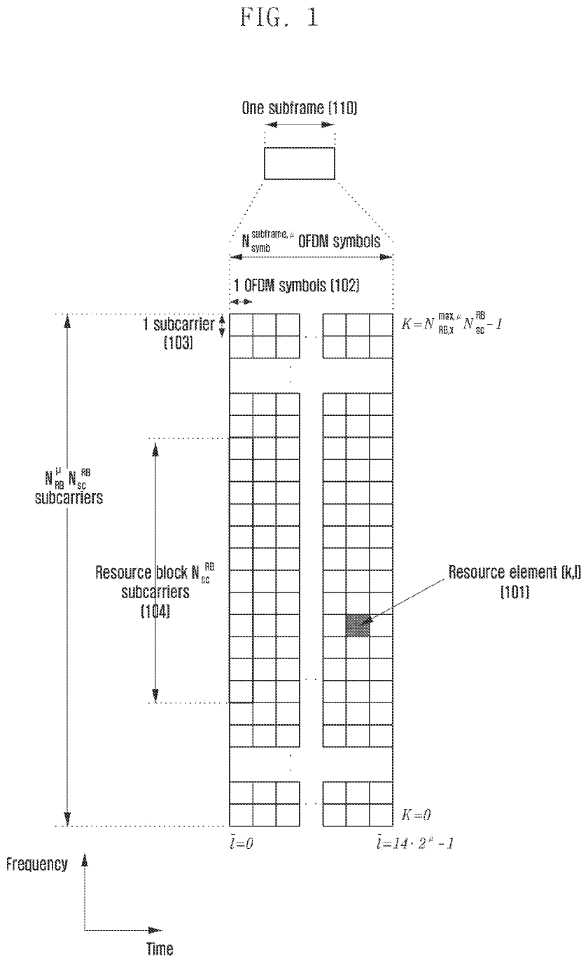

FIG. 1 is a diagram illustrating a basic structure of a time-frequency domain that is a radio resource area in which data or a control channel is transmitted in a 5G system according to an embodiment of the disclosure.

Referring to FIG. 1, a horizontal axis represents a time domain, and a vertical axis represents a frequency domain. A basic unit of a resource in the time and frequency domains is a resource element (RE) 101, and may be defined to be 1 orthogonal frequency division multiplexing (OFDM) symbol 102 on the time axis and 1 subcarrier 103 on the frequency axis. N_{K}^{RB} (e.g., 12) consecutive REs in the frequency domain may constitute one resource block (RB) 104. One subframe 110 may comprise a plurality of OFDM symbols on the time axis.

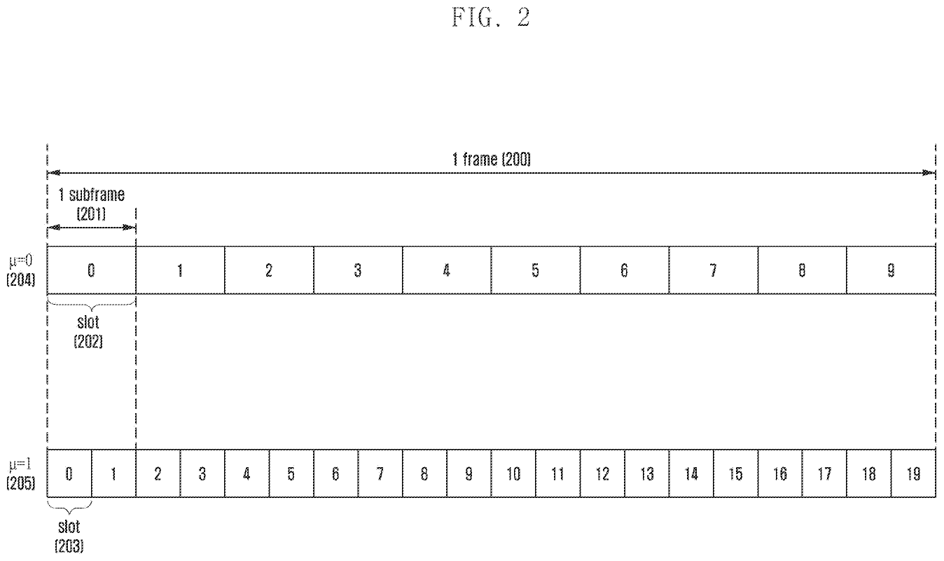

FIG. 2 is a diagram illustrating a frame, a subframe, and a slot structure in the wireless communication system according to an embodiment of the disclosure.

FIG. 2 illustrates an example of a frame 200, a subframe 201, and a slot 202 structure. One frame 200 may be defined to be 10 ms. One subframe 201 may be defined to be 1 ms, and thus one frame 200 may include a total of 10 subframes 201. One slot 202 or 203 may be defined to be 14 OFDM symbols (that is, the number of slot symbols per slot (N_{symb}^{slot})=14). One subframe 201 may include one or multiple slots 202 and 203, the number of slots 202 and 203 per subframe 201 may vary according to a configuration value μ 204 or 205 for a subcarrier spacing. An example of FIG. 2 illustrates a case 204 where μ=0 and a case 205 where μ=1, for subcarrier spacing configuration values. In the case 204 where μ=0, one subframe 201 may include one slot 202, and in the case 205 where μ=1, one subframe 201 may include two slots 203. That is, the number (Nₛₗₒₜ^{subframe,μ}) of slots per subframe may vary according to configuration value μ for a subcarrier spacing, and accordingly, the number (Nₛₗₒₜ^{frame,μ}) of slots per frame may vary. Nₛₗₒₜ^{subframe,μ} and Nₛₗₒₜ^{frame,μ} according to respective subcarrier spacing configurations μ may be defined in Table 1 below.

TABLE 1

| μ | N_{sy mb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

[Bandwidth Part (BWP)]

Subsequently, a bandwidth part (BWP) configuration in the 5G communication system will be described in detail with reference to the drawings.

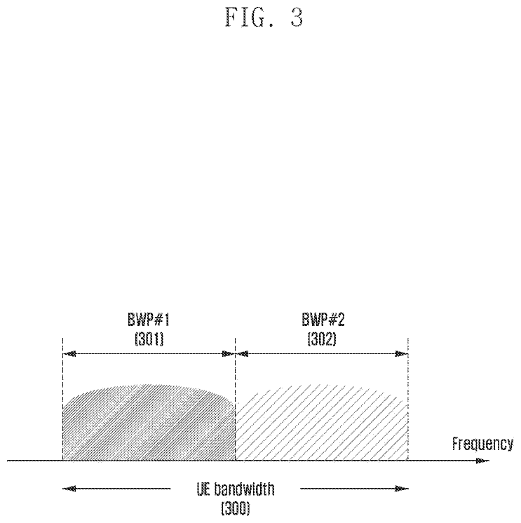

FIG. 3 is a diagram illustrating an example of a bandwidth part configuration in the wireless communication system according to an embodiment of the disclosure.

FIG. 3 shows an example in which a terminal bandwidth (UE bandwidth) 300 is configured to have two bandwidth parts that are bandwidth part #1 301 and bandwidth part #2 302. A base station may configure one or multiple bandwidth parts for a terminal, and may configure, for each bandwidth part, information as shown in Table 2 below.

TABLE 2

| | |
|---|---|
| BWP ::= | SEQUENCE { |
| bwp-Id | BWP-Id, |
| (Bandwidth part identifier) | |
| locationAndBandwidth | INTEGER |
| (1..65536), | |
| (Bandwidth part position) | |
| subcarrierSpacing | ENUMERATED {n0, |
| n1, n2, n3, n4, n5}, | |
| (Subcarrier spacing) | |
| cyclicPrefix | ENUMERATED { |
| extended } | |
| (Cyclic prefix) | |
| } | |

The disclosure is not limited to the above example, and in addition to the configuration information, various parameters related to a bandwidth part may be configured for the terminal. The base station may deliver the information to the terminal via higher layer signaling, for example, radio resource control (RRC) signaling. At least one bandwidth part among the configured one or multiple bandwidth parts may be activated. Whether the configured bandwidth part is active may be delivered from the base station to the terminal in a semi-static manner via RRC signaling or may be dynamically delivered via downlink control information (DCI).

According to some embodiments, the base station may configure an initial bandwidth part (BWP) for initial access, via a master information block (MIB), for the terminal before an RRC connection. More specifically, in an initial access stage, the terminal may receive configuration information for a search space and a control area (control resource set (CORESET)) in which a physical downlink control channel (PDCCH) for receiving system information (which may correspond to remaining system information (RMSI) or system information block 1 (SIB1)) required for initial access may be transmitted via the MIB. Each of the search space and the control resource set configured via the MIB may be considered to be identity (ID) 0. The base station may notify the terminal of configuration information, such as frequency allocation information, time allocation information, and numerology for control resource set #0, via the MIB. In addition, the base station may notify, via the MIB, the terminal of configuration information for a monitoring period and occasion for control resource set #0, that is, configuration information for search space #0. The terminal may consider a frequency domain configured to be control resource set #0, which is obtained from the MIB, as an initial bandwidth part for initial access. In this case, an identity (ID) of the initial bandwidth part may be considered to be 0.

The configuration of a bandwidth part supported by 5G may be used for various purposes.

According to some embodiments, if a bandwidth supported by the terminal is smaller than a system bandwidth, this may be supported via the bandwidth part configuration. For example, the base station may configure, for the terminal, a frequency position (configuration information 2) of the bandwidth part, and the terminal may thus transmit or receive data at a specific frequency position within the system bandwidth.

According to some embodiments, for the purpose of supporting different numerologies, the base station may configure multiple bandwidth parts for the terminal. For example, in order to support both data transmission or reception using a subcarrier spacing of 15 kHz and a subcarrier spacing of 30 kHz for a certain terminal, two bandwidth parts may be configured with subcarrier spacings of 15 kHz and 30 kHz, respectively. Different bandwidth parts may be frequency-division-multiplexed, and when data is to be transmitted or received at a specific subcarrier spacing, a bandwidth part configured with the subcarrier spacing may be activated.

According to some embodiments, for the purpose of reducing power consumption of the terminal, the base station may configure, for the terminal, bandwidth parts having different bandwidth sizes. For example, if the terminal supports a very large bandwidth, for example, 100 MHz, and always transmits or receives data via the corresponding bandwidth, very large power consumption may occur. In particular, in a situation where there is no traffic, it may be very inefficient, in terms of power consumption, to perform monitoring for an unnecessary downlink control channel with a large bandwidth of 100 MHz. For the purpose of reducing the power consumption of the terminal, the base station may configure, for the terminal, a bandwidth part of a relatively small bandwidth, for example, a bandwidth part of 20 MHz. In the situation where there is no traffic, the terminal may perform monitoring in the bandwidth part of 20 MHz, and when data is generated, the terminal may transmit or receive the data by using the bandwidth part of 100 MHz according to an indication of the base station.

In the method for configuring the bandwidth part, terminals before an RRC connection may receive configuration information for an initial bandwidth part via a master information block (MIB) during initial access. More specifically, a terminal may be configured with a control resource set (CORESET) for a downlink control channel via which downlink control information (DCI) for scheduling of a system information block (SIB) may be transmitted from an MIB of a physical broadcast channel (PBCH). The bandwidth of the control resource set, which is configured via the MIB, may be considered to be the initial bandwidth part, and the terminal may receive a physical downlink shared channel (PDSCH), through which the SIB is transmitted, via the configured initial bandwidth part. In addition to the purpose of receiving the SIB, the initial bandwidth part may be used for other system information (OSI), paging, and random access.

[Change of Bandwidth Part (BWP)]

When one or more bandwidth parts are configured for the terminal, the base station may indicate the terminal to change (or switch or shift) a bandwidth part, by using a bandwidth part indicator field in DCI. For example, in FIG. 3, if a currently active bandwidth part of the terminal is bandwidth part #1 301, the base station may indicate bandwidth part #2 302 to the terminal by using the bandwidth part indicator in the DCI, and the terminal may switch the bandwidth part to bandwidth part #2 302 indicated using the bandwidth part indicator in the received DCI.

As described above, the DCI-based switching of the bandwidth part may be indicated by the DCI for scheduling of a PDSCH or physical uplink shared channel (PUSCH), and therefore when a request for switching a bandwidth part is received, the terminal may need to receive or transmit the PDSCH or PUSCH scheduled by the corresponding DCI, with ease in the switched bandwidth part. To this end, requirements for a delay time (TBWP) required when a bandwidth part is switched are regulated in the standards, and may be defined as shown in Table 3, for example.

TABLE 3

| | | BWP switch delay T_{BWP} (slots) | |
|---|---|---|---|
| μ | NR Slot length (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 18 |

Note 1: Depends on UE capability.
Note 2: If the BWP switch involves changing of SCS, the BWP switch delay is determined by the larger one between the SCS before BWP switch and the SCS after BWP switch.

The requirements for a bandwidth part switch delay time support type 1 or type 2 according to capability of the terminal. The terminal may report a supportable bandwidth part delay time type to the base station.

According to the aforementioned requirements for the bandwidth part switch delay time, when the terminal receives DCI including the bandwidth part switch indicator in slot n, the terminal may complete switching to a new bandwidth part indicated by the bandwidth part switch indicator at a time point no later than slot n+T_{BWP}, and may perform transmission or reception for a data channel scheduled by the corresponding DCI in the switched new bandwidth part. When the base station is to schedule a data channel with a new bandwidth part, time domain resource allocation for the data channel may be determined by considering the bandwidth part switch delay time (T_{BWP}) of the terminal. That is, in a method of determining time domain resource allocation for a data channel when the base station schedules the data channel with a new bandwidth part, scheduling of the data channel may be performed after a bandwidth part switch delay time. Accordingly, the terminal may not expect that DCI indicating bandwidth part switching indicates a slot offset (K0 or K2) value smaller than a value of the bandwidth part switch delay time (T_{BWP}).

If the terminal receives DCI (for example, DCI format 1_1 or 0_1) indicating bandwidth part switching, the terminal may not perform any transmission or reception during a time interval from a third symbol of a slot in which a PDCCH including the DCI is received to a start point of a slot indicated by a slot offset (K0 or K2) value indicated using a time domain resource allocation indicator field in the DCI. For example, when the terminal receives the DCI indicating bandwidth part switching in slot n, and a slot offset value indicated by the DCI is K, the terminal may not perform any transmission or reception from a third symbol of slot n to a symbol (i.e., the last symbol in slot n+K−1) before slot n+K.

[SS/PBCH Block]

In the following, a synchronization signal (SS)/PBCH block in 5G will be described.

The SS/PBCH block may refer to a physical layer channel block including a primary SS (PSS), a secondary SS (SSS), and a PBCH. Detailed descriptions are as follows.
PSS: A PSS is a signal that serves as a reference for downlink time/frequency synchronization, and provides some information of a cell ID.
SSS: An SSS serves as a reference for downlink time/frequency synchronization, and provides the remaining cell ID information that is not provided by a PSS. Additionally, the SSS may serve as a reference signal for demodulation of a PBCH.
PBCH: A PBCH provides essential system information necessary for transmission or reception of a data channel and a control channel of a terminal. The essential system information may include search space-related control information indicating radio resource mapping information of a control channel, scheduling control information on a separate data channel for transmission of system information, and the like.
SS/PBCH block: An SS/PBCH block includes a combination of a PSS, an SSS, and a PBCH. One or multiple SS/PBCH blocks may be transmitted within 5 ms, and each transmitted SS/PBCH block may be distinguished by an index.

A terminal may detect a PSS and an SSS in an initial access stage and may decode a PBCH. An MIB may be obtained from the PBCH, and control resource set (CORESET) #0 (which may correspond to a control resource set having a control resource set index of 0) may be configured from the MIB. The terminal may perform monitoring on control resource set #0 while assuming that a selected SS/PBCH block and a demodulation reference signal (DMRS) transmitted in control resource set #0 are quasi co-located (QCL). The terminal may receive system information as downlink control information transmitted in control resource set #0. The terminal may acquire, from the received system information, random-access channel (RACH)-related configuration information required for initial access. The terminal may transmit a physical RACH (PRACH) to the base station in consideration of the selected SS/PBCH index, and the base station having received the PRACH may acquire information on the SS/PBCH block index selected by the terminal. The base station may identify a block that the terminal has selected from among respective SS/PBCH blocks and may identify that control resource set #0 associated with the selected block is monitored.

[PDCCH: Related to DCI]

Subsequently, downlink control information (DCI) in the 5G system will be described in detail.

In the 5G system, scheduling information on uplink data (or physical uplink data channel (PUSCH)) or downlink data (or physical downlink data channel (PDSCH)) is delivered from the base station to the terminal via DCI. The terminal may monitor a DCI format for fallback and a DCI format for non-fallback with respect to a PUSCH or a PDSCH. The fallback DCI format may include a fixed field predefined between the base station and the terminal, and the non-fallback DCI format may include a configurable field.

DCI may be transmitted through a physical downlink control channel (PDCCH) via channel coding and modulation. A cyclic redundancy check (CRC) is attached to a DCI message payload, and may be scrambled with a radio network temporary identifier (RNTI) corresponding to an identity of the terminal. Different RNTIs may be used according to a purpose of the DCI message, for example, terminal-specific (UE-specific) data transmission, a power control command, a random access response, etc. That is, the RNTI is not explicitly transmitted, but is included in CRC calculation so as to be transmitted. When the DCI message transmitted on a PDCCH is received, the terminal performs a CRC check by using an assigned RNTI and determines, if the CRC check succeeds, that the message is addressed to the terminal.

For example, DCI for scheduling of a PDSCH for system information (SI) may be scrambled with an SI-RNTI. DCI for scheduling of a PDSCH for a random access response (RAR) message may be scrambled with an RA-RNTI. DCI for scheduling of a PDSCH for a paging message may be scrambled with a P-RNTI. DCI for notification of a slot format indicator (SFI) may be scrambled with an SFI-RNTI. DCI for notification of a transmit power control (TPC) may be scrambled with a TPC-RNTI. DCI for scheduling of a UE-specific PDSCH or PUSCH may be scrambled with a cell RNTI (C-RNTI).

DCI format 0_0 may be used for fallback DCI for scheduling of a PUSCH, in which a CRC may be scrambled with a C-RNTI. DCI format 0_0 in which a CRC is scrambled with a C-RNTI may include, for example, the following information.

TABLE 4
Identifier for DCI formats (DCI format identifier)-[1] bit
Frequency domain resource assignment-
[┌log₂(N_{RB}^{UL,BWP} (N_{RB}^{UL,BWP} + 1)/2┐] bits
Time domain resource assignment-X bits
Frequency hopping flag-1 bit.
Modulation and coding scheme-5 bits
New data indicator-1 bit
Redundancy version-2 bits
HARQ process number-4 bits
Transmit power control (TPC) command for scheduled PUSCH-[2] bits
Uplink (UL)/supplementary UL (SUL) indicator-0 or 1 bit

DCI format 0_1 may be used for non-fallback DCI for scheduling of a PUSCH, in which a CRC may be scrambled with a C-RNTI. DCI format 0_1 in which a CRC is scrambled with a C-RNTI may include, for example, information in Table 5.

```
TABLE 5
Carrier indicator - 0 or 3 bits
UL/SUL indicator - 0 or 1 bit
Identifier for DCI formats - [1] bits
Bandwidth part indicator - 0, 1 or 2 bits
Frequency domain resource assignment
  For resource allocation type 0, ┌N_{RB}^{UL,BWP}/P┐ bits
  For resource allocation type 1,
  ┌log₂ (N_{RB}^{UL,BWP} (N_{RB}^{UL,BWP} +1)/2)┐ bits
Time domain resource assignment −1, 2, 3, or 4 bits
Virtual resource block (VRB)-to-physical resource block (PRB) mapping -
0 or 1 bit, only for resource allocation type 1.
  0 bit if only resource allocation type 0 is configured;
  1 bit otherwise.
Frequency hopping flag - 0 or 1 bit, only for resource allocation type 1.
  0 bit if only resource allocation type 0 is configured;
  1 bit otherwise.
Modulation and coding scheme - 5 bits
New data indicator - 1 bit
Redundancy version - 2 bits
HARQ process number - 4 bits
1st downlink assignment index - 1 or 2 bits
  1 bit for semi-static HARQ-ACK codebook;
  2 bits for dynamic HARQ-ACK codebook with single HARQ-ACK
    codebook.
2nd downlink assignment index - 0 or 2 bits
  2 bits for dynamic HARQ-ACK codebook with two HARQ-ACK sub-
    codebooks;
  0 bit otherwise.
TPC command for scheduled PUSCH - 2 bits
SRS resource indicator - $⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{S R S} ) ⌉$
bits
  $⌈ {log}_{2} ( {\sum }_{k = 1}^{{L}_{max}} ( \begin{matrix}{N}_{S R S} \\ k\end{matrix} ) ) ⌉$
  bits for non-codebook based PUSCH transmission;
  ┌log2 (N_{SRS})┐ bits for codebook based PUSCH transmission.
Precoding information and number of layers -up to 6 bits
Antenna ports - up to 5 bits
SRS request - 2 bits
Channel state information (CSI) request - 0, 1, 2, 3, 4, 5, or 6 bits
Code block group (CBG) transmission information- 0, 2, 4, 6, or 8 bits
Code block group (CBG) transmission information - 0 or 2 bits.
beta_offset indicator - 0 or 2 bits
  Demodulation reference signal (DMRS) sequence initialization - 0 or
1 bit
```

DCI format 1_0 may be used for fallback DCI for scheduling of a PDSCH, in which a CRC may be scrambled with a C-RNTI. DCI format 1_0 in which a CRC is scrambled with a C-RNTI may include, for example, information in Table 6.

TABLE 6
Identifier for DCI formats-[1] bit
Frequency domain resource assignment-
[┌log₂(N_{RB}^{DL,BWP} (N_{RB}^{DL,BWP} + 1)/2┐] bits
Time domain resource assignment-X bits
VRB-to-PRB mapping-1 bit.
Modulation and coding scheme-5 bits
New data indicator-1 bit
Redundancy version-2 bits
HARQ process number-4 bits
Downlink assignment index-2 bits
TPC command for scheduled physical uplink control channel
(PUCCH)-[2]bits
Physical uplink control channel (PUCCH) resource indicator-3 bits
PDSCH-to-HARQ feedback timing indicator-[3] bits

DCI format 1_1 may be used for non-fallback DCI for scheduling of a PDSCH, in which a CRC may be scrambled with a C-RNTI. DCI format 1_1 in which a CRC is scrambled with a C-RNTI may include, for example, information in Table 7.

```
TABLE 7
Carrier indicator-0 or 3 bits
Identifier for DCI formats-[1] bits
Bandwidth part indicator-0, 1 or 2 bits
Frequency domain resource assignment
  For resource allocation type 0, ┌N_{RB}^{DL,BWP}/P┐ bits
  For resource allocation type 1, ┌log₂(N_{RB}^{DL,BWP} (N_{RB}^{DL,BWP} + 1)/2┐] bits
Time domain resource assignment -1, 2, 3, or 4 bits
VRB-to-PRB mapping-0 or 1 bit, only for resource allocation type 1.
  0 bit if only resource allocation type 0 is configured;
  1 bit otherwise.
Physical resource block (PRB) bundling size indicator-0 or 1 bit
Rate matching indicator-0, 1, or 2 bits
Zero power channel state information reference signal (ZP CSI-RS)
trigger-0, 1, or 2 bits
For transport block 1 (for first transport block):
  Modulation and coding scheme-5 bits
  New data indicator-1 bit
  Redundancy version-2 bits
For transport block 2 (for second transport block):
  Modulation and coding scheme-5 bits
  New data indicator-1 bit
Redundancy version-2 bits
HARQ process number-4 bits
Downlink assignment index-0 or 2 or 4 bits
TPC command for scheduled PUCCH-2 bits
PUCCH resource indicator-3 bits
PDSCH-to-HARQ_feedback timing indicator-3 bits
Antenna ports-4, 5 or 6 bits
Transmission configuration indication-0 or 3 bits
SRS request-2 bits
CBG transmission information-0, 2, 4, 6, or 8 bits
Code block group (CBG) flushing out information-0 or 1 bit
  DMRS sequence initialization-1 bit
```

[PDCCH: CORESET, REG, CCE, Search Space]

Hereinafter, a downlink control channel in the 5G communication system will be described in more detail with reference to the drawings.

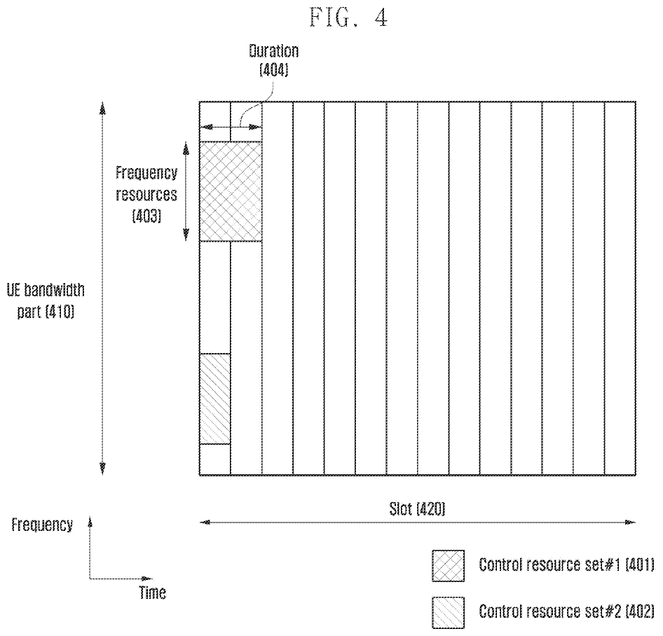

FIG. 4 is a diagram illustrating an example of a control resource set (control resource set (CORESET)) in which a downlink control channel is transmitted in the 5G wireless communication system according to an embodiment of the disclosure.

FIG. 4 illustrates an example in which a terminal bandwidth part 410 (UE bandwidth part) is configured on the frequency axis, and two control resource sets (control resource set #1 401 and control resource set #2 402) are configured within one slot 420 on the time axis. The control resource sets 401 and 402 may be configured in a specific frequency resource 403 within the entire terminal bandwidth part 410 on the frequency axis. One or multiple OFDM symbols may be configured on the time axis and may be defined as a control area duration (control resource set duration) 404. Referring to the example illustrated in FIG. 4, control resource set #1 401 is configured to have a control resource set duration of 2 symbols, and control resource set #2 402 is configured to have a control resource set duration of 1 symbol.

The aforementioned control resource set in 5G may be configured for the terminal by the base station via higher layer signaling (e.g., system information, a master information block (MIB), and radio resource control (RRC) signaling). Configuring the control resource set for the terminal may refer to providing information, such as an identifier (identity) of the control resource set, a frequency position of the control resource set, and a symbol length of the control resource set. For example, information in Table 8 below may be included.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(Control resource set identity)

| | |
|---|---|
| frequencyDomainResources | BIT STRING (SIZE (45)), |

(Frequency axis resource allocation information)

| | |
|---|---|
| duration | INTEGER (1..maxCoReSetDuration), |

(Time axis resource allocation information)

| | |
|---|---|
| cce-REG-MappingType | CHOICE { |

(CCE-to-REG mapping scheme)

| | |
|---|---|
| interleaved | SEQUENCE { |
| reg-BundleSize | ENUMERATED {n2, n3, n6}, |
| (REG bundle size) | |
| precoderGranularity | ENUMERATED {sameAsREG- |
| bundle, allContiguousRBs}, | |
| interleaverSize | ENUMERATED {n2, n3, |
| n6} | |
| (Interleaver size) | |
| shiftIndex | |

INTEGER(0..maxNrofPhysicalResourceBlocks-

| | |
|---|---|
| 1) | OPTIONAL |
| (Interleaver shift) | |
| }, | |
| nonInterleaved | NULL |
| }, | |
| tci-StatesPDCCH | SEQUENCE(SIZE |

(1..maxNrofTCI-StatesPDCCH)) OF TCI-StateId

OPTIONAL,

(QCL configuration information)

| | |
|---|---|
| tci-PresentInDCI | ENUMERATED |
| {enabled} | OPTIONAL, |
| -- Need S | |
| } | |

In Table 8, tci-StatesPDCCH (simply, referred to as a transmission configuration indication (TCI) state) configuration information may include information on one or multiple synchronization signal (SS)/physical broadcast channel (PBCH) block indices or channel state information reference signal (CSI-RS) indices having the quasi co-location (QCL) relationship with a DMRS transmitted in the corresponding control resource set.

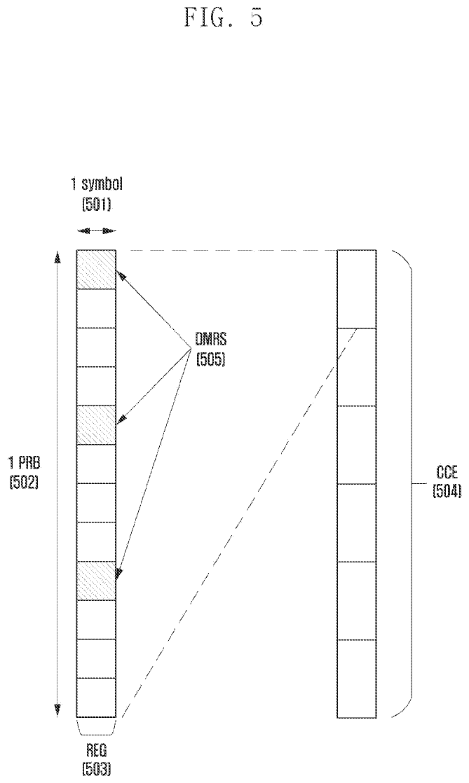

FIG. 5 is a diagram showing an example of a basic unit of time and frequency resources constituting a downlink control channel which may be used in 5G according to an embodiment of the disclosure.

Referring to FIG. 5, a basic unit of time and frequency resources constituting a control channel is referred to as a resource element group (REG) 503, and an REG 503 may be defined to have 1 OFDM symbol 501 on the time axis and 1 physical resource block (PRB) 502, that is, 12 subcarriers, on the frequency axis. A base station may configure a downlink control channel allocation unit by concatenation with the REG 503.

As illustrated in FIG. 5, when a basic unit for allocation of a downlink control channel in 5G is a control channel element (CCE) 504, 1 CCE 504 may include multiple REGs 503. When the REG 503 illustrated in FIG. 5 is described as an example, the REG 503 may include 12 Res, and if 1 CCE 504 includes 6 REGs 503, 1 CCE 504 may include 72 Res. When a downlink control resource set is configured, the corresponding area may include multiple CCEs 504, and a specific downlink control channel may be mapped to one or multiple CCEs 504 so as to be transmitted according to an aggregation level (AL) within the control resource set. The CCEs 504 within the control resource set are classified by numbers, and the numbers of the CCEs 504 may be assigned according to a logical mapping scheme.

The basic unit of the downlink control channel illustrated in FIG. 5, that is, the REG 503, may include both Res, to which DCI is mapped, and an area, to which a DMRS 505 that is a reference signal for decoding the Res, is mapped. As shown in FIG. 5, 3 DMRSs 505 may be transmitted in 1 REG 503. The number of CCEs required to transmit a PDCCH may be 1, 2, 4, 8, or 16 depending on the aggregation level (AL), and different numbers of CCEs may be used to implement link adaptation of the downlink control channel. For example, if AL=L, one downlink control channel may be transmitted via the L number of CCEs. A terminal needs to detect a signal without knowing information on the downlink control channel, wherein a search space representing a set of CCEs is defined for blind decoding. The search space is a set of downlink control channel candidates including CCEs, for which the terminal needs to make an attempt of decoding on a given aggregation level. Since there are various aggregation levels that make one bundle with 1, 2, 4, 8, or 16 CCEs, the terminal may have multiple search spaces. A search space set may be defined as a set of search spaces at all configured aggregation levels.

The search space may be classified into a common search space and a terminal-specific (UE-specific) search space. A certain group of terminals or all terminals may monitor a common search space of a PDCCH in order to receive cell-common control information, such as a dynamic scheduling or paging message for system information. For example, PDSCH scheduling assignment information for transmission of an SIB including cell operator information, etc. may be received by monitoring the common search space of a PDCCH. In a case of the common search space, the certain group of terminals or all terminals need to receive a PDCCH, and may thus be defined as a set of previously agreed CCEs. Scheduling assignment information for a UE-specific PDSCH or PUSCH may be received by monitoring a UE-specific search space of a PDCCH. The UE-specific search space may be defined UE-specifically, based on an identity of the terminal and functions of various system parameters.

In 5G, a parameter for the search space of the PDCCH may be configured from the base station to the terminal via higher layer signaling (e.g., SIB, MIB, and RRC signaling). For example, the base station may configure, to the terminal, the number of PDCCH candidates at each aggregation level L, a monitoring period for a search space, a monitoring occasion in units of symbols in the slot for the search space, a search space type (common search space or UE-specific search space), a combination of an RNTI and a DCI format, which is to be monitored in the search space, a control resource set index for monitoring of the search space, etc. For example, information in Table 9 below may be included.

TABLE 9

| | |
|---|---|
| SearchSpace ::= | SEQUENCE { |

```
    -- Identity of the search space. SearchSpaceId = 0 identifies the SearchSpace
        configured via PBCH (MIB) or ServingCellConfigCommon.
```

| | |
|---|---|
| searchSpaceId | SearchSpaceId, |
| (earch space identity) | |
| controlResourceSetId | ControlResourceSetId, |
| (Control resource set identity) | |
| monitoringSlotPeriodicityAndOffset | CHOICE { |
| (Monitoring slot level period) | |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |
| } | |
| | OPTIONAL, |
| duration(monitoring duration) | INTEGER (2..2559) |
| monitoringSymbolsWithinSlot | BIT STRING (SIZE |
| (14)) | OPTIONAL, |
| (Monitoring symbol in slot) | |
| nrofCandidates | SEQUENCE { |

(The number of PDCCH candidates for each aggregation level)

| | |
|---|---|
| aggregationLevel1 | ENUMERATED {n0, n1, n2, n3, n4, |
| n5, n6, n8}, | |
| aggregationLevel2 | ENUMERATED {n0, n1, n2, n3, n4, |
| n5, n6, n8}, | |
| aggregationLevel4 | ENUMERATED {n0, n1, n2, n3, n4, |
| n5, n6, n8}, | |
| aggregationLevel8 | ENUMERATED {n0, n1, n2, n3, n4, |
| n5, n6, n8}, | |
| aggregationLevel16 | ENUMERATED {n0, n1, n2, n3, n4, |
| n5, n6, n8} | |
| }, | |
| searchSpaceType | CHOICE { |
| (Search space type) | |

```
        -- Configures this search space as common search space (CSS) and DCI
        formats to monitor.
```

| | |
|---|---|
| Common | SEQUENCE { |
| (Common search space) | |
| } | |
| ue-Specific | SEQUENCE { |
| (UE-specific search space) | |

```
          -- Indicates whether the UE monitors in this USS for DCI formats 0-0 and
        1-0 or for formats 0-1 and 1-1.
```

| | |
|---|---|
| Formats | ENUMERATED {formats0-0- |
| And-1-0, formats0-1-And-1-1}, | |
| ... | |
| } | |

According to configuration information, the base station may configure one or multiple search space sets for the terminal. According to some embodiments, the base station may configure search space set 1 and search space set 2 to the terminal, may configure DCI format A, which is scrambled with X-RNTI in search space set 1, to be monitored in the common search space, and may configure DCI format B, which is scrambled with Y-RNTI in search space set 2, to be monitored in the UE-specific search space.

According to the configuration information, one or multiple search space sets may exist in the common search space or the UE-specific search space. For example, search space set #1 and search space set #2 may be configured to be a common search space, and search space set #3 and search space set #4 may be configured to be a UE-specific search space.

In the common search space, the following combinations of DCI formats and RNTIs may be monitored. Of course, the disclosure is not limited to the following examples.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the following combinations of DCI formats and RNTIs may be monitored. Of course, the disclosure is not limited to the following examples.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The RNTIs specified above may comply with the following definition and purpose.

Cell RNTI (C-RNTI): For UE-specific PDSCH scheduling

Temporary cell RNTI (TC-RNTI): For UE-specific PDSCH scheduling

Configured scheduling RNTI (CS-RNTI): For semi-statically configured UE-specific PDSCH scheduling

Random-Access RNTI (RA-RNTI): For PDSCH scheduling during random-access

Paging RNTI (P-RNTI): For scheduling PDSCH on which paging is transmitted

System Information RNTI (SI-RNTI): For scheduling PDSCH on which system information is transmitted

Interruption RNTI (INT-RNTI): Used for indicating whether to puncture PDSCH

Transmit power control for PUSCH RNTI (TPC-PUSCH-RNTI): Used for indicating power control command for PUSCH

Transmit power control for PUCCH RNTI (TPC-PUCCH-RNTI): Used for indicating power control command for PUCCH

Transmit power control for SRS RNTI (TPC-SRS-RNTI): Used for indicating power control command for SRS

The aforementioned DCI formats may conform to the following definition as in the example of Table 10.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands |
| | for SRS transmissions by one or more UEs |

In 5G, a search space of aggregation level L in search space set s, and control resource set p may be expressed as Equation 1 below.

$$L \cdot \{ {y}_{p , {n}_{s f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equation 1$$

L: aggregation level
n_{CI}: carrier index
N_{CCE,p}: the total number of CCEs existing in control resource set p
n_{s,f}^{μ}: slot index
PM_{s,max}^{(L)}: the number of PDCCH candidates for aggregation level L
m_{s,n}_{_{CI}}=0, . . . , M_{s,max}^{(L)}−1: PDCCH candidate index of aggregation level L

i=0, . . . , L−1
Y_{p,n}_{_{s,f}}_{^{μ}}=(Aₚ·Y_{p,n}_{_{s,f}}₋₁_{^{μ}})mod D, Y_{p,-1}=n_{RNTI}≠0, Aₚ=39827 for pmod3=0, Aₚ=39829 for pmod3=1, Aₚ=39839 for pmod3=2, and D=65537
n_{RNTI}: UE identifier

A value of Y_{p,n}_{_{s,f}}_{^{μ}} may correspond to 0 in the common search space.

In the UE-specific search space, a value of Y_{p,n}_{_{s,f}}_{^{μ}} may correspond to a value that varies depending on a time index and the identity (ID configured for the terminal by the base station or C-RNTI) of the terminal.

In 5G, multiple search space sets may be configured by different parameters (e.g., parameters in Table 9), and therefore a set of search spaces monitored by the terminal at each time point may vary. For example, if search space set #1 is configured with an X-slot period, search space set #2 is configured with a Y-slot period, and X and Y are thus different from each other, the terminal may monitor both search space set #1 and search space set #2 in a specific slot, and may monitor one of search space set #1 and search space set #2 in the specific slot.

[PDCCH: BD/CCE Limit]

When multiple search space sets are configured for the terminal, the following conditions may be considered for a method of determining a search space set required to be monitored by the terminal.

If the terminal is configured with a value of monitoringCapabilityConfig-r16, which is higher layer signaling, with r15monitoringcapability, the terminal may define, for each slot, a maximum value for the number of PDCCH candidates that may be monitored and for the number of CCEs constituting the entire search space (here, the entire search space refers to all CCE sets corresponding to a union area of multiple search space sets), and if a value of monitoringCapabilityConfig-r16 is configured with r16monitoringcapability, the terminal may define, for each span, a maximum value for the number of PDCCH candidates that may be monitored and for the number of CCEs constituting the entire search space (here, the entire search space may refer to all CCE sets corresponding to a union area of multiple search space sets).

[Condition 1: Limiting the Maximum Number of PDCCH Candidates]

As described above, according to a configuration value of higher layer signaling, M^{μ} which is the maximum number of PDCCH candidates that may be monitored by the terminal may, for example, conform to Table 11 below when defined based on slot, and may conform to Table 12 below when defined based on span, in a cell configured with a subcarrier spacing of 15·2^{μ} kHz.

TABLE 11

| | Maximum number of PDCCH candidates per |
|---|---|
| μ | slot and per serving cell (M^{μ}) |
| 0 | 44 |
| 1 | 36 |
| 2 | 22 |
| 3 | 20 |

TABLE 12

| | Maximum number M^{μ} of monitored PDCCH candidates | | |
|---|---|---|---|
| | per span for combination (X, Y) and per serving cell | | |
| μ | (2, 2) | (4, 3) | (7, 3) |
| 0 | 14 | 28 | 44 |
| 1 | 12 | 24 | 36 |

[Condition 2: Limiting the Maximum Number of CCEs]

As described above, according to a configuration value of higher layer signaling, C^{μ} which is the maximum number of CCEs constituting the entire search space (here, the entire search space refers to all CCE sets corresponding to a union area of multiple search space sets) may conform to Table 13 below when defined based on slot, and may conform to Table 14 below when defined based on span, in a cell configured with a subcarrier spacing of 15·2^{μ} kHz.

TABLE 13

| | Maximum number of non-overlapped CCEs per slot |
|---|---|
| μ | and per serving cell (C^{μ}) |
| 0 | 56 |
| 1 | 56 |
| 2 | 48 |
| 3 | 32 |

TABLE 14

| | Maximum number C^{μ} of non-overlapped CCEs per | | |
|---|---|---|---|
| | span for combination (X, Y) and per serving cell | | |
| μ | (2, 2) | (4, 3) | (7, 3) |
| 0 | 18 | 36 | 56 |
| 1 | 18 | 36 | 56 |

For the convenience of description, a situation in which both conditions 1 and 2 are satisfied at a specific time point is defined as “condition A”. Therefore, not satisfying condition A may refer to not satisfying at least one of conditions 1 and 2.

[PDCCH: Overbooking]

According to configurations of the search space sets by the base station, a case in which condition A is not satisfied at a specific time point may occur. If condition A is not satisfied at the specific time point, the terminal may select and monitor only some of the search space sets configured to satisfy condition A at the corresponding time point, and the base station may transmit a PDCCH in the selected search space sets.

The method of selecting some search spaces from the entire configured search space set may conform to the following methods.

If condition A for PDCCH is not satisfied at a specific time point (slot), the terminal (or base station) may select a search space set, in which a search space type is configured to be a common search space, preferentially over a search space set configured to be a UE-specific search space, from among search space sets existing at the corresponding time point.

If all the search space sets configured to be the common search space are selected (that is, if condition A is satisfied even after all the search spaces configured to be the common search space are selected), the terminal (or base station) may select the search space sets configured to be the UE-specific search space. In this case, if there are multiple search space sets configured to be the UE-specific search spaces, a search space set having a low search space set index may have a higher priority. In consideration of the priority, the UE-specific search space sets may be selected within a range in which condition A is satisfied.

[Related to Rate Matching/Puncturing]

In the following, a rate matching operation and a puncturing operation are described in detail.

When time and frequency resources A, in which predetermined symbol sequence A is to be transmitted, overlap predetermined time and frequency resources B, a rate matching or puncturing operation may be considered as a transmission/reception operation of channel A in consideration of domain resource C in which resources A and resources B overlap each other. A detailed operation may follow the content below.

Rate Matching Operation
The base station may transmit, to the terminal, channel A by mapping the same only to resource areas remaining after excluding, from all resources A for transmission of symbol sequence A, resource C corresponding to an area in which resources A overlap resource B. For example, when symbol sequence A includes {symbol #1, symbol #2, symbol #3, symbol #4}, resources A are {resource #1, resource #2, resource #3, resource #4}, and resources B are {resource #3, resource #5}, the base station may sequentially map symbol sequence A to resources {resource #1, resource #2, resource #4} remaining after excluding, from resources A, {resource #3} which corresponds to resource C, so as to transmit the same. As a result, the base station may map the symbol sequence {symbol #1, symbol #2, symbol #3} to {resource #1, resource #2, resource #4}, respectively, so as to transmit the same.

The terminal may determine resources A and resources B from scheduling information for symbol sequence A from the base station, and may determine, based thereof, resource C that is an area in which resources A and resources B overlap each other. The terminal may receive symbol sequence A, based on an assumption that symbol sequence A has been mapped to and transmitted in the areas remaining after excluding resource C from all resources A. For example, when symbol sequence A includes {symbol #1, symbol #2, symbol #3, symbol #4}, resources A are {resource #1, resource #2, resource #3, resource #4}, and resources B are {resource #3, resource #5}, the terminal may receive symbol sequence A, based on an assumption that symbol sequence A has been sequentially mapped to the resources {resource #1, resource #2, resource #4} which are remaining after excluding, from resources A, {resource #3} which corresponds to resource C. As a result, the terminal may perform a series of reception operation later based on the assumption that the symbol sequence {symbol #1, symbol #2, symbol #3} is mapped to and transmitted in {resource #1, resource #2, resource #4}, respectively.

Puncturing Operation

When there is resource C corresponding to the area in which all resources A for transmission of symbol sequence A to the terminal overlap resources B, the base station may map symbol sequence A to all resources A, but may perform transmission only in the resource areas remaining after excluding resource C from resources A, without performing transmission in the resource area corresponding to resource C. For example, when symbol sequence A includes {symbol #1, symbol #2, symbol #3, symbol #4}, resources A are {resource #1, resource #2, resource #3, resource #4}, and resources B are {resource #3, resource #5}, the base station may map symbol sequence A of {symbol #1, symbol #2, symbol #3, symbol #4} to resources A {resource #1, resource #2, resource #3, resource #4}, respectively, and may transmit only the symbol sequence {symbol #1, symbol #2, symbol #4} corresponding to the resources {resource #1, resource #2, resource #4} which are remaining after excluding, from resources A, {resource #3} corresponding to resource C, without transmitting {symbol #3} mapped to {resource #3} corresponding to resource C. As a result, the base station may map the symbol sequence {symbol #1, symbol #2, symbol #4} to {resource #1, resource #2, resource #4}, respectively, so as to transmit the same.

The terminal may determine resources A and resources B from scheduling information for symbol sequence A from the base station, and may determine, based thereof, resource C that is an area in which resources A and resources B overlap each other. The terminal may receive symbol sequence A, based on the assumption that symbol sequence A has been mapped to all resources A but is transmitted only in the areas remaining after excluding resource C from resources A. For example, when symbol sequence A includes {symbol #1, symbol #2, symbol #3, symbol #4}, resources A are {resource #1, resource #2, resource #3, resource #4}, and resources B are {resource #3, resource #5}, the terminal may assume that symbol sequence A {symbol #1, symbol #2, symbol #3, symbol #4} is mapped to resources A {resource #1, resource #2, resource #3, resource #4}, respectively, but {symbol #3} mapped to {resource #3} corresponding to resource C is not transmitted, and may perform reception based on the assumption that the symbol sequence {symbol #1, symbol #2, symbol #4} corresponding to the resources {resource #1, resource #2, resource #4} which are remaining after excluding, from resources A, {resource #3} corresponding to resource C is mapped and transmitted. As a result, the terminal may perform a series of reception operation later based on the assumption that the symbol sequence {symbol #1, symbol #2, symbol #4} is mapped to and transmitted in {resource #1, resource #2, resource #4}, respectively.

Hereinafter, a method of configuring a rate matching resource for the purpose of rate matching in the 5G communication system will be described. Rate matching refers to that a size of a signal is adjusted by considering an amount of resources capable of transmitting the signal. For example, rate matching of a data channel may refer to that a size of data is adjusted according to an amount of resources, without mapping and transmitting the data channel with respect to a specific time and frequency resource area.

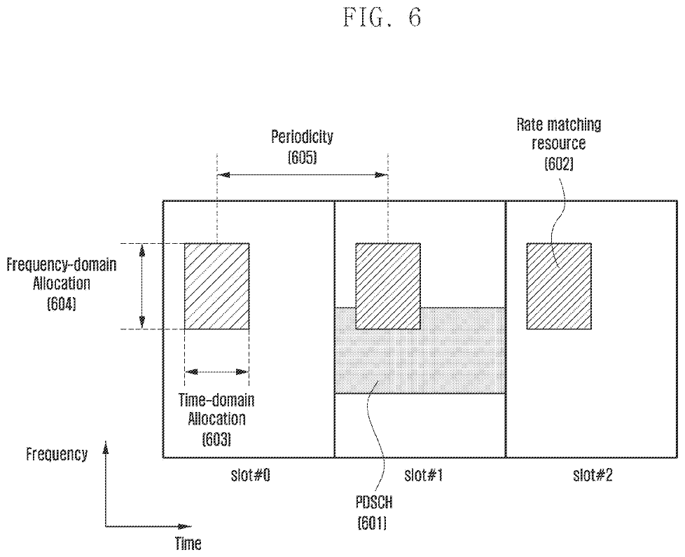

FIG. 6 is a diagram for describing a method by which a base station and a terminal transmit or receive data in consideration of a downlink data channel and a rate matching resource according to an embodiment of the disclosure.

FIG. 6 illustrates a downlink data channel (e.g., a physical downlink shared channel (PDSCH)) 601 and a rate matching resource 602. The base station may configure one or multiple rate matching resources 602 for the terminal via higher layer signaling (e.g., RRC signaling). Configuration information of the rate matching resource 602 may include time axis resource allocation information 603, frequency axis resource allocation information 604, and periodicity information 605. Hereinafter, a bitmap corresponding to the frequency axis resource allocation information 604 is referred to as a “first bitmap”, a bitmap corresponding to the time axis resource allocation information 603 is referred to as a “second bitmap”, and a bitmap corresponding to the periodicity information 605 is referred to as a “third bitmap”. When all or some of the time and frequency resources of the scheduled data channel 601 overlap the configured rate matching resource 602, the base station may match the data channel 601 to the rate matching resource 602 part so as to transmit the same, and the terminal may perform reception and decoding based on an assumption that the data channel 601 is rate-matched in the rate matching resource 602 part.

The base station may dynamically notify, via DCI, the terminal of whether to rate-match the data channel in the configured rate matching resource part via an additional configuration (corresponding to a “rate matching indicator” in the aforementioned DCI format). Specifically, the base station may select some of the configured rate matching resources, group the same into a rate matching resource group, and inform the terminal of whether to perform rate matching of a data channel for each rate matching resource group, via DCI by using a bitmap scheme. For example, when four rate matching resources of RMR #1, RMR #2, RMR #3, and RMR #4 are configured, the base station may configure rate matching groups of RMG #1={RMR #1, RMR #2} and RMG #2={RMR #3, RMR #4}, and may indicate, to the terminal, whether to perform rate matching in each of RMG #1 and RMG #2, by using 2 bits within a DCI field. For example, the base station may indicate “1” when rate matching is needed, and may indicate “0” when rate matching is not needed.

In the 5G system, granularity at an “RB symbol level” and granularity at an “RE level” are supported as the aforementioned method of configuring a rate matching resource for the terminal. More specifically, the following configuration method may be used.

RB Symbol Level

The terminal may be configured with up to four RateMatchPattern for each bandwidth part via higher layer signaling, and one RateMatchPattern may include the following content.

As reserved resources within a bandwidth part, resources in which time and frequency resource areas of the corresponding reserved resources are configured may be included in a combination of an RB-level bitmap and a symbol-level bitmap on the frequency axis. The reserved resources may span one or two slots. A time domain pattern (periodicityAndPattern), in which the time and frequency domains including each RB-level and symbol-level bitmap pair are repeated, may be additionally configured.

Time and frequency domain resource areas configured as a control resource set within a bandwidth part and a resource area corresponding to a time domain pattern configured by a search space configuration in which the corresponding resource areas are repeated may be included.

RE Level

The terminal may be configured with the following contents via higher layer signaling.

As configuration information (lte-CRS-ToMatchAround) for REs corresponding to an LTE cell-specific reference signal or common reference signal (CRS) pattern, the number (nrofCRS-Ports) of LTE CSR ports, values (v-shift) of LTE-CRS-vshift(s), information (carrierFreqDL) on a center subcarrier position of an LTE carrier from a frequency point that is a reference (e.g., reference point A), information on a bandwidth size (carrierBandwidthDL) of an LTE carrier, subframe configuration information (mbsfn-SubframConfigList) corresponding to a multicast-broadcast single-frequency network (MBSFN), and the like may be included. The terminal may determine a CRS position within an NR slot corresponding to the LTE subframe, based on the aforementioned information.

Configuration information for a resource set corresponding to one or multiple zero power (ZP) CSI-RSs within a bandwidth part may be included.

[Relating to LTE CRS Rate Match]

Subsequently, a rate match procedure for the aforementioned LTE CRS will be described in detail. For the coexistence of long-term evolution (LTE) and new RAT (NR) (LTE-NR coexistence), NR provides a function of configuring a cell-specific reference signal (CRS) pattern of LTE for an NR terminal. More specifically, the CRS pattern may be provided by RRC signaling including at least one parameter in ServingCellConfigCommon information element (IE) or ServingCellConfig IE. Examples of the parameter may include lte-CRS-ToMatchAround, lte-CRS-PatternList1-r16, lte-CRS-PatternList2-r16, crs-RateMatch-PerCORES ETPoolIndex-r16, and the like.

Rel-15 NR provides a function in which one CRS pattern may be configured per serving cell via parameter lte-CRS-ToMatchAround. In Rel-16 NR, the function has been extended to enable configuration of multiple CRS patterns per serving cell. More specifically, a single-transmission and reception point (TRP) configuration terminal may be configured with one CRS pattern per one LTE carrier, and a multi-TRP configuration terminal may be configured with two CRS patterns per one LTE carrier. For example, up to three CRS patterns per serving cell may be configured for the single-TRP configuration terminal via parameter lte-CRS-PatternList1-r16. For another example, a CRS may be configured for each TRP in the multi-TRP configuration terminal. That is, a CRS pattern for TRP1 may be configured via parameter lte-CRS-PatternList1-r16, and a CRS pattern for TRP2 may be configured via parameter lte-CRS-PatternList2-r16. When two TRPs are configured as above, whether to apply both the CRS patterns of TRP1 and TRP2 to a specific physical downlink shared channel (PDSCH) or whether to apply only the CRS pattern for one TRP is determined via parameter crs-RateMatch-PerCORESETPoolIndex-r16, wherein only the CRS pattern of one TRP is applied if parameter crs-RateMatch-PerCORESETPoolIndex-r16 is configured to be “enabled”, and both the CRS patterns of the two TRPs are applied in other cases.

Table 15 shows ServingCellConfig IE including the CRS pattern, and Table 16 shows RateMatchPatternLTE-CRS IE including at least one parameter for the CRS pattern.

TABLE 15

| | |
|---|---|
| ServingCellConfig ::= | SEQUENCE { |
| tdd-UL-DL-ConfigurationDedicated | TDD-UL-DL-ConfigDedicated |
| OPTIONAL, -- Cond TDD | |
| initialDownlinkBWP | BWP-DownlinkDedicated |
| OPTIONAL, -- Need M | |
| downlinkBWP-ToReleaseList | SEQUENCE (SIZE (1..maxNrofBWPs)) OF |
| BWP-Id | OPTIONAL, -- Need N |
| downlinkBWP-ToAddModList | SEQUENCE (SIZE (1..maxNrofBWPs)) |
| OF BWP-Downlink | OPTIONAL, -- Need N |
| firstActiveDownlinkBWP-Id | BWP-Id |
| OPTIONAL, -- Cond SyncAndCellAdd | |
| bwp-InactivityTimer | ENUMERATED {ms2, ms3, ms4, ms5, ms6, |
| ms8, ms10, ms20, ms30, | |
| | ms40,ms50, ms60, ms80,ms100, ms200,ms300, |
| ms500, | |
| | ms750, ms1280, ms1920, ms2560, spare 10, spare9, |
| spare8, | |
| | spare7, spare6, spare5, spare4, spare3, spare2, |
| spare1 } OPTIONAL, -- Need R | |
| defaultDownlinkBWP-Id | BWP-Id |
| OPTIONAL, -- Need S | |
| uplinkConfig | UplinkConfig |
| OPTIONAL, -- Need M | |
| supplementaryUplink | UplinkConfig |
| OPTIONAL, -- Need M | |
| pdcch-ServingCellConfig | SetupRelease { PDCCH-ServingCellConfig } |
| OPTIONAL, -- Need M | |
| pdsch-ServingCellConfig | SetupRelease { PDSCH-ServingCellConfig } |
| OPTIONAL, -- Need M | |
| csi-MeasConfig | SetupRelease { CSI-MeasConfig } |
| OPTIONAL, -- Need M | |
| sCellDeactivationTimer | ENUMERATED {ms20, ms40, ms80, ms160, |
| ms200, ms240, | |
| | ms320, ms400, ms480, ms520, ms640, ms720, |
| | ms840, ms1280, spare2,spare1} OPTIONAL, |
| -- Cond ServingCellWithoutPUCCH | |
| crossCarrierSchedulingConfig | CrossCarrierSchedulingConfig |
| OPTIONAL, -- Need M | |
| tag-Id | TAG-Id, |
| dummy | ENUMERATED {enabled} |
| OPTIONAL, -- Need R | |
| pathlossReferenceLinking | ENUMERATED {spCell, sCell} |
| OPTIONAL, -- Cond SCellOnly | |
| servingCellMO | MeasObjectId |
| OPTIONAL, -- Cond MeasObject | |
| ..., | |
| [[ | |
| lte-CRS-ToMatchAround | SetupRelease { RateMatchPatternLTE-CRS } |
| OPTIONAL, -- Need M | |
| rateMatchPatternToAddModList | SEQUENCE (SIZE |
| (1..maxNrofRateMatchPatterns)) OF RateMatchPattern | OPTIONAL, -- Need |
| N | |
| rateMatchPatternToReleaseList | SEQUENCE (SIZE |
| (1..maxNrofRateMatchPatterns)) OF RateMatchPatternId | OPTIONAL, -- Need |
| N | |
| downlinkChannelBW-PerSCS-List | SEQUENCE (SIZE (1..maxSCSs)) OF |
| SCS-SpecificCarrier | OPTIONAL -- Need S |
| ]], | |
| [[ | |
| supplementaryUplinkRelease | ENUMERATED { true} |
| OPTIONAL, -- Need N | |
| tdd-UL-DL-ConfigurationDedicated-IAB-MT-r16 | TDD-UL-DL- |
| ConfigDedicated-IAB-MT-r16 | OPTIONAL, -- Cond TDD_IAB |
| dormantBWP-Config-r16 | SetupRelease { DormantBWP-Config-r16 } |
| OPTIONAL, -- Need M | |
| ca-SlotOffset-r16 | CHOICE { |
| refSCS 15kHz | INTEGER (−2..2), |
| refSCS30KHz | INTEGER (−5..5), |
| refSCS60KHz | INTEGER (−10..10), |
| refSCS120KHz | INTEGER (−20..20) |
| } | OPTIONAL, |
| --Cond AsyncCA | |
| channelAccessConfig-r16 | SetupRelease { ChannelAccessConfig-r16 } |
| OPTIONAL, -- Need M | |
| intraCellGuardBandsDL-List-r16 | SEQUENCE (SIZE (1..maxSCSs)) OF |
| IntraCellGuardBandsPerSCS-r16 | OPTIONAL, -- Need S |
| intraCellGuardBandsUL-List-r16 | SEQUENCE (SIZE (1..maxSCSs)) OF |
| IntraCellGuardBandsPerSCS-r16 | OPTIONAL, -- Need S |
| csi-RS-ValidationWith-DCI-r16 | ENUMERATED {enabled} |
| OPTIONAL, -- Need R | |
| lte-CRS-PatternList1-r16 | SetupRelease { LTE-CRS-PatternList-r16 } |
| OPTIONAL, -- Need M | |
| lte-CRS-PatternList2-r16 | SetupRelease { LTE-CRS-PatternList-r16 } |
| OPTIONAL, -- Need M | |
| crs-RateMatch-PerCORESETPoolIndex-r16 | ENUMERATED {enabled} |
| OPTIONAL, -- Need R | |
| enableTwoDefaultTCI-States-r16 | ENUMERATED {enabled} |
| OPTIONAL, -- Need R | |
| enableDefaultTCI-StatePerCoresetPoolIndex-r16 | ENUMERATED {enabled} |
| OPTIONAL, -- Need R | |
| enableBeamSwitchTiming-r16 | ENUMERATED {true} |
| OPTIONAL, -- Need R | |
| cbg-TxDiffTBsProcessingType1-r16 | ENUMERATED {enabled} |
| OPTIONAL, -- Need R | |
| cbg-TxDiffTBsProcessingType2-r16 | ENUMERATED {enabled} |
| OPTIONAL -- Need R | |
| ]] | |
| } | |

```
TABLE 16
    - RateMatchPatternLTE-CRS
The IE RateMatchPatternLTE-CRS is used to configure a pattern to rate match
around LTE CRS. See TS 38.214 [19], clause 5.1.4.2.
      RateMatchPatternLTE-CRS information element
-- ASN1START
-- TAG-RATEMATCHPATTERNLTE-CRS-START
```

| | |
|---|---|
| RateMatchPatternLTE-CRS ::= | SEQUENCE { |
| carrierFreqDL | INTEGER (0 .. 16383), |
| carrierBandwidthDL | ENUMERATED {n6, n15, n25, n50, n75, n100, |

spare2, spare1},

| | |
|---|---|
| mbsfn-SubframeConfigList | EUTRA-MBSFN-SubframeConfigList |

OPTIONAL, -- Need M

| | |
|---|---|
| nrofCRS-Ports | ENUMERATED {n1, n2, n4}, |
| v-Shift | ENUMERATED {n0, n1, n2, n3, n4, n5} |

}
LTE-CRS-PatternList-r16 ::= SEQUENCE (SIZE (1 .. maxLTE-CRS-Patterns-
r16)) OF RateMatchPatternLTE-CRS
-- TAG-RATEMATCHPATTERNLTE-CRS-STOP
-- ASN1STOP
RateMatch PatternLTE-CRS field descriptions
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19], clause
5.1.4.2).
v-Shift
Shifting value v-shift in LTE to rate match around LTE CRS (see TS 38.214 [19],
clause 5.1.4.2).

[PDSCH: Relating to Frequency Resource Allocation]

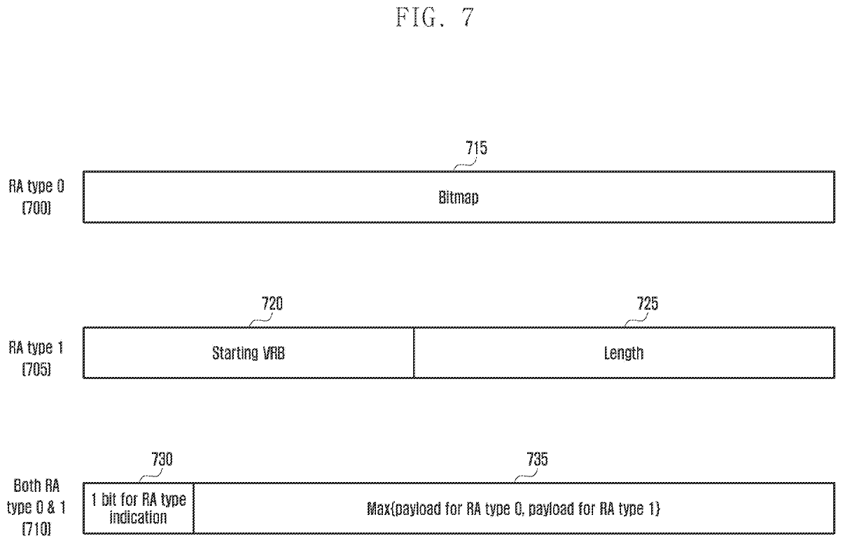

FIG. 7 is a diagram illustrating an example of frequency axis resource allocation of a physical downlink shared channel (PDSCH) in the wireless communication system according to an embodiment of the disclosure.

FIG. 7 is a diagram illustrating three frequency axis resource allocation methods of type 0 700, type 1 705, and a dynamic switch 710 which are configurable via a higher layer in the NR wireless communication system.

Referring to FIG. 7, if a terminal is configured as RA type 0 700, via higher layer signaling, to use only resource type 0, some downlink control information (DCI) for allocation of a PDSCH to the terminal includes a bitmap 715 having NRBG bits. Conditions for this will be described later. In this case, NRBG refers to the number of resource block groups (RBG) determined as shown in Table 17 below according to a BWP size assigned by a BWP indicator and higher layer parameter rbg-Size, and data is transmitted to the RBG indicated to be 1 by a bit map.

TABLE 17

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

If the terminal is configured, via higher layer signaling, to use only resource type 1 705, some DCI that assigns a PDSCH to the terminal includes frequency axis resource allocation information having ┌log₂(N_{RB}^{DL,BWP}(N_{RB}^{DL,BWP}+1)/2┐ bits. Conditions for this will be described later. Based on this, the base station may configure a starting VRB 720 and a length 725 of frequency axis resources continuously allocated therefrom.

If the terminal is configured, via higher layer signaling, to use both resource type 0 and resource type 1 710, some DCI for assignment of a PDSCH to the terminal includes frequency axis resource allocation information including bits of a large value 735 among a payload 715 for configuration of resource type 0 and payloads 720 and 725 for configuration of resource type 1. Conditions for this will be described later. In this case, one bit 730 may be added to a first part (MSB) of the frequency axis resource allocation information in the DCI, and if the corresponding bit has a value of “0”, use of resource type 0 may be indicated, and if the bit has a value of “1”, use of resource type 1 may be indicated.

[PDSCH/PUSCH: Relating to Time Resource Allocation]

Hereinafter, a method of time domain resource allocation for a data channel in the next-generation mobile communication system (5G or NR system) is described.

The base station may configure, for the terminal via higher layer signaling (e.g., RRC signaling), a table for time domain resource allocation information on a downlink data channel (physical downlink shared channel (PDSCH)) and an uplink data channel (physical uplink shared channel (PUSCH)). A table including up to 16 entries (maxNrofDL-Allocations=16) may be configured for the PDSCH, and a table including up to 16 entries (maxNrofUL-Allocations=16) may be configured for the PUSCH. In an embodiment, the time domain resource allocation information may include a PDCCH-to-PDSCH slot timing (denoted as K0, and corresponding to a time interval in units of slots between a time point at which the PDCCH is received and a time point at which the PDSCH scheduled by the received PDCCH is transmitted), a PDCCH-to-PUSCH slot timing (denoted as K2, and corresponding to a time interval in units of slots between a time point at which the PDCCH is received and a time point at which the PUSCH scheduled by the received PDCCH is transmitted), information on a position and length of a start symbol in which the PDSCH or PUSCH is scheduled within a slot, a mapping type of the PDSCH or PUSCH, or the like. For example, information as shown in Table 18 or Table 19 below may be transmitted from the base station to the terminal.

TABLE 18
PDSCH-TimeDomainResourceAllocationList information element

| PDSCH-TimeDomainResourceAllocationList | ::= | SEQUENCE |
|---|---|---|
| (SIZE(1..maxNrofDL-Allocations)) | OF | PDSCH- |
| TimeDomainResourceAllocation | | |
| PDSCH-TimeDomainResourceAllocation ::= | SEQUENCE { | |
| k0 | INTEGER(0..32) | OPTIONAL, |

| | |
|---|---|
| -- Need S | |
| mapping Type | ENUMERATED {typeA, typeB}, |
| startSymbolAndLength | INTEGER (0..127) |
| } | |

TABLE 19
PDSCH-TimeDomainResourceAllocationList information element

| PDSCH-TimeDomainResourceAllocationList | ::= | SEQUENCE |
|---|---|---|
| (SIZE(1..maxNrofUL-Allocations)) | OF | PDSCH- |
| TimeDomainResourceAllocation | | |
| PDSCH-TimeDomainResourceAllocation ::= | SEQUENCE { | |
| k2 | INTEGER(0..32) | OPTIONAL, -- Need S |

| | |
|---|---|
| mapping Type | ENUMERATED {typeA, typeB}, |
| startSymbolAndLength | INTEGER (0..127) |
| } | |

The base station may notify one of the entries in the tables relating to the time domain resource allocation information to the terminal via L1 signaling (e.g., DCI) (e.g., the entry may be indicated by a “time domain resource allocation” field in the DCI). The terminal may acquire the time domain resource allocation information for PDSCH or PUSCH, based on DCI received from the base station.

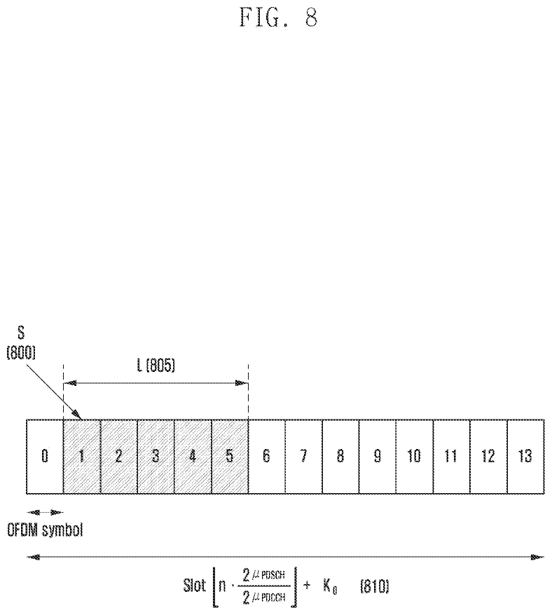

FIG. 8 is a diagram illustrating an example of time axis resource allocation of a PDSCH in the wireless communication system according to an embodiment of the disclosure.

Referring to FIG. 8, a base station may indicate a time axis position of a PDSCH resource according to a start position 800 and a length 805 of an OFDM symbol in one slot dynamically indicated via DCI, a scheduling offset K0 value 810, and subcarrier spacings (SCSs) (μ_{PDSCH} and μ_{PDCCH}) of a data channel and a control channel configured using a higher layer.

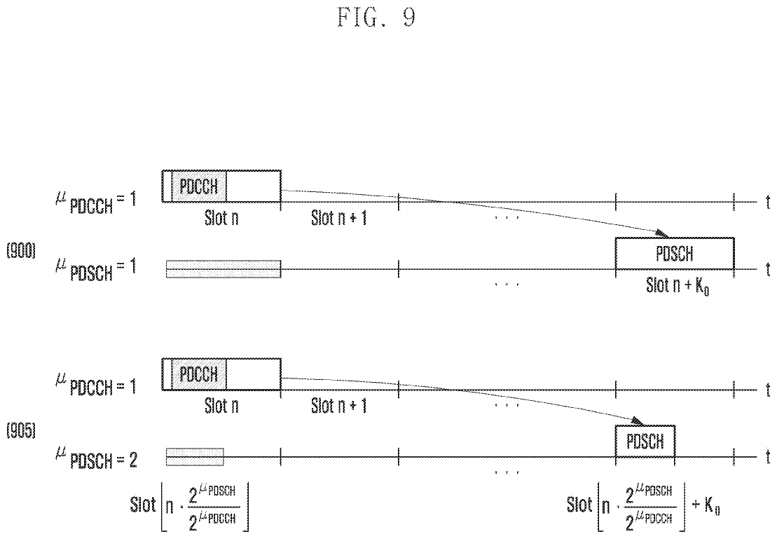

FIG. 9 is a diagram illustrating an example of time axis resource allocation according to subcarrier spacings of a data channel and a control channel in the wireless communication system according to an embodiment of the disclosure.

Referring to FIG. 9, if a subcarrier spacing of a data channel is the same as that of a control channel 900 (μ_{PDSCH}=μ_{PDCCH}), slot numbers for data and control are the same, and therefore a base station and a terminal may generate a scheduling offset according to predetermined slot offset K₀. On the other hand, if the subcarrier spacings of the data channel and the control channel are different 905 (μ_{PDSCH}≠μ_{PDCCH}), the slot numbers for data and control are different, and thus the base station and the terminal may generate a scheduling offset according to a predetermined slot offset K₀, based on the subcarrier spacing of a PDCCH.

[PUSCH: Relating to Transmission Scheme]

Subsequently, a scheduling scheme of PUSCH transmission will be described. PUSCH transmission may be dynamically scheduled by a UL grant in DCI or may be operated by configured grant Type 1 or Type 2. Dynamic scheduling indication for PUSCH transmission is possible with DCI format 0_0 or 0_1.

For configured grant Type 1 PUSCH transmission, the UL grant in DCI may not be received, and configuration may be performed semi-statically via reception of configuredGrantConfig including rrc-ConfiguredUplinkGrant of Table 20 via higher signaling. Configured grant Type 2 PUSCH transmission may be semi-persistently scheduled by the UL grant in DCI after reception of configuredGrantConfig that does not include rrc-ConfiguredUplinkGrant of Table 20 via higher signaling. When PUSCH transmission is operated by the configured grant, parameters applied to PUSCH transmission are applied via configuredGrantConfig that is higher signaling in Table 20, except for dataScramblingIdentityPUSCH, txConfig, codebookSubset, maxRank, and scaling of UCI-OnPUSCH provided via pusch-Config that is higher signaling in Table 21. If the terminal is provided with transformPrecoder in configuredGrantConfig which is higher signaling in Table 20, the terminal applies tp-pi2BPSK in pusch-Config of Table 21 to PUSCH transmission operated by the configured grant.

TABLE 20

| | |
|---|---|
| ConfiguredGrantConfig ::= | SEQUENCE { |
| frequency Hopping | ENUMERATED {intraSlot, interSlot} |
| OPTIONAL, -- Need S, | |
| cg-DMRS-Configuration | DMRS-UplinkConfig, |
| mcs-Table | ENUMERATED {qam256, qam64LowSE} |
| OPTIONAL, -- Need S | |
| mcs-TableTransformPrecoder | ENUMERATED {qam256, |
| qam64LowSE} | OPTIONAL, -- Need S |
| uci-OnPUSCH | SetupRelease { CG-UCI-OnPUSCH } |
| OPTIONAL, -- Need M | |
| resourceAllocation | ENUMERATED { resourceAllocationType0, |

resourceAllocationType1, dynamicSwitch },

| | |
|---|---|
| rbg-Size | ENUMERATED {config2} |
| OPTIONAL, -- Need S | |
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |
| OPTIONAL, -- Need S | |
| nrofHARQ-Processes | INTEGER(1..16), |
| repK | ENUMERATED{n1, n2, n4, n8}, |
| repK-RV | ENUMERATED {s1-0231, s2-0303, s3-0000} |
| OPTIONAL, -- Need R | |
| periodicity | ENUMERATED { |
| | sym2, sym7, sym1x14, sym2x14, sym4x14, |

sym5×14, sym8×14, sym10x14, sym16x14, sym20x14,

sym32x14, sym40×14, sym64×14, sym80x14,

sym128x14, sym160×14, sym256×14, sym320x14, sym512x14,

| | |
|---|---|
| | sym640x14, sym1024×14, sym1280x14, |
| sym2560x14, sym5120x14, | |
| | sym6, sym1x12, sym2x12, sym4×12, sym5x12, |

sym8x12, sym10x12, sym16x12, sym20x12, sym32x12,

sym40×12, sym64×12, sym80x12, sym128x12,

sym160×12, sym256×12, sym320x12, sym512x12, sym640x12,

| | |
|---|---|
| | sym1280x12, sym2560x12 |
| }, | |
| configuredGrantTimer | INTEGER (1..64) |
| OPTIONAL, -- Need R | |
| rrc-ConfiguredUplink Grant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |
| OPTIONAL, -- Need R | |
| precodingAndNumberOfLayers | INTEGER (0..63), |
| srs-ResourceIndicator | INTEGER (0..15) |
| OPTIONAL, -- Need R | |
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |
| PathlossReferenceRSs-1), | |
| ... | |
| } | |
| OPTIONAL, -- Need R | |
| ... | |
| } | |

Subsequently, a PUSCH transmission method will be described. A DMRS antenna port for PUSCH transmission is the same as an antenna port for SRS transmission. PUSCH transmission may follow each of a codebook-based transmission method and a non-codebook-based transmission method, depending on whether a value of txConfig in pusch-Config of Table 21, which is higher signaling, is “codebook” or “nonCodebook”.

As described above, PUSCH transmission may be dynamically scheduled via DCI format 0_0 or 0_1, and may be semi-statically configured by a configured grant. If the terminal is indicated with scheduling for PUSCH transmission via DCI format 0_0, the terminal performs beam configuration for PUSCH transmission by using pucch-spatialRelationInfoID corresponding to a UE-specific PUCCH resource which corresponds to a minimum ID within an enabled uplink BWP in a serving cell, in which case the PUSCH transmission is based on a single antenna port. The terminal does not expect scheduling for PUSCH transmission via DCI format 0_0, within a BWP in which a PUCCH resource including pucch-spatialRelationInfo is not configured. If the terminal is not configured with txConfig in pusch-Config of Table 21, the terminal does not expect to be scheduled via DCI format 0_1.

TABLE 21

| | |
|---|---|
| PUSCH-Config := | SEQUENCE { |
| dataScramblingIdentityPUSCH | INTEGER (0..1023) |
| OPTIONAL, -- Need S | |
| txConfig | ENUMERATED {codebook, |
| nonCodebook} | OPTIONAL, -- Need S |

dmrs-UplinkForPUSCH-MappingTypeA SetupRelease { DMRS-

| | |
|---|---|
| UplinkConfig } | OPTIONAL, -- Need M |

dmrs-UplinkForPUSCH-MappingTypeB SetupRelease { DMRS-

| | |
|---|---|
| Uplink Config } | OPTIONAL, -- Need M |
| pusch-PowerControl | Power Control |
| OPTIONAL, -- Need M | |
| frequencyHopping | ENUMERATED {intraSlot, |
| interSlot} | OPTIONAL, -- Need S |
| frequency HoppingOffsetLists | SEQUENCE (SIZE (1 .. 4)) OF |

INTEGER (1..maxNrofPhysicalResourceBlocks-1)

| | |
|---|---|
| OPTIONAL, -- Need M | |
| resourceAllocation | ENUMERATED { |

resourceAllocationType0, resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |
| OPTIONAL, -- Need S | |
| mcs-Table | ENUMERATED {qam256, |
| qam64LowSE} | OPTIONAL, -- Need S |
| mcs-TableTransformPrecoder | ENUMERATED {qam256, |
| qam64LowSE} | OPTIONAL, -- Need S |
| transformPrecoder | ENUMERATED {enabled, |
| disabled} | OPTIONAL, -- Need S |
| codebookSubset | ENUMERATED |
| {fullyAndPartialAndNonCoherent, | |
| partialAndNonCoherent,nonCoherent} | |
| OPTIONAL, -- Cond codebookBased | |
| maxRank | INTEGER (1..4) |
| OPTIONAL, -- Cond codebookBased | |
| rbg-Size | ENUMERATED { config2} |
| OPTIONAL, -- Need S | |
| uci-OnPUSCH | SetupRelease { UCI-OnPUSCH} |
| OPTIONAL, -- Need M | |
| tp-pi2BPSK | ENUMERATED {enabled} |
| OPTIONAL, -- Need S | |
| ... | |
| } | |

Subsequently, codebook-based PUSCH transmission will be described. Codebook-based PUSCH transmission may be dynamically scheduled via DCI format 0_0 or 0_1 and may operate semi-statically by a configured grant. If a codebook-based PUSCH is dynamically scheduled PUSCH format 0_1 or is configured semi-statically by a configured grant, the terminal determines a precoder for PUSCH transmission, based on an SRS resource indicator (SRI), a transmission precoding matrix indicator (TPMI), and a transmission rank (the number of PUSCH transmission layers).

In this case, the SRI may be given via a field, SRS resource indicator, in DCI or may be configured via srs-ResourceIndicator that is higher signaling. The terminal is configured with at least one SRS resource at codebook-based PUSCH transmission, and may be configured with up to two SRS resources. If the terminal is provided with the SRI via DCI, an SRS resource indicated by the SRI refers to an SRS resource corresponding to the SRI from among SRS resources transmitted before a PDCCH including the SRI. The TPMI and the transmission rank may be given via a field, precoding information and number of layers, in DCI or may be configured via precodingAndNumberOfLayers that is higher signaling. The TPMI is used to indicate a precoder applied to PUSCH transmission. If the terminal is configured with one SRS resource, the TPMI is used to indicate a precoder to be applied in the configured one SRS resource. If the terminal is configured with multiple SRS resources, the TPMI is used to indicate a precoder to be applied in the SRS resource indicated via the SRI.

A precoder to be used for PUSCH transmission is selected from an uplink codebook having the same number of antenna ports as a value of nrofSRS-Ports in SRS-Config which is higher signaling. In codebook-based PUSCH transmission, the terminal determines a codebook subset, based on codebookSubset in pusch-Config which is higher signaling and the TPMI. codebookSubset in pusch-Config, which is higher signaling, may be configured with one of “fullyAndPartialAndNonCoherent”, “partialAndNonCoherent”, or “nonCoherent”, based on UE capability reported to the base station by the terminal. If the terminal has reported “partialAndNonCoherent” as UE capability, the terminal does not expect that a value of codebookSubset which is higher signaling is configured to be “fullyAndPartialAndNonCoherent”. If the terminal has reported “nonCoherent” as UE capability, the terminal does not expect that the value of codebookSubset which is higher signaling is configured to be “fullyAndPartialAndNonCoherent” or “partialAndNonCoherent”. If nrofSRS-Ports in SRS-ResourceSet that is higher signaling indicates two SRS antenna ports, the terminal does not expect that the value of codebookSubset which is higher signaling is configured to be “partialAndNonCoherent”.

The terminal may be configured with one SRS resource set, in which a value of usage in SRS-ResourceSet that is higher signaling is configured to be “codebook”, and one SRS resource in the corresponding SRS resource set may be indicated via the SRI. If multiple SRS resources are configured in the SRS resource set in which the usage value in SRS-ResourceSet that is higher signaling is configured to be “codebook”, the terminal expects that the value of nrofSRS-Ports in SRS-Resource that is higher signaling is configured to be the same for all SRS resources.

The terminal transmits one or multiple SRS resources included in the SRS resource set, in which the value of usage is configured to be “codebook”, to the base station according to higher signaling, and the base station selects one of the SRS resources transmitted by the terminal and indicates the terminal to perform PUSCH transmission using transmission beam information of the corresponding SRS resource. In this case, in codebook-based PUSCH transmission, the SRI is used as information for selecting of an index of one SRS resource and is included in the DCI. Additionally, the base station adds, to the DCI, information indicating the rank and TPMI to be used by the terminal for PUSCH transmission. The terminal uses the SRS resource indicated by the SRI to perform PUSCH transmission by applying the precoder indicated by the TPMI and the rank, which has been indicated based on a transmission beam of the SRS resource.

Subsequently, non-codebook-based PUSCH transmission will be described. Non-codebook-based PUSCH transmission may be dynamically scheduled via DCI format 0_0 or 0_1 and may operate semi-statically by a configured grant. If at least one SRS resource is configured in an SRS resource set, in which the value of usage in SRS-ResourceSet that is higher signaling is configured to be “nonCodebook”, the terminal may be scheduled with non-codebook-based PUSCH transmission, via DCI format 0_1.

For the SRS resource set in which the value of usage in SRS-ResourceSet that is higher signaling is configured to be “nonCodebook”, the terminal may be configured with one connected non-zero power (NZP) CSI-RS resource. The terminal may perform calculation on a precoder for SRS transmission via measurement for the NZP CSI-RS resource connected to the SRS resource set. If a difference between a last reception symbol of an aperiodic NZP CSI-RS resource connected to the SRS resource set and a first symbol of aperiodic SRS transmission in the terminal is less than 42 symbols, the terminal does not expect information on the precoder for SRS transmission to be updated.

If a value of resourceType in SRS-ResourceSet that is higher signaling is configured to be “aperiodic”, the connected NZP CSI-RS is indicated via an SRS request which is a field in DCI format 0_1 or 1_1. In this case, if the connected NZP CSI-RS resource is an aperiodic NZP CSI-RS resource, the presence of the connected NZP CSI-RS in a case where a value of the field, SRS request, in DCI format 0_1 or 1_1 is not “00” is indicated. In this case, the corresponding DCI should indicate neither a cross carrier nor cross BWP scheduling. If the value of the SRS request indicates the presence of the NZP CSI-RS, the NZP CSI-RS is located in a slot in which a PDCCH including the SRS request field has been transmitted. TCI states configured in scheduled subcarriers are not configured to QCL-TypeD.

If a periodic or semi-persistent SRS resource set is configured, the connected NZP CSI-RS may be indicated via associatedCSI-RS in SRS-ResourceSet that is higher signaling. For non-codebook-based transmission, the terminal does not expect that spatialRelationInfo, which is higher signaling for the SRS resource, and associatedCSI-RS in SRS-ResourceSet that is higher signaling are configured together.

If multiple SRS resources are configured, the terminal may determine the precoder and transmission rank to be applied to PUSCH transmission, based on the SRI indicated by the base station. The SRI may be indicated via the field, SRS resource indicator, in DCI or may be configured via srs-ResourceIndicator that is higher signaling. Like the aforementioned codebook-based PUSCH transmission, when the terminal receives the SRI via the DCI, the SRS resource indicated by the SRI refers to an SRS resource corresponding to the SRI from among SRS resources transmitted before the PDCCH including the SRI. The terminal may use one or multiple SRS resources for SRS transmission, and the maximum number of SRS resources concurrently transmittable in an identical symbol within one SRS resource set is determined by UE capability reported to the base station by the terminal. In this case, the SRS resources for concurrent transmission by the terminal occupy the same identical RB. The terminal configures one SRS port for each SRS resource. Only one SRS resource set, in which the value of usage in SRS-ResourceSet that is higher signaling is configured to be “nonCodebook”, may be configured, and up to 4 SRS resources for the non-codebook-based PUSCH transmission may be configured.

The base station transmits one NZP CSI-RS connected to the SRS resource set to the terminal, and the terminal calculates, based on a result of measurement at reception of the NZP CSI-RS, the precoder to be used during transmission of one or multiple SRS resources in the SRS resource set. The terminal applies the calculated precoder when transmitting, to the base station, one or multiple SRS resources in the SRS resource set in which usage is configured to be “nonCodebook”, and the base station selects one or multiple SRS resources from among the received one or multiple SRS resources. In non-codebook-based PUSCH transmission, the SRI refers to an index capable of representing one SRS resource or a combination of multiple SRS resources, and the SRI is included in the DCI. The number of SRS resources indicated by the SRI transmitted by the base station may be the number of transmission layers of the PUSCH, and the terminal transmits the PUSCH by applying, to each layer, the precoder applied to SRS resource transmission.

[PUSCH: Preparation Procedure Time]

Subsequently, a PUSCH preparation procedure time will be described. If the base station uses DCI format 0_0, 0_1, or 0_2 to schedule the terminal to transmit the PUSCH, the terminal may require a PUSCH preparation procedure time for transmitting the PUSCH by applying a transmission method (a transmission precoding method of an SRS resource, the number of transmission layers, and a spatial domain transmission filter) indicated via the DCI. In NR, the PUSCH preparation procedure time is defined in consideration of the same. The PUSCH preparation procedure time of the terminal may follow Equation 2 below.

T_{proc,2}=max((N₂+d_{2,1}+d₂)(2048+144)κ2^{-μ}T_{c}+Tₑₓₜ+T_{switch},d_{2,2}) Equation 2

Each variable in T_{proc,2} described above using Equation 2 may have the following meaning
N₂: The number of symbols determined according to UE processing capability 1 or 2 and numerology μ according to capability of the terminal. If UE processing capability 1 is reported according to a capability report of the terminal, N₂ may have values of Table 22, and if UE processing capability 2 is reported and it is configured, via higher layer signaling, that UE processing capability 2 is available, N₂ may have values of Table 23.

TABLE 22

| | PUSCH preparation time N₂ |
|---|---|
| μ | [symbols] |
| 0 | 10 |
| 1 | 12 |
| 2 | 23 |
| 3 | 36 |

TABLE 23

| | PUSCH preparation time N₂ |
|---|---|
| μ | [symbols] |
| 0 | 5 |
| 1 | 5.5 |
| 2 | 11 for frequency range 1 |

d_{2,1}: The number of symbols determined to be 0 if all resource elements of a first OFDM symbol of PUSCH transmission are configured to include only DM-RS, and to be 1 otherwise.
κ: 64
μ: μ follows one of μ_{DL} or μ_{UL}, at which T_{proc,2} has a greater value μ_{DL} denotes a numerology of a downlink in which a PDCCH including DCI for scheduling of a PUSCH is transmitted, and μ_{UL} denotes a numerology of an uplink in which a PUSCH is transmitted.
T_{c}: 1/(Δfₘₐₓ*N_{f}), where Δfₘₐₓ=480*103 Hz, and N_{f}=4096
d_{2,2}: d_{2,2} follows a BWP switching time when DCI for scheduling of the PUSCH indicates BWP switching, and 0 otherwise.
d₂: If OFDM symbols of a PUCCH having a low priority index and a PUSCH having a high priority index and a PUCCH overlap in time, a d₂ value of the PUSCH having the high priority index is used. Otherwise, d₂ is 0.
Tₑₓₜ: If the terminal uses a shared spectrum channel access scheme, the terminal calculates Tₑₓₜ to apply the same to the PUSCH preparation procedure time. Otherwise, Tₑₓₜ is assumed to be 0.
T_{switch}: If an uplink switching interval is triggered, T_{switch} is assumed to be a switching interval time. Otherwise, T_{switch} is assumed to be 0.

The base station and the terminal determine that the PUSCH preparation procedure time is not sufficient if a first symbol of the PUSCH starts before a first uplink symbol in which a CP starts after T_{proc,2} from a last symbol of the PDCCH including the DCI for scheduling of the PUSCH, in consideration of time axis resource mapping information of the PUSCH scheduled via the DCI and a timing advance effect between the uplink and the downlink. Otherwise, the base station and the terminal determine that the PUSCH preparation procedure time is sufficient. If the PUSCH preparation procedure time is sufficient, the terminal transmits the PUSCH, and if the PUSCH preparation procedure time is not sufficient, the terminal may disregard the DCI for scheduling of the PUSCH.

[Relating to CA/DC]

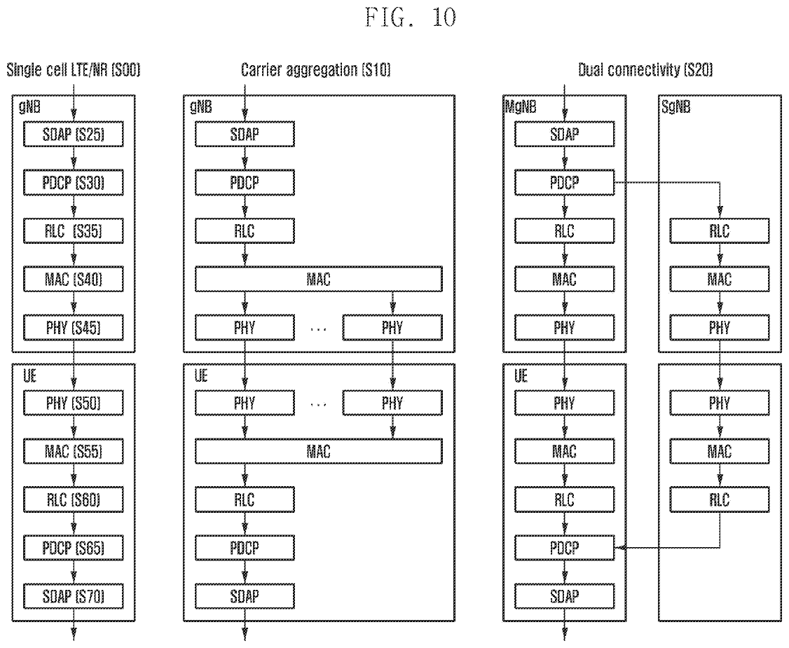

FIG. 10 is a diagram illustrating a radio protocol structure of a base station and a terminal in single cell, carrier aggregation, and dual connectivity situations according to an embodiment of the disclosure.

Referring to FIG. 10, radio protocols of a next-generation mobile communication system include NR service data adaptation protocols (SDAP) S25 and S70, NR packet data convergence protocols (PDCP) S30 and S65, NR radio link controls (RLC) S35 and S60, and NR medium access controls (MAC) S40 and S55 layers in a terminal and an NR base station, respectively.

Main functions of the NR SDAPs S25 and S70 may include some of the following functions.

User data transfer function (transfer of user plane data)

Function of mapping a quality of service (QoS) flow and a data bearer for an uplink and a downlink (mapping between a QoS flow and a data radio bearer (DRB) for both DL and UL)

Function of marking a QoS flow ID in an uplink and a downlink (marking QoS flow ID in both DL and UL packets)

Function of mapping reflective QoS flow to data bearer for uplink SDAP protocol data units (PDUs) (reflective QoS flow to DRB mapping for the UL SDAP PDUs)

With respect to an SDAP layer device, the terminal may be configured, via an RRC message, whether to use a header of the SDAP layer device or whether to use a function of the SDAP layer device for each PDCP layer device, for each bearer, or for each logical channel, and if the SDAP header is configured, a non-access stratum (NAS) QoS reflection configuration 1-bit indicator (NAS reflective QoS) and an access stratum (AS) QoS reflection configuration 1-bit indicator (AS reflective QoS) in the SDAP header may indicate the terminal to update or reconfigure mapping information for data bearers and QoS flows in uplink and downlink. The SDAP header may include QoS flow ID information indicating QoS. The QoS information may be used as a data processing priority, scheduling information, etc. to support a smooth service.

Main functions of the NR PDCPs S30 and S65 may include some of the following functions.

Header compression and decompression function (robust header compression (ROHC) only)

User data transfer function

In-sequence delivery function (in-sequence delivery of upper layer PDUs)

Out-of-sequence delivery function (out-of-sequence delivery of upper layer PDUs)

Reordering function (PDCP PDU reordering for reception)

Duplicate detection function (duplicate detection of lower layer SDU)

Retransmission function (retransmission of PDCP SDU)

Encryption and decryption function (ciphering and deciphering)

Timer-based SDU discard function (timer-based SDU discard in uplink)

In the above, the reordering function of the NR PDCP device refers to a function of reordering PDCP PDUs received from a lower layer in order based on a PDCP sequence number (SN), and may include a function of transferring data to a higher layer according to the reordered sequence. Alternatively, the reordering function of the NR PDCP device may include a function of direct transfer without considering a sequence, may include a function of reordering the sequence to record lost PDCP PDUs, may include a function of reporting states of the lost PDCP PDUs to a transmission side, and may include a function of requesting retransmission of the lost PDCP PDUs.

Main functions of the NR RLCs S35 and S60 may include some of the following functions.

Data transmission function (transfer of upper layer PDUs)

In-sequence delivery function (in-sequence delivery of upper layer PDUs)

Out-of-sequence delivery function (out-of-sequence delivery of upper layer PDUs)

Automatic repeat request (ARQ) function (error correction through ARQ)

Concatenation, segmentation, and reassembly functions (concatenation, segmentation and reassembly of RLC SDUs)

Re-segmentation function (re-segmentation of RLC data PDUs)

Reordering function (reordering of RLC data PDUs)

Duplicate detection function

Error detection function (protocol error detection)

RLC SDU discard function

RLC Re-Establishment Function

In the above, the in-sequence delivery function of the NR RLC device may refer to a function of sequentially delivering, to a higher layer, RLC SDUs received from a lower layer. The in-sequence delivery function of the NR RLC may include a function of, if originally one RLC SDU is segmented into multiple RLC SDUs and then received, reassembling and delivering the same, may include a function of reordering the received RLC PDUs according to an RLC sequence number (SN) or a PDCP sequence number (SN), may include a function of reordering a sequence and recording lost RLC PDUs, may include a function of reporting states of the lost RLC PDUs to a transmission side, and may include a function of requesting retransmission of the lost RLC PDUs. The in-sequence delivery function of the NR RLC may include a function of, if there is a lost RLC SDU, sequentially delivering only RLC SDUs before the lost RLC SDU to a higher layer, or may include a function of sequentially delivering all the received RLC SDUs to a higher layer before a predetermined timer starts if the timer expires even if there is a lost RLC SDU. Alternatively, the in-sequence delivery function of the NR RLC device may include a function of sequentially delivering all the RLC SDUs received up to the current time to a higher layer if the predetermined timer expires even if there is a lost RLC SDU. The RLC PDUs may be processed in the order of reception thereof (in order of arrival regardless of the order of the sequence numbers or serial numbers) and may be delivered to the PDCP device regardless of the order (out-of-sequence delivery). In a case of segments, segments stored in a buffer or to be received at a later time may be received, reconfigured into one complete RLC PDU, processed, and then may be delivered to the PDCP device. The NR RLC layer may not include a concatenation function, and the function may be performed in an NR MAC layer or may be replaced with a multiplexing function of the NR MAC layer.

In the above, the out-of-sequence delivery function of the NR RLC device refers to a function of delivering RLC PDUs received from a lower layer to an immediate higher layer in any order, may include a function of, when originally one RLC SDU is divided into multiple RLC SDUs and then received, reassembling the divided RLC SDUs and delivering the same, and may include a function of storing RLC SNs or PDCP SNs of the received RLC PDUs, arranging the order thereof, and recording lost RLC PDUs.

The NR MAC S40 or S55 may be connected to multiple NR RLC layer devices included in one terminal, and main functions of the NR MAC may include some of the following functions.
Mapping function (mapping between logical channels and transport channels)
Multiplexing and demultiplexing function (multiplexing/demultiplexing of MAC SDUs)
Scheduling information reporting function
HARQ function (error correction through HARQ)
Function of priority handling between logical channels (priority handling between logical channels of one UE)
Function of priority handling between terminals (priority handling between UEs by means of dynamic scheduling)
MBMS service identification function
Transport format selection function
Padding function

The NR PHY layers S45 and S50 may perform channel-coding and modulation of higher layer data, make the channel-coded and modulated higher layer data into OFDM symbols, and transmit the OFDM symbols via a radio channel, or may perform demodulation and channel-decoding of the OFDM symbols received through the radio channel and transfer the same to the higher layer.

The detailed structure of the radio protocol structure may be variously changed according to a carrier (or cell) operating method. For example, if the base station transmits, based on a single carrier (or cell), data to the terminal, the base station and the terminal use a protocol structure having a single structure for each layer, as shown in S00. On the other hand, if the base station transmits data to the terminal, based on carrier aggregation (CA) using multiple carriers in a single TRP, the base station and the terminal use a protocol structure in which up to the RLC layer has a single structure but the PHY layer is multiplexed via the MAC layer, as in S10. As another example, if the base station transmits data to the terminal, based on dual connectivity (DC) using multiple carriers in multiple TRPs, the base station and the terminal use a protocol structure in which up to the RLC has a single structure but the PHY layer is multiplexed via the MAC layer, as in S20.

Referring to the aforementioned descriptions relating to PDCCH and beam configurations, repeated PDCCH transmission is not supported currently in Rel-15 and Rel-16 NR, and it is thus difficult to achieve required reliability in a scenario requiring high reliability, such as URLLC. The disclosure provides a method of repeated PDCCH transmission via multiple transmission points (TRPs) so to improve PDCCH reception reliability of a terminal. Specific methods will be described in detail in the following embodiments.

Hereinafter, an embodiment of the disclosure is described in detail with the accompanying drawings. Contents of the disclosure are applicable in FDD and TDD systems. Hereinafter, in the disclosure, higher signaling (or higher layer signaling) is a method of transferring a signal from a base station to a terminal by using a physical layer downlink data channel or transferring a signal from a terminal to a base station by using a physical layer uplink data channel, and may be referred to as RRC signaling, PDCP signaling, or a medium access control (MAC) control element (MAC CE).

Hereinafter, in the disclosure, in determining whether to apply cooperative communication, it is possible for a terminal to use various methods, in which PDCCH(s) for assignment of a PDSCH to which cooperative communication is applied has a specific format, PDCCH(s) for assignment of a PDSCH to which cooperative communication is applied includes a specific indicator indicating whether the cooperative communication is applied, PDCCH(s) for assignment of a PDSCH to which cooperative communication is applied is scrambled with a specific RNTI, applying of cooperative communication in a specific period indicated by a higher layer is assumed, and the like. Hereinafter, for convenience of description, a case in which a terminal receives PDSCH to which cooperative communication has been applied based on conditions similar to the above will be referred to as an NC-JT case.

Hereinafter, in the disclosure, determination of the priority between A and B may be mentioned in various ways, such as selecting one having a higher priority according to a predetermined priority rule so as to perform an operation corresponding thereto, or omitting or dropping an operation having a lower priority.

Hereinafter, in the disclosure, descriptions of the examples will be provided via multiple embodiments, but these are not independent of each other, and it is possible that one or more embodiments are applied concurrently or in combination.

Hereinafter, an embodiment of the disclosure is described in detail with the accompanying drawings. Hereinafter, a base station is a subject that performs resource allocation to a terminal, and may be at least one of a gNode B, a gNB, an eNode B, a Node B, a base station (BS), a radio access unit, a base station controller, or a node on a network. A terminal may include a user equipment (UE), a mobile station (MS), a cellular phone, a smartphone, a computer, or a multimedia system capable of performing a communication function. Hereinafter, an embodiment of the disclosure will be described using the 5G system as an example, but the embodiment of the disclosure may also be applied to other communication systems having a similar technical background or channel type. For example, LTE or LTE-A mobile communication and a mobile communication technology developed after 5G may be included therein. Therefore, an embodiment of the disclosure may be applied to other communication systems via some modifications without departing from the scope of the disclosure, according to determination by those skilled in the art. Contents of the disclosure are applicable in FDD and TDD systems.

In addition, in description of the disclosure, when it is determined that a detailed description of a related function or configuration may unnecessarily obscure the subject matter of the disclosure, the detailed description thereof will be omitted. Terms to be described hereinafter are terms defined in consideration of functions in the disclosure, and may vary depending on intention or usage of users or operators. Therefore, the definition should be based on contents throughout the specification.

Hereinafter, in description of the disclosure, higher layer signaling may be signaling corresponding to at least one of the following signaling types or a combination of one or more thereof.

Master information block (MIB)

System information block (SIB) or SIB X (X=1, 2, . . . )

Radio resource control (RRC)

Medium access control (MAC) control element (CE)

In addition, L1 signaling may be signaling corresponding to at least one of signaling methods using the following physical layer channels or signaling types or a combination of one or more thereof.

Physical downlink control channel (PDCCH)

Downlink control information (DCI)

Terminal-specific (UE-specific) DCI

Group common DCI

Common DCI

Scheduling DCI (e.g., DCI used for scheduling downlink or uplink data)

Non-scheduling DCI (e.g., DCI not for scheduling of downlink or uplink data)

Physical uplink control channel (PUCCH)

Uplink control information (UCI)

Hereinafter, in the disclosure, determination of the priority between A and B may be mentioned in various ways, such as selecting one having a higher priority according to a predetermined priority rule so as to perform an operation corresponding thereto, or omitting or dropping an operation having a lower priority.

Hereinafter, in the disclosure, descriptions of the examples will be provided via multiple embodiments, but these are not independent of each other, and it is possible that one or more embodiments are applied concurrently or in combination.

[Relating to Multi-PDSCH/PUSCH Scheduling]

A new scheduling method has been introduced in Rel-17 new radio (NR) of 3^{rd} generation partnership project (3GPP). The disclosure relates to the new scheduling method. The new scheduling method introduced in Rel-17 NR is “multi-PDSCH scheduling” in which one piece of DCI enables scheduling of one or multiple PDSCHs and “multi-PUSCH scheduling” in which one piece of DCI enables scheduling of one or multiple PUSCHs. In multiple PDSCHs or multiple PUSCHs, each PDSCH or each PUSCH delivers a different transport block (TB). By using the multi-PDSCH scheduling and the multi-PUSCH scheduling, the base station does not schedule multiple pieces of DCI for scheduling of each of multiple PDSCHs or multiple PUSCHs for the terminal, and overhead of a downlink control channel may be thus reduced. However, since one piece of DCI for the multi-PDSCH scheduling and multi-PUSCH scheduling needs to include scheduling information for multiple PDSCHs or multiple PUSCHs, the size of the DCI may be increased. To this end, when multi-PDSCH scheduling and multi-PUSCH scheduling are configured for the terminal, a method for the terminal to properly interpret the DCI is required.

The disclosure provides descriptions of an example of multi-PDSCH scheduling, but the methods and/or embodiments proposed in the disclosure may also be used in multi-PUSCH scheduling.

The base station may configure multi-PDSCH scheduling for the terminal. For example, the base station may explicitly configure, for the terminal, multi-PDSCH scheduling in a higher layer signal (e.g., a radio resource control (RRC) signal). Alternatively, the base station may implicitly configure, for the terminal, multi-PDSCH scheduling in a higher layer signal (e.g., an RRC signal).

For multi-PDSCH scheduling for the terminal, the base station may configure a time domain resource assignment (TDRA) table via a higher layer signal (e.g., an RRC signal) as follows. One or multiple rows of the TDRA table may be included. The number of the rows may be configured to be up to N_rows, and a unique index may be assigned to each row. The unique index may be one value among 1, 2, . . . , N_row. For example, N_row may be 16. One or multiple pieces of scheduling information may be configured for each row. Here, when one piece of scheduling information is configured in one row, the row schedules one PDSCH. That is, when the row is indicated, it may be said that single-PDSCH scheduling is indicated. When multiple pieces of scheduling information are configured in one row, the multiple pieces of scheduling information are used to schedule multiple PDSCHs in order. That is, when the row is indicated, it may be interpreted that multi-PDSCH scheduling is indicated.

The scheduling information may be K0 values, SLIVs, and PDSCH mapping types. That is, when multi-PDSCH scheduling is indicated, the row may include multiple K0 values, SLIVs, and PDSCH mapping types. An N-th K0 value, an N-th SLIV, and an N-th PDSCH mapping type are scheduling information of an N-th PDSCH. For reference, one row may include a maximum of N_pdsch K0 values, SLIVs, and PDSCH mapping types. For example, N_pdsch=8. That is, one row may be for scheduling of up to 8 PDSCHs.

Here, K0 indicates a slot scheduled for a PDSCH, and represents a slot difference (offset) between a slot in which a PDCCH transmitting DCI for scheduling of the PDSCH is received and the slot scheduled for the PDSCH. For example, if K0=0, a slot in which the PDSCH is received is the same slot as a slot in which the PDCCH is received. Here, the starting and length indicator value (SLIV) indicates an index of a symbol in which the PDSCH starts and the number of consecutive symbols to which the PDSCH is allocated within one slot. The PDSCH mapping type indicates information related to a position of a first DMRS (front-loaded DMRS) of the PDSCH. For PDSCH mapping type A, the first DMRS (front-loaded DMRS) of the PDSCH may start at a third symbol or a fourth symbol of the slot, and for PDSCH mapping type B, the first DMRS (front-loaded DMRS) of the PDSCH may start at a first symbol of symbols in which the PDSCH is scheduled.

When the row of the TDRA table is configured in the higher layer signal, some of the K0 value, SLIV, PDSCH mapping type may be omitted from scheduling information. In this case, an omitted value may be interpreted to have a default value. For example, if K0 is omitted, a value of K0 may be interpreted to be 0. When the row of the TDRA table is configured, information other than the K0 value, SLIV, and PDSCH mapping type may be additionally configured.

In the following description, it is assumed that multi-PDSCH scheduling is configured for the terminal Here, the multi-PDSCH scheduling configuration may refer to configuration of multiple pieces of scheduling information in at least one row of the TDRA table. For reference, another row of the TDRA table may be for configuration of one piece of scheduling information. Therefore, even if multi-PDSCH scheduling is configured for the terminal, single-PDSCH scheduling may be indicated or multi-PDSCH scheduling may be indicated to the terminal depending on the row of the TDRA field of the received DCI. In other words, the multi-PDSCH scheduling indication is a case in which the row of the TDRA table indicated to the terminal from the DCI includes multiple pieces of scheduling information, and the single-PDSCH scheduling indication is a case in which the row of the TDRA table indicated to the terminal from the DCI includes one piece of scheduling information.

For single-PDSCH scheduling indication, one PDSCH is scheduled, and scheduling of the one PDSCH requires information, such as a modulation coding scheme (MCS), a new data indicator (NDI), a redundancy version (RV), and an HARQ process number (HPN). To this end, DCI indicating single-PDSCH scheduling needs to include information, such as MCS, NDI, RV, and HPN of the one PDSCH. More specifically,

The DCI indicating single-PDSCH scheduling may include one MCS field. An MCS (i.e., a modulation scheme and a code rate of a channel code) indicated in the MCS field may be applied to one PDSCH scheduled by the DCI.

The DCI indicating single-PDSCH scheduling may include a 1-bit NDI field. An NDI value may be acquired from the 1-bit NDI field, and whether one PDSCH transmits a new transport block or retransmits a previous transport block may be determined based on the NDI value.

The DCI indicating single-PDSCH scheduling may include a 2-bit RV field. An RV value may be acquired from the 2-bit RV field, and a redundancy version of one PDSCH may be determined based on the RV value.

The DCI for single-PDSCH scheduling may include one HPN field. The one HPN field may be 4 bits. (For reference, if the terminal supports up to 32 HARQ processes, the HPN field may be extended to 5 bits, but an assumption of 4 bits is made for the convenience in description of the disclosure). One HARQ process ID may be indicated via the one HPN field. The one HARQ process ID may be a PDSCH process ID of one scheduled PDSCH.

If DCI indicates multi-PDSCH scheduling, multiple PDSCHs are scheduled, and therefore each PDSCH needs information, such as an MCS, an NDI, an RV, and an HPN. To this end, the DCI indicating multi-PDSCH scheduling needs to include information, such as an MCS, an NDI, an RV, and an HPN of each scheduled PDSCH. More specifically,

The DCI indicating multi-PDSCH scheduling may include one MCS field. An MCS (i.e., a modulation scheme and a code rate of a channel code) indicated in the MCS field may be applied to all PDSCHs scheduled by the DCI. That is, in the DCI for multi-PDSCH scheduling, different PDSCHs may not be scheduled with different MCSs.

The DCI indicating multi-PDSCH scheduling may include a K-bit NDI field. Here, K may be a largest value in the number of scheduling information included in each row of the TDRA table. For example, when the TDRA table includes two rows, a first row includes 4 pieces of scheduling information, and a second row includes 8 pieces of scheduling information, K may equal to 8 (K=8). A k-th bit of the K-bit NDI field may indicate an NDI value of the PDSCH corresponding to k-th scheduling information. That is, a k-th PDSCH acquires the NDI value from the k-th bit of the K-bit NDI field, and whether the k-th PDSCH transmits a new transport block or retransmits a previous transport block may be determined based on the NDI value.

The DCI indicating multi-PDSCH scheduling may include a K-bit RV field. A k-th bit of the K-bit RV field may indicate an RV value of the PDSCH corresponding to k-th scheduling information. That is, the k-th PDSCH acquires the RV value from the k-th bit of the K-bit RV field, and a redundancy version of the k-th PDSCH may be determined based on the RV value.

The DCI indicating multi-PDSCH scheduling may include one HPN field. The one HPN field may be 4 bits. (For reference, if the terminal supports up to 32 HARQ processes, the HPN field may be extended to 5 bits, but an assumption of 4 bits is made for the convenience in description of the disclosure). One HARQ process ID may be indicated via the one HPN field. The one HARQ process ID may be an HARQ process ID of a first PDSCH among PDSCHs scheduled by the DCI indicating multi-PDSCH scheduling. Here, the first PDSCH corresponds to first scheduling information. HPNs of the PDSCHs may be sequentially increased by 1. That is, for a second PDSCH (corresponding to second scheduling information), an HPN is a value obtained by increasing the HARQ process ID of the first PDSCH by 1. For reference, if the HARQ process ID exceeds a maximum HARQ process ID number (numOfHARQProcessID) configured for the terminal, a modulo operation may be performed. In other words, if the HARQ process ID indicated by the DCI is “x”, the HARQ process ID of the k-th PDSCH may be determined as follows.

k-th PDSCH HPN=(x+k−1)modulo numOfHARQProcessID

As described above, if DCI indicates single-PDSCH scheduling, the DCI includes a 1-bit NDI field or a 2-bit RV field, and if DCI indicates multi-PDSCH scheduling, the DCI includes a K-bit NDI field or a K-bit RV field. For reference, single-PDSCH scheduling indication or multi-PDSCH scheduling indication may be performed in a TDRA field of the DCI (that is, whether single-PDSCH scheduling is indicated or multi-PDSCH scheduling is indicated is determined according to the number of pieces of scheduling information included in an indicated row of the TDRA field). Accordingly, one piece of DCI should support both single-PDSCH scheduling and multi-PDSCH scheduling. If a length of the DCI for single-PDSCH scheduling indication and a length of the DCI for multi-PDSCH scheduling indication are different from each other, “0” should be added (padded) to DCI of a shorter length so as to match the lengths.

A procedure of DCI interpretation by the terminal is as follows. The terminal receives DCI. In this case, it is assumed that a length of the DCI is the same as a longer DCI length among the length of the DCI for single-PDSCH scheduling indication and the length of the DCI for multi-PDSCH scheduling indication. The terminal may identify a position of the TDRA field in the DCI. The position of the TDRA field in the DCI for single-PDSCH scheduling indication and that in the DCI for multi-PDSCH scheduling indication may be the same. The terminal may determine, via the TDRA field, whether the DCI is for single-PDSCH scheduling indication or is for multi-PDSCH scheduling indication. If the number of pieces of scheduling information included in the indicated row of the TDRA field is one, the DCI is determined to be for single-PDSCH scheduling indication, and if the number of pieces of scheduling information included in the row is two or more, the DCI is determined to be for multi-PDSCH scheduling indication. If the terminal determines that the DCI is for single-PDSCH scheduling indication, the DCI may be interpreted according to the determination. That is, it may be interpreted that an NDI field is 1 bit and an RV field is 2 bits. If the terminal determines that the DCI is for multi-PDSCH scheduling indication, the DCI may be interpreted according to the determination. That is, it may be interpreted that the NDI field is K bits and the RV field is K bits. For reference, positions of other fields in the DCI may vary according to a length of the NDI field or a length of the RV field. Therefore, for other fields, according to whether the DCI is for single-PDSCH scheduling indication or for multi-PDSCH scheduling indication, bit lengths of other fields may be the same, but positions within the DCI may be different.

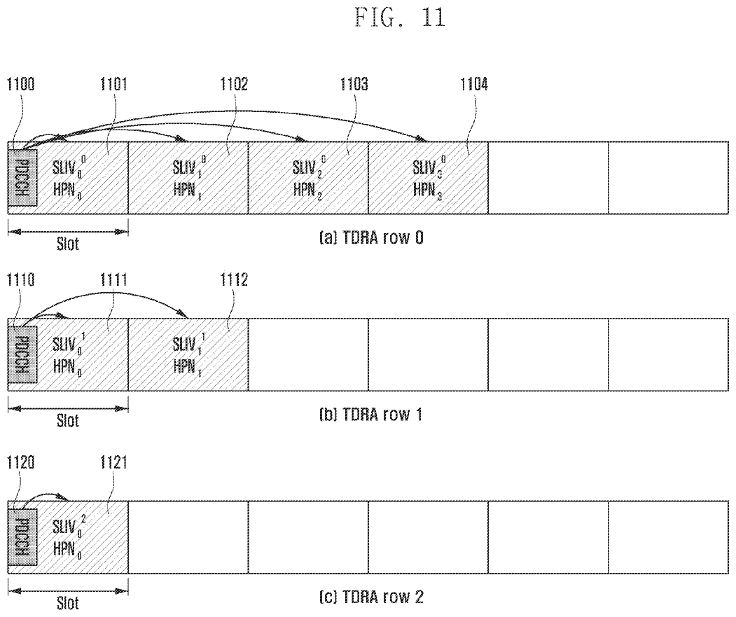

FIG. 11 illustrates a PDSCH scheduling scheme according to various embodiments of the disclosure.

A first row (row 0) of a TDRA table includes four pieces of scheduling information (K0 values, SLIVs, and PDSCH mapping types). A first SLIV is referred to as SLIV⁰₀, a second SLIV is referred to as SLIV⁰₁, a third SLIV is referred to as SLIV⁰₂, and a fourth SLIV is referred to as SLIV⁰₃. Accordingly, when a terminal is indicated with the first row (row 0) of the TDRA table, it may be determined that multi-PDSCH scheduling is indicated.

A second row (row 1) of the TDRA table includes two pieces of scheduling information (K0 values, SLIVs, and PDSCH mapping types). A first SLIV is referred to as SLIV¹₀, and a second SLIV is referred to as SLIV¹₁. Accordingly, when the terminal is indicated with the second row (row 1) of the TDRA table, it may be determined that multi-PDSCH scheduling is indicated.

A third row (row 2) of the TDRA table includes one piece of scheduling information (a K0 value, an SLIV, and a PDSCH mapping type). Here, the SLIV is referred to as SLIV²₀. Accordingly, if the terminal is indicated with the third row (row 2) of the TDRA table, it may be determined that single-PDSCH scheduling is indicated.

FIG. 11 part [a] illustrates a case in which the terminal is indicated with the first row (row 0) of the TDRA table. In DCI received by the terminal in a PDCCH 1100, the first row (row 0) may be indicated in the TDRA field. Accordingly, the terminal may receive four PDSCHs, based on four pieces of scheduling information (K0 values, SLIVs, or PDSCH mapping types) in the first row (row 0). Symbols for receiving a first PDSCH 1101 may be determined based on the first SLIV that is SLIV⁰₀, symbols for receiving a second PDSCH 1102 may be determined based on the second SLIV that is SLIV⁰₁, symbols for receiving a third PDSCH 1103 may be determined based on the third SLIV that is SLIV⁰₂, and symbols for receiving a fourth PDSCH 1104 may be determined based on the fourth SLIV that is SLIV⁰₃. Each of the four PDSCHs may have a unique HARQ process ID. That is, the first PDSCH may have HPN₀ as an HARQ process ID, the second PDSCH may have HPN₁ as an HARQ process ID, the third PDSCH may have HPN₂ as an HARQ process ID, and the fourth PDSCH may have HPN₃ as an HARQ process ID. Here, in the DCI, the HARQ process ID of the first PDSCH may be indicated. For example, in the DCI, HPN₀=0 may be indicated as the HARQ process ID of the first PDSCH. In this case, HPN₁=1 may be a PDSCH process ID of the second PDSCH, HPN₁=2 may be a PDSCH process ID of the third PDSCH, and HPN₁=3 may be a PDSCH process ID of the fourth PDSCH.

FIG. 11 part [b] illustrates a case in which the terminal is indicated with the second row (row 1) of the TDRA table. In DCI received by the terminal in a PDCCH 1110, the second row (row 1) may be indicated in the TDRA field. Accordingly, the terminal may receive two PDSCHs, based on two pieces of scheduling information (K0 values, SLIVs, or PDSCH mapping types) in the second row (row 1). Symbols for receiving a first PDSCH 1111 may be determined based on SLIV¹₀ that is the first SLIV, and symbols for receiving a second PDSCH 1112 may be determined based on SLIV¹₁ that is the second SLIV. Each of the two PDSCHs may have a unique HARQ process ID. That is, the first PDSCH may have HPN₀ as an HARQ process ID, and the second PDSCH may have HPN₁ as an HARQ process ID. Here, in the DCI, the HARQ process ID of the first PDSCH may be indicated. For example, HPN₀=0 may be indicated as the HARQ process ID of the first PDSCH in DCI. In this case, a PDSCH process ID of the second PDSCH may be HPN₁=1.

FIG. 11 part [c] illustrates a case in which the terminal is indicated with the third row (row 2) of the TDRA table. In DCI received by the terminal in a PDCCH 1120, the third row (row 2) may be indicated in the TDRA field. Accordingly, the terminal may receive one PDSCH, based on one piece of scheduling information (a K0 value, an SLIV, or a PDSCH mapping type) in the third row (row 2). Symbols for receiving one PDSCH 1121 may be determined based on SLIV²₀ that is one SLIV. In the DCI, an HARQ process ID of one PDSCH, which is, HPN₀, is indicated. For example, in the DCI, HPN₀=0 may be indicated as the HARQ process ID of the one PDSCH.

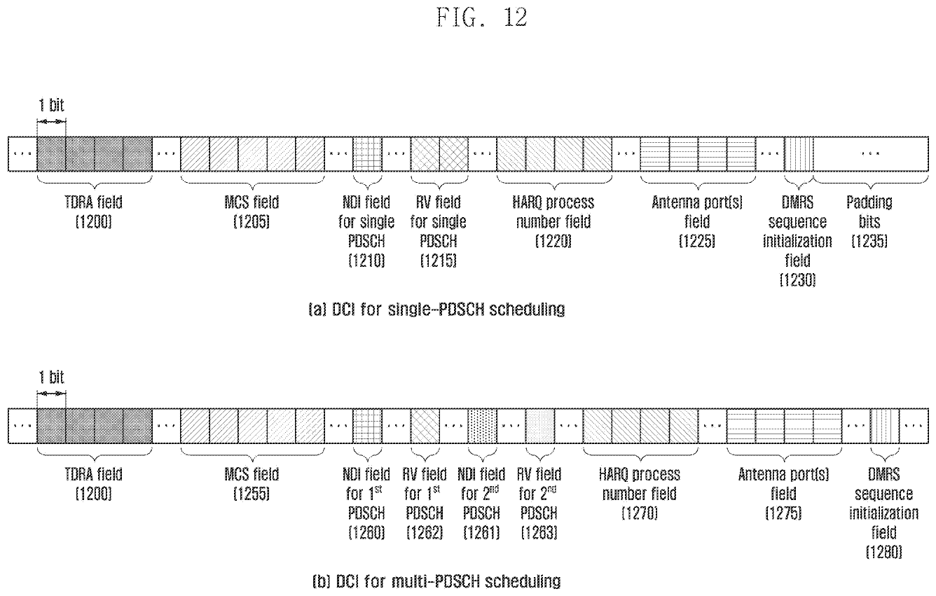

FIG. 12 illustrates DCI for single-PDSCH scheduling and multi-PDSCH scheduling according to various embodiments of the disclosure.

Referring to FIG. 12 parts [a] and [b], a terminal may determine a position of a TDRA field 1200 in received DCI. The position is the same position in single-PDSCH scheduling DCI and multi-PDSCH scheduling DCI. Whether the received DCI is single-PDSCH scheduling DCI or multi-PDSCH scheduling DCI may be determined based on a TDRA field value.

If a row (e.g., a third row (row 2) of the TDRA table) corresponding to the value of the TDRA field of the received DCI includes one piece of scheduling information a (K0 value, an SLIV, or a PDSCH mapping type), the terminal may interpret the DCI as single-PDSCH scheduling DCI, as in FIG. 12 part [a]. Referring to FIG. 12 part [a], the single-PDSCH scheduling DCI may include a 5-bit MCS field 1205, a 1-bit NDI field 1210, a 2-bit RV field 1215, and a 4-bit HARQ process number field 1220. The single-PDSCH scheduling DCI may include other fields. For example, an antenna port(s) field 1225, a DMRS sequence initialization field 1230, or the like may be included. If the single-PDSCH scheduling DCI is shorter than multi-PDSCH scheduling DCI, padding bits 1235 may be included.

If a row (e.g., a first row (row 0) or a second row (row 1) of the TDRA table) corresponding to a value of the TDRA field 1200 of the received DCI includes two or more pieces of scheduling information (K0 values, SLIVs, or PDSCH mapping types), the terminal may interpret the DCI as multi-PDSCH scheduling DCI, as in FIG. 12 part [b]. Referring to FIG. 12 part [b], the multi-PDSCH scheduling DCI may include a 5-bit MCS field 1255, K-bit NDI fields 1260 and 1261, a K-bit RV field 1262 and 1263, and a 4-bit HARQ process number field 1270. The multi-PDSCH scheduling DCI may include other fields. For example, an antenna port(s) field 1275, a DMRS sequence initialization field 1280, or the like may be included. For reference, DCI in which up to two PDSCHs are scheduled is shown in FIG. 12 part [b]. Here, the 2-bit NDI fields 1260 and 1261 are shown separately, but may be attached as one 2-bit field. In addition, in FIG. 12 part [b], the 2-bit RV fields 1262 and 1263 are shown separately, but may be attached as one 2-bit field.

Referring to FIG. 12 parts [a] and [b], it is assumed that a length of the DCI indicating single-PDSCH scheduling is shorter than a length of the DCI indicating multi-PDSCH scheduling, so that padding bits 1235 are added to the single-PDSCH scheduling DCI. If the length of the DCI indicating single-PDSCH scheduling is longer than the length of the DCI indicating multi-PDSCH scheduling, padding bits may be added to the DCI indicating multi-PDSCH scheduling.

Hereinafter, the disclosure assumes that a PDSCH transmits a single codeword unless otherwise specified. If transmission of two codewords is configured for a terminal, fields of DCI are for a first codeword unless otherwise specified.

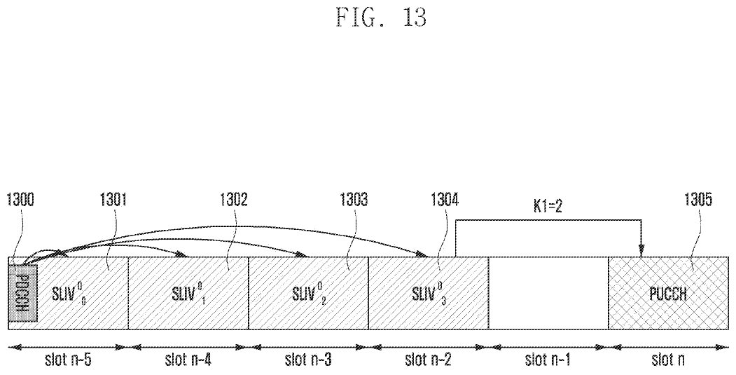

FIG. 13 is a diagram illustrating a method of transmitting HARQ-ACK of multiple PDSCHs according to an embodiment of the disclosure.

Referring to FIG. 13, descriptions are provided for a PUCCH 1305 for HARQ-ACK transmission of one or multiple PDSCHs scheduled by DCI received by the terminal in a PDCCH 1300 when the DCI indicates multi-PDSCH scheduling.

A base station may configure one or multiple K1 value(s) for a terminal. This may be referred to as set K1. DCI indicating multi-PDSCH scheduling may include an indicator indicating one K1 value in set K1. More specifically, the DCI may include a PDSCH-to-HARQ_feedback timing indicator field having up to 3 bits. The field may indicate one K1 value in set K1.

The terminal may determine a slot for transmission of HARQ-ACKs of multiple PDSCHs, based on one K1 value and a slot in which a last PDSCH of the multiple PDSCHs is scheduled. For reference, HARQ-ACKs of all PDSCHs scheduled via one piece of DCI may be transmitted through one PUCCH in a slot for transmission of the HARQ-ACK. A slot after K1 slots from a slot scheduled for a last PDSCH is a slot for transmission of HARQ-ACKs of multiple PDSCHs. That is, a PUCCH including the HARQ-ACKs of the multiple PDSCHs may be transmitted in a slot after K1 slots from the slot scheduled for the last PDSCH.

Referring to FIG. 13, it is assumed that DCI received by the terminal in a PDCCH 1300 indicates row 0 of the TDRA table as in FIG. 11, and according to row 0 of the TDRA table, a PDSCH has been scheduled in slot n−5, slot n−4, slot n−3, and slot n−2. In addition, it is assumed that the terminal is indicated with 2 as a K1 value. In this case, the terminal may determine slot n as a slot for transmission of HARQ-ACK, wherein slot n is two slots, i.e., the K1 value, after slot n−2 that is a last slot scheduled for the PDSCH. That is, in the PUCCH 1305 of slot n, the terminal may transmit HARQ-ACK information of a PDSCH 1301 of slot n−5, a PDSCH 1302 of slot n−4, a PDSCH 1303 of slot n−3, and a PDSCH 1304 of slot n−2.

The terminal may monitor a DCI format (e.g., DCI format 1_0, DCI format 1_1, or DCI format 1_2) so as to be scheduled with PDSCH reception. For reference, the terminal may be configured to monitor one or multiple of DCI formats (e.g., DCI format 1_0, DCI format 1_1, and DCI format 1_2) in a specific search space. Among the DCI formats, DCI format 1_1 may be used for multi-PDSCH scheduling. However, DCI format 1_0 and DCI format 1_2 cannot be used for multi-PDSCH scheduling.

More specifically, TDRA tables for PDSCH reception for each DCI format of the terminal are shown in Tables 24 to 25. The terminal may be configured with four TDRA tables from the base station as follows.

PDSCH-ConfigCommon includes pdsch-TimeDomainAllocationList

Since PDSCH-ConfigCommon is included in system information block 1 (SIB1), pdsch-TimeDomainAllocationList is a cell-common TDRA table. pdsch-TimeDomainAllocationList may include up to 16 rows, and the rows include a K0 value, an SLIV value, or a PDSCH mapping type. Here, one SLIV value exists, and therefore pdsch-TimeDomainAllocationList cannot be used for multi-PDSCH scheduling.

PDSCH-Config includes pdsch-TimeDomainAllocationList

Since PDSCH-Config is included in RRC parameters of the terminal, pdsch-TimeDomainAllocationList is a UE-specific TDRA table. pdsch-TimeDomainAllocationList may include up to 16 rows, and the rows include a K0 value, an SLIV value, or a PDSCH mapping type. Here, one SLIV value exists, and therefore pdsch-TimeDomainAllocationList cannot be used for multi-PDSCH scheduling.

PDSCH-Config includes pdsch-TimeDomainAllocationListForMultiPDSCH-r17

Since PDSCH-Config is included in RRC parameters of the terminal, pdsch-TimeDomainAllocationListForMultiPDSCH-r17 is a UE-specific TDRA table. pdsch-TimeDomainAllocationListForMultiPDSCH-r17 may include up to 64 rows, and the rows include a K0 value, an SLIV value, or a PDSCH mapping type. Here, there may be one or multiple K0 values and SLIV values. Therefore, pdsch-TimeDomainAllocationListForMultiPDSCH-r17 cannot be used for multi-PDSCH scheduling.

PDSCH-Config includes pdsch-TimeDomainAllocationListForDCI-Format1-2

Since PDSCH-Config is included in RRC parameters of the terminal, pdsch-TimeDomainAllocationListForDCI-Format1-2 is a UE-specific TDRA table. pdsch-TimeDomainAllocationList may include up to 16 rows, and the rows include a K0 value, an SLIV value, or a PDSCH mapping type. Here, one SLIV value exists, and therefore pdsch-TimeDomainAllocationList cannot be used for multi-PDSCH scheduling. In addition, pdsch-TimeDomainAllocationListForDCI-Format1-2 is applied only to DCI format 1_2.

Referring to Table 24 and Table 25, if the terminal receives the four configurations for the TDRA table, TDRA tables of DCI format 1_0, DCI format 1_1, and DCI format 1_2 monitored by the terminal for PDSCH reception may be determined as follows.

Table 24 shows the TDRA table of DCI format 1_0 and DCI format 1_1. First, when DCI format 1_0 and DCI format 1_1 are monitored in a common search space of CORESET0, if “PDSCH-ConfigCommon includes pdsch-TimeDomainAllocationList” is configured, the TDRA table is determined according to the configuration of “PDSCH-ConfigCommon includes pdsch-TimeDomainAllocationList”, and if “PDSCH-ConfigCommon includes pdsch-TimeDomainAllocationList” is not configured, a default A TDRA table is used. Here, the default A TDRA table is a TDRA table available for the terminal without a separate configuration, and is described in 3GPP standard document TS38.214. When DCI format 1_0 and DCI format 1_1 are monitored in a common search space of a CORESET other than CORESET0 or monitored in a UE-specific search space, the TDRA table is determined according to configuration of “PDSCH-Config includes pdsch-TimeDomainAllocationListForMultiPDSCH-r17” if “PDSCH-Config includes pdsch-TimeDomainAllocationListForMultiPDSCH-r17” is configured, the TDRA table is determined according to configuration of “PDSCH-Config includes pdsch-TimeDomainAllocationList” if “PDSCH-Config includes pdsch-TimeDomainAllocationListForMultiPDSCH-r17” is not configured and “PDSCH-Config includes pdsch-TimeDomainAllocationList” is configured, the TDRA table is determined according to “PDSCH-ConfigCommon includes pdsch-TimeDomainAllocationList” if “PDSCH-Config includes pdsch-TimeDomainAllocationListForMultiPDSCH-r17” and “PDSCH-Config includes pdsch-TimeDomainAllocationList” are not configured and “PDSCH-ConfigCommon includes pdsch-TimeDomainAllocationList” is configured, and the default A TDRA table is used if “PDSCH-ConfigCommon includes pdsch-TimeDomainAllocationList” is not configured.

TABLE 24

| | | | | PDSCH- | |
|---|---|---|---|---|---|
| | | | | Config | PDSCH |
| | | PDSCH- | PDSCH- | includes | time |
| | | ConfigCommon | Config | pdsch-TimeDomain | domain |
| | PDCCH | includes | includes | AllocationList | resource |
| | search | pdsch- | pdsch- | ForMultiPDSCH- | allocation |
| RNTI | space | TimeDomainAllocationList | TimeDomainAllocationList | r17 | to apply |
| C-RNTI, | Any | No | — | — | Default A |
| MCS-C- | common | Yes | — | — | pdsch- |
| RNTI, | search | | | | TimeDomainAllocationList |
| CS- | space | | | | provided in |
| RNTI | associated | | | | PDSCH- |
| | with | | | | ConfigCommon |
| | CORESET | | | | |
| | 0 | | | | |
| C-RNTI, | Any | No | No | — | Default A |
| MCS-C- | common | Yes | No | — | pdsch- |
| RNTI | search | | | | TimeDomainAllocationList |
| CS- | space not | | | | provided in |
| RNTI | associated | | | | PDSCH- |
| | with | | | | ConfigCommon |
| | CORESET | | | | |
| | 0 | | | | |
| | UE | No/Yes | Yes | — | pdsch- |
| | specific | | | | TimeDomainAllocationList |
| | search | | | | provided in |
| | space | | | | PDSCH- |
| | | | | | Config |
| | | No/Yes | — | Yes | pdsch- |
| | | | | | TimeDomainAllocationList |
| | | | | | ForMultiPDSCH- |
| | | | | | r17 |
| | | | | | provided in |
| | | | | | PDSCH- |
| | | | | | Config |

Table 25 shows the TDRA table of DCI format 1_2. The TDRA table is determined according to configuration of “PDSCH-Config includes pdsch-TimeDomainAllocationListForDCI-Format1-2” if “PDSCH-Config includes pdsch-TimeDomainAllocationListForDCI-Format1-2” is configured, the TDRA table is determined according to configuration of “PDSCH-Config includes pdsch-TimeDomainAllocationList” if “PDSCH-Config includes pdsch-TimeDomainAllocationListForDCI-Format1-2” is not configured and “PDSCH-Config includes pdsch-TimeDomainAllocationList” is configured, the TDRA table is determined according to configuration of “PDSCH-ConfigCommon includes pdsch-TimeDomainAllocationList” if “PDSCH-Config includes pdsch-TimeDomainAllocationListForDCI-Format1-2” and “PDSCH-Config includes pdsch-TimeDomainAllocationList” are not configured and “PDSCH-ConfigCommon includes pdsch-TimeDomainAllocationList” is configured, and the default A TDRA table is used if “PDSCH-ConfigCommon includes pdsch-TimeDomainAllocationList” is not configured.

TABLE 25

| PDSCH- | | PDSCH-Config | |
|---|---|---|---|
| ConfigCommon | PDSCH-Config | includes pdsch- | PDSCH time |
| includes pdsch- | includes pdsch- | TimeDomain | domain resource |
| TimeDomain | TimeDomain | AllocationListFor | allocation to |
| AllocationList | AllocationList | DCI-Format1-2 | apply |
| No | No | No | Default A |
| Yes | No | No | pdsch- |
| | | | TimeDomain |
| | | | AllocationList |
| | | | provided in |
| | | | PDSCH- |
| | | | ConfigCommon |
| No/Yes | Yes | No | pdsch- |
| | | | TimeDomain |
| | | | AllocationList |
| | | | provided in |
| | | | PDSCH-Config |
| No/Yes | No/Yes | Yes | pdsch- |
| | | | TimeDomain |
| | | | AllocationListDCI-1- |
| | | | 2 provided in |
| | | | PDSCH-Config |

Based on Tables 24 and 25, if the terminal is configured with “PDSCH-Config includes pdsch-TimeDomainAllocationListForMultiPDSCH-r17” that is TDRA table configuration information for multi-PDSCH scheduling, “PDSCH-Config includes pdsch-TimeDomainAllocationListForMultiPDSCH-r17” is applicable to DCI format 1_1. However, if “PDSCH-Config includes pdsch-TimeDomainAllocationListForMultiPDSCH-r17” cannot be applied to DCI format 1_0 or DCI format 1_2. Therefore, DCI format 1_0 and DCI format 1_2 cannot be used for multi-PDSCH scheduling.

The terminal may receive, from a higher layer, “pdsch-AggregationFactor in pdsch-config” or “pdsch-AggregationFactor in sps-Config” as a configuration for repeated PDSCH reception from the base station. If the terminal receives the configuration, repeated PDSCH reception may be performed according to the configuration. For example, pdsch-AggregationFactor may be configured to be one value among 2, 4, and 8. According to the configuration, a PDSCH may be repeatedly received in consecutive slots, and a reception symbol of the PDSCH in each slot may be determined to have the same SLIV. In addition, the same transport block (TB) may be repeatedly received in the consecutive slots.

“pdsch-AggregationFactor in pdsch-config” is applicable to a PDSCH scheduled in DCI format 1_1 or DCI format 1_2 in which a CRC is scrambled with C-RNTI, MCS-C-RNTI, or CS-RNTI with NDI=1. However, DCI format 1_0 is not applied. In addition, if multi-PDSCH scheduling (“PDSCH-Config includes pdsch-TimeDomainAllocationListForMultiPDSCH-r17”) is configured in DCI format 1_1, “pdsch-AggregationFactor in pdsch-config” is not applied to DCI format 1_1. In other words, if multi-PDSCH scheduling (“PDSCH-Config includes pdsch-TimeDomainAllocationListForMultiPDSCH-r17”) is configured in DCI format 1_1, “pdsch-AggregationFactor in pdsch-config” is applied only in DCI format 1_2.

“pdsch-AggregationFactor in sps-Config” is applicable to a PDSCH scheduled in DCI format 1_2 or DCI format 1_1, in which a CRC is scrambled with CS-RNTI with NDI=1, and a PDSCH scheduled using sps-Config without PDCCH transmission. However, “pdsch-AggregationFactor in sps-Config” is not applied to DCI format 1_0. In addition, if multi-PDSCH scheduling (“PDSCH-Config includes pdsch-TimeDomainAllocationListForMultiPDSCH-r17”) is configured in DCI format 1_1, “pdsch-AggregationFactor in sps-Config” is not applied to DCI format 1_1. In other words, if multi-PDSCH scheduling (“PDSCH-Config includes pdsch-TimeDomainAllocationListForMultiPDSCH-r17”) is configured in DCI format 1_1, “pdsch-AggregationFactor in sps-Config” is applied only in DCI format 1_2.

[Relating to Type-1 HARQ-ACK Codebook]

In the NR system, a Type-1 HARQ-ACK codebook is also referred to as a semi-static HARQ-ACK codebook.

The following description corresponds to a situation in which the number of PUCCHs through which a terminal is able to transmit HARQ-ACK information within one time unit (e.g., a slot, a sub-slot, or a mini-slot) is limited to one. Unless otherwise specified, the time unit is described as a slot, but may be extended to a sub-slot, a mini-slot, and the like.

A terminal may be configured with a semi-static HARQ-ACK codebook configuration from a base station. The configuration may be performed via a higher layer signal (e.g., an RRC signal). The terminal may receive a DCI format from the base station. The terminal may transmit HARQ-ACK information of an SCell dormancy indication, an SPS PDSCH release, or a PDSCH scheduled by the DCI format, in a slot indicated by a value of a PDSCH-to-HARQ_feedback timing indicator in the DCI format. If the terminal is indicated to transmit multiple pieces of HARQ-ACK information in one slot, the terminal may generate the HARQ-ACK information as an HARQ-ACK codebook according to a predetermined rule and transmit the same via one PUCCH in the slot.

More specific rules for generating a semi-static HARQ-ACK codebook are as follows.

The terminal may report NACK for an HARQ-ACK information bit value within the HARQ-ACK codebook, in a slot that is not indicated by the PDSCH-to-HARQ_feedback timing indicator field in the DCI format.

If the terminal reports only HARQ-ACK information for one SPS PDSCH release or one PDSCH reception in all M_{A,C} cases for candidate PDSCH reception, and when the report is scheduled by DCI format 1_0 including information indicating that a counter DACI field indicates 1 in a PCell, the terminal may determine one HARQ-ACK codebook for the SPS PDSCH release or the PDSCH reception.

Otherwise, a method of determining an HARQ-ACK codebook according to the method described below is followed.

For convenience of the disclosure, a PDSCH-to-HARQ_feedback timing indicator value is referred to as a K1 value. The terminal may be configured with multiple K1 values, and the multiple K1 values are collectively referred to as set K1.

A set of PDSCH reception candidate occasions in serving cell c is referred to as M_{A,c}, and a method for obtaining M_{A,c} will be described later.

<Type-1 HARQ-ACK Codebook for Single PDSCH Reception>

First, it is assumed that a PDSCH scheduled by a DCI format is received in one slot. This may include a case where pdsch-AggregationFactor is not configured from a higher layer.

When a PUCCH or PUSCH delivering a Type-1 HARQ-ACK codebook is transmitted in slot n, pseudo-codes for this are as follows.

[Pseudo-Code 1: (No Repeated PDSCH Reception)]
Preparation operation: Set R is a set of scheduling information (slot information (hereinafter, K0 value) to which a PDSCH is mapped, and start symbol and length information (hereinafter, a starting and length value (SLIV)) configured in a time domain resource assignment (TDRA) table. If the terminal monitors one or more DCI formats, and the DCI formats use different TDRA tables, the set R is generated based on all TDRA tables.
Operation 0: MA,c is initialized to an empty set. k is initialized to 0. j is initialized to 0.
Operation 1: A k-th largest K1 value is selected from configured set K1. (For example, if k=0, a largest K1 value is selected from the set K1, and if k=1, a second largest K1 value is selected from the set K1.) The K1 value is K1,k.
Operation 2: If a symbol corresponding to start symbol and length information (SLIV) belonging to each row of set R and a symbol configured for uplink in a higher layer overlap in a slot (slot n−K1,k) corresponding to a value of K1,k, the row may be excluded from set R.
Operation 3-1 (if the terminal has only UE capability of receiving a maximum of one unicast PDSCH in one slot): If determined set R is not an empty set, j is added as a new PDSCH reception candidate occasion to set MA,c. When one of PDSCH candidates of set R is received, the terminal may place HARQ-ACK of the one PDSCH in the new PDSCH candidate occasion of j. j is increased by 1.
Operation 3-2 (if the terminal has UE capability of receiving more than one unicast PDSCH in one slot): For an SLIV that ends first in determined set R and SLIVs which overlap the SLIV in time, j is added as a new PDSCH reception candidate occasion to set MA,c. When one of PDSCH candidates having the SLIV is received, the terminal may place HARQ-ACK of the one PDSCH in the new PDSCH candidate occasion of j. j is increased by 1. The SLIVs are excluded from set R. Operation 3-2 is repeated until set R becomes an empty set.
Operation 4: k is increased by 1. If k is smaller than a cardinality of set K1, operations are started again from operation 2, and if k is equal to or greater than the cardinality of set K1, pseudo-code 1 ends.

[End of Pseudo-Code 1]

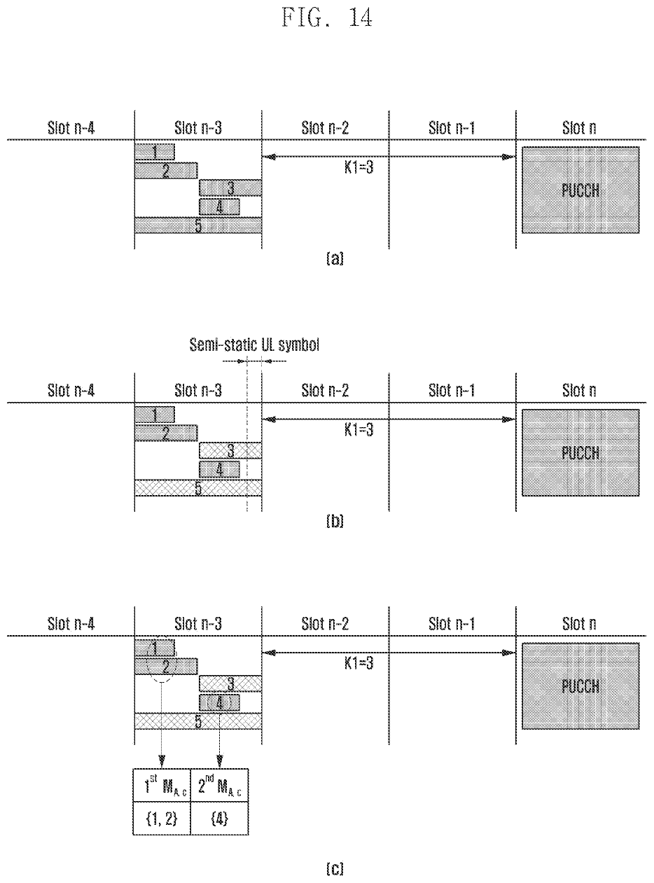

FIG. 14 is a diagram illustrating an example for describing a pseudo-code for generating an HARQ-ACK codebook for a PDSCH received in one slot, according to various embodiments of the disclosure.

Referring to FIG. 14, pseudo-code 1 described above will be described. PUCCH transmission including HARQ-ACK information may be performed in slot n. For example, the HARQ-ACK information may be generated in the form of a Type-1 HARQ-ACK codebook.

It is assumed that K1=3 is configured as a K1 value for the terminal. In addition, the TDRA table of the DCI format monitored by the terminal may include 5 rows as in Table 26. For reference, a K0 value, an SLIV value, or a PDSCH mapping type value may be configured in each row, but a PDSCH mapping type is omitted for convenience of description.

TABLE 26

| Index | K0 | SLIV (S, L) |
|---|---|---|
| 1 | 0 | SLIV 1 (0, 4) |
| 2 | 0 | SLIV 2 (0, 7) |
| 3 | 0 | SLIV 3 (7, 7) |
| 4 | 0 | SLIV 4 (7, 4) |
| 5 | 0 | SLIV 5 (0, 14) |

The terminal may include, in set R, each row of the TDRA table in Table 26 according to the preparation operation in pseudo-code 1. FIG. 14 part [a] shows SLIVs according to the respective rows of Table 26. The terminal may determine PDSCH reception candidate occasion M_{A,c}, based on the K1 value and set R. Referring to 14A to 14C, pseudo-code 1 may be interpreted as follows. In the following description, it is assumed that the terminal has UE capability of receiving more than one unicast PDSCH in one slot.
Operation 0: M_{A,c} is initialized to an empty set. k is initialized to 0. j is initialized to 0.
Operation 1: A k-th (k=0) largest K1 value is selected from configured set K1. The K1 value is K_{1,0}=3.
Operation 2: If a symbol corresponding to start symbol and length information (SLIV) belonging to each row of set R and a symbol configured for uplink in a higher layer overlap in slot n−K_{1,0}=slot n−3, the row may be excluded from set R. Referring to FIG. 14 part [b], if some symbols of slot n−3 are semi-static UL symbols configured via a higher layer, rows including SLIVs overlapping the symbol may be excluded from set R. Referring to FIG. 14 part [b], last two symbols of slot n−3 may be semi-static uplink symbols, and SLIV (7,7) in row 3 and SLIV (0,14) in row 5 overlap with the semi-static uplink symbol so as to be excluded from set R. Set R may include rows 1, 2, and 4.
Operation 3-2 (if the terminal has UE capability of receiving more than one unicast PDSCH in one slot):

For an SLIV that ends first in determined set R and SLIVs which overlap the SLIV in time, j=0 is added as a new PDSCH reception candidate occasion to set M_{A,c}. Here, the SLIV that ends first is SLIV (0,4) of row 1, and an SLIV overlapping the SLIV is SLIV (0,7) of row 2. Therefore, if j=0 is added to M_{A,c} and the terminal receives a PDSCH scheduled with SLIV (0,4) of row 1 or SLIV (0,7) of row 2, HARQ-ACK of the PDSCH may be included in a position corresponding to first (j=0) M_{A,c} in the Type-1 HARQ-ACK codebook. j is increased by 1 so that j=1. the SLIVs of rows 1 and 2 are excluded from set R so that R={4}. Set R is not an empty set, and operation 3-2 is thus repeated.

For the SLIV that ends first in determined set R and the SLIVs which overlap the SLIV in time, j=1 is added as a new PDSCH reception candidate occasion to set M_{A,c}. Here, the SLIV that ends first is SLIV (7,4) of row 4, and there is no SLIV overlapping the SLIV. Therefore, if j=1 is added to M_{A,c} and the terminal receives a PDSCH scheduled with SLIV (7,4) of row 4, HARQ-ACK of the PDSCH may be included in a position corresponding to second (j=1) M_{A,c}, in the Type-1 HARQ-ACK codebook. j is increased by 1 so that j=1. The SLIV of row 4 is excluded from set R, and thus set R is an empty set. Therefore, operation 3-2 may end (FIG. 14 part [c]).
Operation 4: k is increased by 1 so that k=1. Since k=1 is equal to the cardinality of set K1, which is 1, pseudo-code 1 ends.

Therefore, referring to 14, the terminal may determine two PDSCH reception candidate occasions of j=0 and j=1 M_{A,c}. The size of the Type-1 HARQ-ACK codebook may be determined according to the number of PDSCH reception candidate occasions. The actual number of bits per PDSCH reception candidate occasion may be determined according to a configuration, such as the number of transport blocks included in each PDSCH, the number of code block groups (CBGs) included in each PDSCH, or spatial bundling.

<Type-1 HARQ-ACK Codebook for Single PDSCH Reception and Repeated PDSCH Reception>

The terminal may receive PDSCHs delivering the same transport block (TB) in multiple slots from the base station. This may include a case where pdsch-AggregationFactor is configured from a higher layer. For reference, if the terminal is configured with pdsch-AggregationFactor, a PDSCH scheduled in a first DCI format may be repeatedly received in multiple slots according to pdsch-AggregationFactor, but a PDSCH scheduled in a second DCI format may be received in one slot. Here, the first DCI format may be referred to as non-fallback DCI or may be referred to as DCI format 1_1 or DCI format 1_2. The second DCI format may be referred to as fallback DCI or may be referred to as DCI format 1_0.

Even if the terminal receives PDSCHs in the multiple slots, since the PDSCHs received in the multiple slots transmit the same TB, the terminal may transmit HARQ-ACK information for the TB to the base station. In other words, the terminal may not transmit HARQ-ACK information of each PDSCH received in each slot to the base station.

If pdsch-AggregationFactor is configured, the terminal may generate a Type-1 HARQ-ACK codebook by assuming that PDSCHs are received in multiple slots. Here, the terminal may receive a PDSCH scheduled in the second DCI format only in one slot, but when generating the Type-1 HARQ-ACK codebook, it is assumed that PDSCHs are received in multiple slots, as the PDSCHs scheduled in the first DCI format.

When a PUCCH or PUSCH delivering a Type-1 HARQ-ACK codebook is transmitted in slot n, pseudo-codes for this are as follows.

[Pseudo-Code 2: (Repeated PDSCH Reception Configured)]
Preparation operation: Set R is a set of scheduling information (slot information (hereinafter, K0 value) to which a PDSCH is mapped, and start symbol and length information (hereinafter, a starting and length value (SLIV)) configured in a time domain resource assignment (TDRA) table. If the terminal monitors one or more DCI formats, and the DCI formats use different TDRA tables, the set R is generated based on all TDRA tables. N_{PDSCH}^{max} may be configured to be a value of pdsch-AggregationFactor.
Operation 0: M_{A,c} is initialized to an empty set. k is initialized to 0. j is initialized to 0.
Operation 1: A k-th largest K1 value is selected from configured set K1. (For example, if k=0, a largest K1 value is selected from the set K1, and if k=1, a second largest K1 value is selected from the set K1.) The K1 value is K_{1,k}.
Operation 2: If a symbol corresponding to start symbol and length information (SLIV) belonging to each row of set R and a symbol configured for uplink in a higher layer overlap in each of previous N_{PDSCH}^{max} slots from a slot (slot n−K_{1,k}) corresponding to a K_{1,k} value, the row may be excluded from set R.
Operation 3-1 (if the terminal has only UE capability of receiving a maximum of one unicast PDSCH in one slot): If determined set R is not an empty set, j is added as a new PDSCH reception candidate occasion to set M_{A,c}. If one of PDSCH candidates of set R is received (regardless of being received repeatedly in multiple slots or being received in one slot, if a last reception slot is a slot (slot n−K_{1,k}) corresponding to a K_{1,k} value), the terminal may place HARQ-ACK of the PDSCH in the new PDSCH candidate occasion of j. j is increased by 1.
Operation 3-2 (if the terminal has UE capability of receiving more than one unicast PDSCH in one slot): For an SLIV that ends first in determined set R and SLIVs which overlap the SLIV in time, j is added as a new PDSCH reception candidate occasion to set M_{A,c}. If one of PDSCH candidates having the SLIV is received (regardless of being received repeatedly in multiple slots or being received in one slot, if a last reception slot is a slot (slot n−K_{1,k}) corresponding to a K_{1,k} value), the terminal may place HARQ-ACK of the PDSCH in the new PDSCH candidate occasion of j. j is increased by 1. The SLIVs are excluded from set R. Operation 3-2 is repeated until set R is empty.
Operation 4: k is increased by 1. If k is smaller than a cardinality of set K1, operations are started again from operation 2, and if k is equal to or greater than the cardinality of set K1, pseudo-code 2 ends.

[End of Pseudo-Code 2]

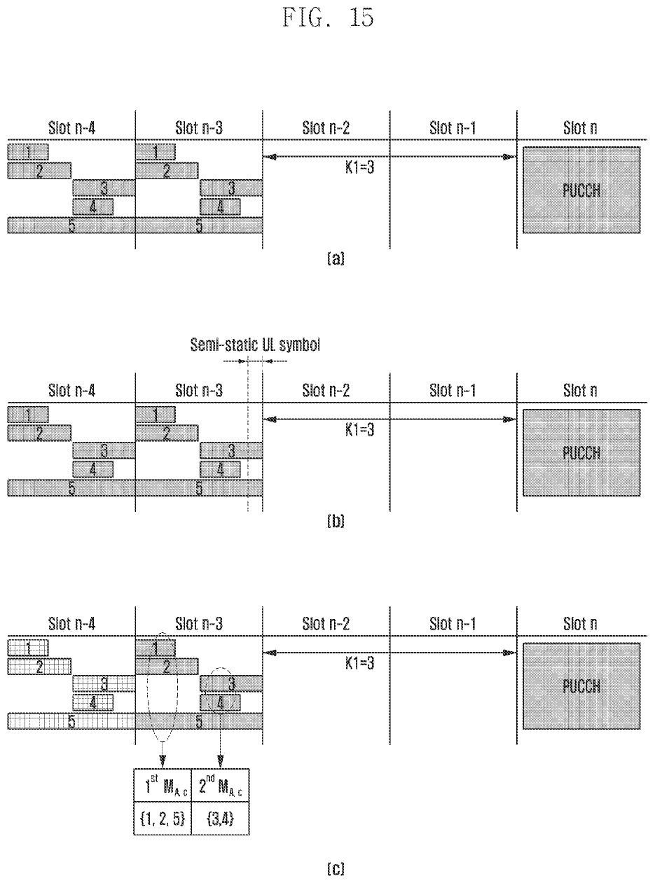

FIG. 15 is a diagram illustrating an example for describing a pseudo-code for generating an HARQ-ACK codebook for a PDSCH repeatedly received in multiple slots, according to various embodiments of the disclosure.

Referring to FIG. 15, pseudo-code 2 described above will be described. PUCCH transmission including HARQ-ACK information may be performed in slot n. For example, the HARQ-ACK information may be generated in the form of a Type-1 HARQ-ACK codebook.

It is assumed that K1=3 is configured as a K1 value for the terminal. In addition, the TDRA table of the DCI format monitored by the terminal may include 5 rows as in Table 26. The terminal may include, in set R, each row of the TDRA table in Table 26 according to the preparation operation. For reference, in Table 26, some rows may belong to the TDRA table of the first DCI format, and some rows may belong to the TDRA table of the second DCI format. For example, rows of indices 1, 2, and 3 may belong to the TDRA table of the first DCI format, and rows of indices 4 and 5 may belong to a TDRA table of the second DCI format. However, set R is a union of all rows regardless of DCI formats to which the rows belong.

Referring to FIG. 15, N_{PDSCH}^{max} is assumed to be 2. FIG. 15 part [a] shows SLIVs according to the respective rows of Table 26. Here, when a Type-1 HARQ-ACK codebook is generated, N_{PDSCH}^{max} is assumed to be 2, and it may be thus considered that a PDSCH is repeatedly received in slot n−3 and slot n−4.

The terminal may determine a PDSCH reception candidate occasion M_{A,c}, based on the K1 value, set R, and N_{PDSCH}^{max}. Referring to FIG. 15, pseudo code 2 may be interpreted as follows. In the following description, it is assumed that the terminal has UE capability of receiving more than one unicast PDSCH in one slot.
Operation 0: M_{A,c} is initialized to an empty set. k is initialized to 0. j is initialized to 0.
Operation 1: A k-th (k=0) largest K1 value is selected from configured set K1. The K1 value is K_{1,0}=3.
Operation 2: If a symbol corresponding to start symbol and length information (SLIV) belonging to each row of set R and a symbol configured for uplink in a higher layer overlap in each of previous N_{PDSCH}^{max}=2 slots (i.e., slot n−3 and slot n−4) from slot n−K_{1,0}=slot n−3, the row may be excluded from set R. In other words, only if a symbol corresponding to start symbol and length information (SLIV) belonging to each row of set R and a symbol configured for uplink in a higher layer overlap commonly in (both) slot n−3 and slot n−4, the corresponding row may be excluded from set R. Referring to FIG. 15 part [b], it is assumed that a semi-static uplink symbol is configured for last two symbols of slot n−3. In this case, SLIV (7,7) of row 3 and SLIV (0,14) of row 5 overlap the semi-static uplink symbol in slot n−3, but do not overlap the semi-static uplink symbol in slot n−4, and thus the corresponding rows may not be excluded from set R. Therefore, set R may include rows 1, 2, 3, 4, and 5.
Operation 3-2 (if the terminal has UE capability of receiving more than one unicast PDSCH in one slot):

For an SLIV that ends first in determined set R and SLIVs which overlap the SLIV in time, j=0 is added as a new PDSCH reception candidate occasion to set M_{A,c}. Here, the SLIV that ends first is SLIV (0,4) of row 1, and the SLIVs overlapping the SLIV is SLIV (0,7) of row 2 and SLIV (0,14) of row 5. Therefore, if j=0 is added to M_{A,c} and the terminal receives a PDSCH scheduled with SLIV (0,4) of row 1, SLIV (0,7) of row 2, or SLIV (0,14) of row 5, HARQ-ACK of the PDSCH may be included in a position corresponding to first (j=0) M_{A,c} in the Type-1 HARQ-ACK codebook. j is increased by 1 so that j=1. The SLIVs of row 1, row 2, and row 5 are excluded from set R so that R={3,4}. Set R is not an empty set, and operation 3-2 is thus repeated.

For the SLIV that ends first in determined set R and the SLIVs which overlap the SLIV in time, j=1 is added as a new PDSCH reception candidate occasion to set M_{A,c}. Here, the SLIV that ends first is SLIV (7,4) of row 4, and an SLIV overlapping the SLIV is SLIV (7,7) of row 3. Therefore, if j=1 is added to M_{A,c} and the terminal receives a PDSCH scheduled with SLIV (7,7) of row 3 or SLIV (7,4) of row 4, HARQ-ACK of the PDSCH may be included in a position corresponding to second (j=1) M_{A,c} in the Type-1 HARQ-ACK codebook. j is increased by 1 so that j=1. The SLIVs of row 3 and row 4 are excluded from set R, and thus set R is an empty set. Therefore, operation 3-2 may end (FIG. 15 part [c]).
Operation 4: k is increased by 1 so that k=1. Since k=1 is equal to the cardinality of set K1, which is 1, pseudo-code 2 ends.

Therefore, referring to FIG. 15, the terminal may determine M_{A,c} for two PDSCH reception candidate occasions of j=0 and j=1. The size of the Type-1 HARQ-ACK codebook may be determined according to the number of PDSCH reception candidate occasions. The actual number of bits per PDSCH reception candidate occasion may be determined according to a configuration, such as the number of transport blocks included in each PDSCH, the number of code block groups (CBGs) included in each PDSCH, or spatial bundling.

In comparison with pseudo-code 1 (no repeated PDSCH reception), the biggest difference of pseudo-code 2 (repeated PDSCH reception configured) is the SLIVs excluded from set R according to operation 2. Referring to FIG. 14 part [b], when the terminal does not repeatedly receive a PDSCH, the terminal may receive a PDSCH only in slot n−3, so that, if an SLIV of the PDSCH overlaps the semi-static uplink symbol in the slot, the SLIV may be excluded from set R. On the other hand, referring to FIG. 15 part [b], when the terminal repeatedly receives a PDSCH, the terminal may receive the PDSCH in multiple slots (e.g., slot n−3 and slot n−4), so that, if an SLIV of the PDSCH does not overlap the semi-static uplink symbol in at least one of the multiple slots, the SLIV may not be excluded from set R. In other words, if the SLIV of the PDSCH overlaps the semi-static uplink symbol in all slots, the SLIV may be excluded from set R. Therefore, compared to pseudo-code 1, pseudo-code 2 may include more PDSCH reception candidate occasions.

In the above, it is said that some indices in Table 26 may belong to the TDRA table of the second DCI format. The PDSCH scheduled in the second DCI format may be received in one slot. However, the terminal may generate a Type-1 HARQ-ACK codebook by assuming that the terminal repeatedly receives all rows in N_{PDSCH}^{max} slots, as in a case of being scheduled in the first DCI format. As mentioned earlier, if repeated reception is assumed, more PDSCH reception candidate occasions may be included, and thus HARQ-ACK information of the PDSCH scheduled in the second PDSCH format may also be included in the Type-1 HARQ-ACK codebook.

Aforementioned pseudo-codes 1 and 2 are described in 9.1.2.1 of 3GPP standard document TS38.213. In the disclosure, for description, the pseudo-code of v16.6.0 of the standard document will be described. The pseudo-code is as shown in Table 27.

```
TABLE 27
[TS38.213 v16.6.0 pseudo-code]
Set j=0 - index of occasion for candidate PDSCH reception or SPS PDSCH release
Set B=Ø
Set M_{A,c} =Ø
Set C(K₁) to the cardinality of set K₁
Set k =0 − index of slot timing values K_{1,k}, in descending order of the slot timing
values, in set K₁ for serving cell C
while k <C(K₁)
  if mod(n_{U} - K_{1,k} +1,max (2^{μ}^{_{UL}} ^{-μ}^{_{DL}} ,1))=0
    Set n_{D} =0 − index of a DL slot within an UL slot
    while n_{D} < max(2^{μ}^{_{UL}} ^{-μ}^{_{DL}} ,1)
        Set R to the set of rows
        Set C(R) to the cardinality of R
        Set r=0 − index of row in set R
        if slot n_{U} starts at a same time as or after a slot for an active DL BWP
        change on serving cell c or an active UL BWP change on the PCell and slot
        └(n_{U} − K_{1,k})·2^{μ}^{_{UL}} ^{-μ}^{_{DL}}┘+n_{D} is before the slot for the active DL BWP change on
        serving cell c or the active UL BWP change on the PCell
          n_{D} = n_{D} + 1;
        else
          while r < c(R)
            if the UE is provided tdd-UL-DL-ConfigurationCommon, or tdd-UL-
            DL-ConfigurationDedicated and, for each slot from slot
            └(n_{U} − K_{1,k}) · 2^{μ}^{_{UL}} ^{-μ}^{_{DL}}┘ + n_{D} − N_{PDSCH}^{repeat,max} + 1 to slot
            └(n_{U} − K_{1,k}) · 2^{μ}^{_{UL}} ^{-μ}^{_{DL}}┘ + n_{D}, at least one symbol of the PDSCH
            time resource derived by row r is configured as UL where K_{1,k} is the k-
            th slot timing value in set K₁ ,
              R=R\r ;
            else
              r = r + 1 ;
            end if
          end while
          if the UE does not indicate a capability to receive more than one unicast
            PDSCH per slot and R≠Ø,
            M_{A,c} = M_{A,c} ∪ j ;
            j = j+1;
          else
            Set C(R) to the cardinality of R
            Set m to the smallest last OFDM symbol index, as determined by the
              SLIV, among all rows of R
            while R≠Ø
              Set r=0
              while r <C(R)
                if S≤m for start OFDM symbol index S for row r
                  b_{r,k,n}_{_{D}} = j ; - index of occasion for candidate PDSCH reception
                    or SPS PDSCH release associated with row r
                  R=R\r ;
                  B = B∪b_{r,k,n}_{_{D}} ;
                else
                  r = r + 1 ;
                end if
              end while
              M_{A,c} = M_{A,c} ∪ j;
              j = j + 1 ;
              Set m to the smallest last OFDM symbol index among all rows of
                R ;
            end while
          end if
          n_{D} = n_{D} + 1;
        end if
    end while
  end if
  k = k + 1 ;
      end while
```

Definitions of the above pseudo-code symbols may be found in 3GPP standard document TS38.213.

<Type-1 HARQ-ACK Codebook for Multi-PDSCH Reception>

The terminal may be configured with multi-PDSCH scheduling. That is, the terminal may be configured with a TDRA table having rows including multiple pieces of scheduling information. Detailed descriptions of multi-PDSCH scheduling have been described above.

The terminal may receive PDSCHs delivering different TBs in multiple slots according to multi-PDSCH scheduling. Since the PDSCHs received in the multiple slots transmit different TBs, HARQ-ACK information for each of the TBs may be transmitted to the base station. In other words, the terminal needs to transmit, to the base station, HARQ-ACK information of each of the PDSCHs received in the respective slots.

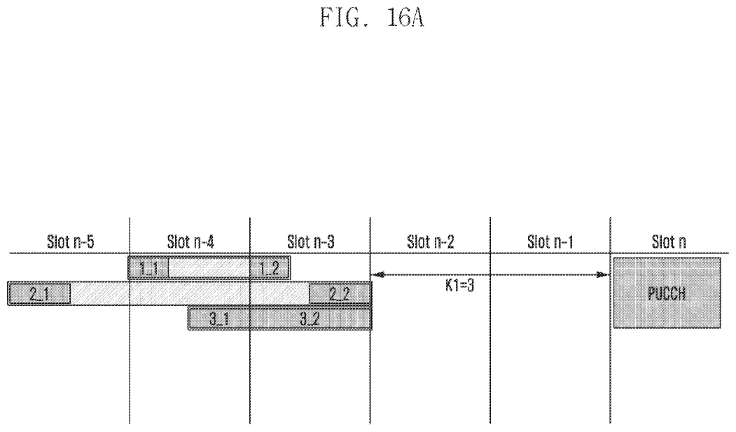

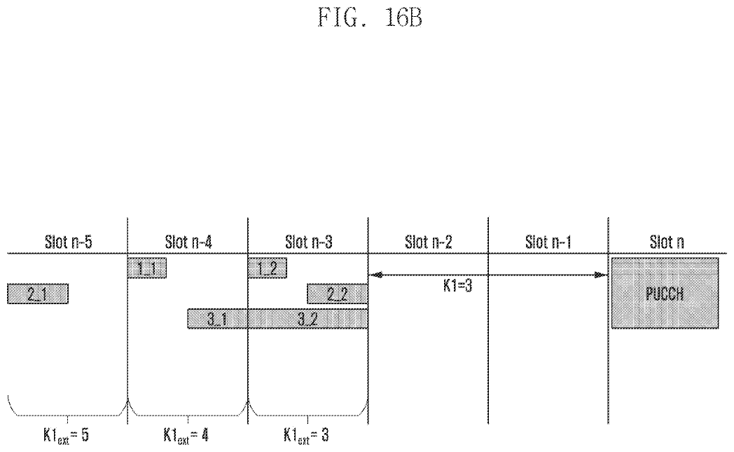

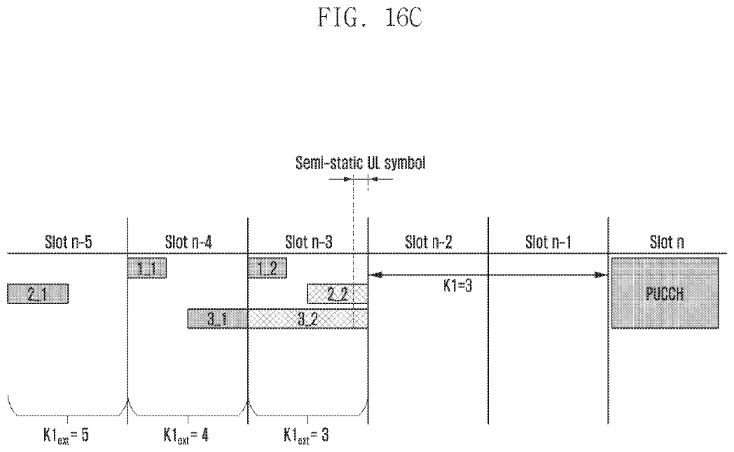

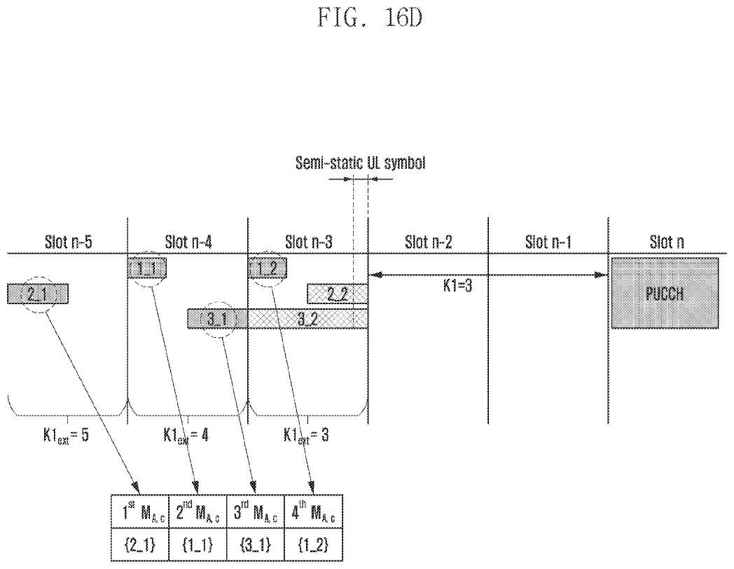

To this end, K1 set extension has been introduced to the Type-1 HARQ-ACK codebook. Descriptions are provided with reference to FIG. 28 or FIGS. 16A and 16B.

First, as in Table 28, the terminal may be configured with a TDRA table having rows including multiple pieces of scheduling information. Table 28 is only an example to help understanding of the disclosure, and does not limit the technical scope of the disclosure. Accordingly, it goes without saying that the TDRA table may be configured so that each row includes one piece of scheduling information or includes three or more pieces of scheduling information, or different rows include different numbers of pieces of scheduling information.

TABLE 28

| | First scheduling | | Second scheduling | |
|---|---|---|---|---|
| | information | | information | |
| Index | K0 | SLIV (S, L) | K0 | SLIV (S, L) |
| 1 | 0 | SLIV 1_1 (0, 4) | 1 | SLIV 1_2 (0, 4) |
| 2 | 0 | SLIV 2_1 (0, 7) | 2 | SLIV 2_2 (7, 7) |
| 3 | 0 | SLIV 3_1 (7, 7) | 1 | SLIV 3_2 (0, 14) |

FIG. 16A is a diagram illustrating an example of describing PDSCHs based on a TDRA table including multiple pieces of scheduling information according to an embodiment of the disclosure. FIG. 16A shows SLIVs of PDSCHs that may be received according to the TDRA table of Table 28. For reference, in FIG. 16A, X_Y may indicate an SLIV according to Y-th scheduling information of row index X of the TDRA table. Here, it is assumed that a K1 value is 3, and HARQ-ACKs of the PDSCHs are transmitted in slot n. That is, an SLIV of last scheduling information according to the TDRA table appears in slot n−3 that is a value of slot n−K1. In addition, a difference between K0 values of scheduling information is an offset (i.e., the number of slots between two slots) between slots in which two SLIVs of the scheduling information are located.

Referring to FIG. 16A, 4 symbols from symbol 0 of slot n−3 correspond to SLIV 1_2 according to last (second) scheduling information of a row having an index of 1. In addition, an offset, which is a difference between K0 values of first scheduling information and second scheduling information, is 1, and therefore 4 symbols from symbol 0 correspond to SLIV 1_1 according to first scheduling information in slot n−3−offset=slot n−4.

According to last (second) scheduling information of a row having an index of 2, 7 symbols from symbol 7 of slot n−3 correspond to SLIV 2_2. In addition, the offset, which is the difference between the K0 values of the first scheduling information and the second scheduling information, is 2, and therefore 7 symbols from symbol 0 correspond to SLIV 2_1 according to first scheduling information in slot n−3−offset=slot n−5.

According to last (second) scheduling information of a row having an index of 3, 14 symbols from symbol 0 of slot n−3 correspond to SLIV 3_2. In addition, an offset, which is a difference between K0 values of first scheduling information and second scheduling information, is 1, and therefore 7 symbols from symbol 7 correspond to SLIV 3_1 according to first scheduling information in slot n−3−offset=slot n−4.

FIG. 16B is a diagram illustrating an example for describing extension of K1 values according to consideration of single-PDSCH scheduling for PDSCHs based on a TDRA table including multiple pieces of scheduling information, according to an embodiment of the disclosure.

Referring to FIG. 16B, the terminal may consider SLIVs of PDSCHs that may be received according to Table 28, as SLIVs scheduled by single-PDSCH scheduling. Accordingly, the terminal may generate a TDRA table for single-PDSCH scheduling, as in Table 29. For reference, each row of the TDRA table for single PDSCH scheduling may include only one piece of scheduling information.

TABLE 29

| Index | K0 | SLIV (S, L) |
|---|---|---|
| 1 | 0 | SLIV 1_1 (0, 4) |
| 2 | 1 | SLIV 1_2 (0, 4) |
| 3 | 0 | SLIV 2_1 (0, 7) |
| 4 | 2 | SLIV 2_2 (7, 7) |
| 5 | 0 | SLIV 3_1 (7, 7) |
| 6 | 1 | SLIV 3_2 (0, 14) |

Based on the K1 value of 3 configured for the terminal, the terminal may determine slot n−3, slot n−4, and slot n−5, which are slots in which a PDSCH may be received, and accordingly, the K1 value may be extended to 3, 4, and 5. In other words, SLIV 1_2, SLIV 2_2, and SLIV 3_2 of indices 2, 4, and 6 may be received in slot n−3. Therefore, the K1 value should be 3 to transmit HARQ-ACK information in slot n. SLIV 1_1 and SLIV 3_1 of indices 1 and 5 may be received in slot n−4. Therefore, the K1 value should be 4 to transmit HARQ-ACK information in slot n. SLIV 2_1 of index 3 may be received in slot n−5. Therefore, the K1 value should be 4 to transmit HARQ-ACK information in slot n. The K1 values obtained here are referred to as extended K1 values (K1ₑₓₜ), and a set of the extended K1 values is referred to as an extended K1 set. However, use of these terms does not limit the technical scope of the disclosure.

The terminal may generate a Type-1 HARQ-ACK codebook, based on the TDRA table (e.g., Table 29) interpreted based on single-PDSCH scheduling and the extended K1 set.

When a PUCCH or PUSCH delivering a Type-1 HARQ-ACK codebook is transmitted in slot n, pseudo-codes for this are as follows.

[Pseudo-Code 3: (Multi-PDSCH Scheduling)]
Preparation operation: Set R is a set of single-scheduling information, which is obtained by dividing multiple pieces of scheduling information (slot information (hereinafter, K0 value) to which a PDSCH is mapped, and start symbol and length information (hereinafter, a starting and length value (SLIV)) configured in a time domain resource assignment (TDRA) table. If the terminal monitors one or more DCI formats, and the DCI formats use different TDRA tables, the set R is generated based on all TDRA tables. In addition, an extended K1 set according to the TDRA table is obtained.
Operation 0: M_{A,c} is initialized to an empty set. k is initialized to 0. j is initialized to 0.
Operation 1: A k-th largest K1 value is selected from the extended K1 set. (For example, if k=0, a largest K1 value is selected from the set K1, and if k=1, a second largest K1 value is selected from the set K1.) The K1 value is K_{1,k}.
Operation 2: If a symbol corresponding to start symbol and length information (SLIV) belonging to each row of set R and a symbol configured for uplink in a higher layer overlap in a slot (slot n−K_{1,k}) corresponding to a value of K_{1,k}, the row may be excluded from set R.
Operation 3-1 (if the terminal has only UE capability of receiving a maximum of one unicast PDSCH in one slot): If determined set R is not an empty set, j is added as a new PDSCH reception candidate occasion to set M_{A,c}. When one of PDSCH candidates of set R is received, the terminal may place HARQ-ACK of the PDSCH in the new PDSCH candidate occasion of j. j is increased by 1.
Operation 3-2 (if the terminal has UE capability of receiving more than one unicast PDSCH in one slot): For an SLIV that ends first in determined set R and SLIVs which overlap the SLIV in time, j is added as a new PDSCH reception candidate occasion to set M_{A,c}. When one of PDSCH candidates having the SLIV is received, the terminal may place HARQ-ACK of the PDSCH in the new PDSCH candidate occasion of j. j is increased by 1. The SLIVs are excluded from set R. Operation 3-2 is repeated until set R is empty.
Operation 4: k is increased by 1. If k is smaller than the cardinality of set K1, operations are started again from operation 2, and if k is equal to or greater than the cardinality of set K1, pseudo-code 3 ends.

[End of Pseudo-Code 3]

FIG. 16C is a diagram illustrating another example for describing a pseudo-code for generating an HARQ-ACK codebook according to an embodiment of the disclosure, and FIG. 16D is a diagram illustrating another example for describing a pseudo-code for generating an HARQ-ACK codebook according to an embodiment of the disclosure.

Aforementioned pseudo-code 3 is described with an example of FIG. 16C or 16D. PUCCH transmission including HARQ-ACK information may be performed in slot n. For example, the HARQ-ACK information may be generated in the form of the Type-1 HARQ-ACK codebook.

It is assumed that K1=3 is configured as a K1 value for the terminal. In addition, the TDRA table of the DCI format monitored by the terminal may include 3 rows as in Table 28. According to the preparation operation, the terminal may change the multiple pieces of scheduling information of respective rows of the TDRA table of Table 28 into single-scheduling information as in Table 29, and the single-scheduling information may be included in set R. In addition, {3,4,5} may be obtained as the extended K1 set. FIG. 16B shows SLIVs and extended K1 values according to respective rows.

The terminal may determine PDSCH reception candidate occasion M_{A,c}, based on the extended K1 set and set R. Referring to FIGS. 16C and 16D, pseudo-code 3 may be interpreted as follows. In the following description, it is assumed that the terminal has UE capability of receiving more than one unicast PDSCH in one slot.
Operation 0: M_{A,c} is initialized to an empty set. k is initialized to 0. j is initialized to 0.
Operation 1: A k-th (k=0) largest K1 value is selected from configured set K1. In the example, the K1 value is K_{1,0}=5.
Operation 2: If a symbol corresponding to start symbol and length information (SLIV) belonging to each row of set R and a symbol configured for uplink in a higher layer overlap in slot n−K_{1,0}=slot n−5, the row may be excluded from set R. Referring to FIGS. 16C and 16D, if some symbols of slot n−5 are semi-static UL symbols configured via a higher layer, rows including SLIVs overlapping the symbols may be excluded from set R. Referring to FIGS. 16C and 16D, slot n−5 includes no semi-static uplink symbol. In addition, in slot n−5, SLIV 1_1 of row 1, SLIV 1_2 of row 2, SLIV 2_2 of row 4, SLIV 3_1 of row 5, and SLIV 3_2 of row 6 do not correspond to HARQ-ACK information transmitted in slot n, so as to be excluded from set R. Therefore, set R may include SLIV 2_1 of row 3.
Operation 3-2 (if the terminal has UE capability of receiving more than one unicast PDSCH in one slot):

For an SLIV that ends first in determined set R and SLIVs which overlap the SLIV in time, j=0 is added as a new PDSCH reception candidate occasion to set M_{A,c}. Here, the SLIV that ends first is SLIV 2_1 (0,4) of row 3, and there is no SLIV overlapping the SLIV. Therefore, if j=0 is added to M_{A,c}, and the terminal receives a PDSCH scheduled with SLIV 2_1 (0,4) of row 3, HARQ-ACK of the PDSCH may be included in a position corresponding to the first (j=0) M_{A,c} in the type-1 HARQ-ACK codebook. j is increased by 1 so that j=1. The SLIV of row 5 is excluded from set R, and thus set R is an empty set. Therefore, operation 3-2 may end.
Operation 4: k is increased by 1 so that k=1. Since k=1 is smaller than the cardinality of set K1, which is 3, operation 1 is performed.
Operation 1: A (k=1)th largest K1 value is selected from configured set K1. In the example, the K1 value is K_{1,1}=4.
Operation 2: If a symbol corresponding to start symbol and length information (SLIV) belonging to each row of set R and a symbol configured for uplink in a higher layer overlap in slot n−K_{1,1}=slot n−4, the row may be excluded from set R. Referring to FIGS. 16C and 16D, if some symbols of slot n−4 are semi-static UL symbols configured via a higher layer, rows including SLIVs overlapping the symbols may be excluded from set R. Referring to FIGS. 16C and 16D, slot n−4 includes no semi-static uplink symbol. In addition, in slot n−4, SLIV 1_2 in row 2, SLIV 2_1 in row 3, SLIV 2_2 in row 4, and SLIV 3_2 in row 6 do not correspond to HARQ-ACK information transmitted in slot n, so as to be excluded from set R. Therefore, set R may include SLIV 1_1 of row 1 and SLIV 3_1 of row 5.
Operation 3-2 (if the terminal has UE capability of receiving more than one unicast PDSCH in one slot):

For an SLIV that ends first in determined set R and SLIVs which overlap the SLIV in time, j=1 is added as a new PDSCH reception candidate occasion to set M_{A,c}. Here, the SLIV that ends first is SLIV 1_1 (0,4) of row 1, and there is no SLIV overlapping the SLIV. Therefore, if j=1 is added to M_{A,c}, and the terminal receives a PDSCH scheduled with SLIV 1_1 (0,4) of row 1, HARQ-ACK of the PDSCH may be included in a position corresponding to the second (j=1) M_{A,c} in the type-1 HARQ-ACK codebook. j is increased by 1 so that j=2. The SLIV of rows 1 is excluded from set R so that R={5}. Set R is not an empty set, and operation 3-2 is thus repeated.

For the SLIV that ends first in determined set R and the SLIVs which overlap the SLIV in time, j=2 is added as a new PDSCH reception candidate occasion to set M_{A,c}. Here, the SLIV that ends first is SLIV 3_1 (7,7) of row 5, and there is no SLIV overlapping the SLIV. Therefore, if j=2 is added to M_{A,c}, and the terminal receives a PDSCH scheduled with SLIV 3_1 (7,7) of row 5, HARQ-ACK of the PDSCH may be included in a position corresponding to the third (j=2) M_{A,c} in the type-1 HARQ-ACK codebook. j is increased by 1 so that j=3. The SLIV of row 5 is excluded from set R, and thus set R is an empty set. Therefore, operation 3-2 may end.
Operation 4: k is increased by 1 so that k=2. Since k=1 is smaller than the cardinality of set K1, which is 3, operation 1 is performed.
Operation 1: A (k=2)th largest K1 value is selected from the extended K1 set. In the example, the K1 value is K_{1,2}=3.
Operation 2: If a symbol corresponding to start symbol and length information (SLIV) belonging to each row of set R and a symbol configured for uplink in a higher layer overlap in slot n−K_{1,2}=slot n−3, the row may be excluded from set R. Referring to FIGS. 16C and 16D, if some symbols of slot n−3 are semi-static UL symbols configured via a higher layer, rows including SLIVs overlapping the symbols may be excluded from set R. Referring to FIGS. 16C and 16D, last two symbols of slot n−3 may be semi-static uplink symbols, and SLIV (7,7) in row 4 and SLIV (0,14) in row 6 overlap with the semi-static uplink symbol so as to be excluded from set R. In addition, in slot n−3, SLIV 1_1 in row 1, SLIV 2_1 in row 3, and SLIV 3_1 in row 5 do not correspond to HARQ-ACK information transmitted in slot n, so as to be excluded from set R. Therefore, set R may include SLIV 1_2 of row 2.
Operation 3-2 (if the terminal has UE capability of receiving more than one unicast PDSCH in one slot):

For an SLIV that ends first in determined set R and SLIVs which overlap the SLIV in time, j=3 is added as a new PDSCH reception candidate occasion to set M_{A,c}. Here, the SLIV that ends first is SLIV 1_2 (0,4) of row 2, and there is no SLIV overlapping the SLIV. Therefore, if j=3 is added to M_{A,c}, and the terminal receives a PDSCH scheduled with SLIV 1_2 (0,4) of row 2, HARQ-ACK of the PDSCH may be included in a position corresponding to the fourth (j=3) M_{A,c} in the type-1 HARQ-ACK codebook. j is increased by 1 so that j=4. The SLIV of row 2 is excluded from set R, and thus set R is an empty set. Therefore, operation 3-2 may end.
Operation 4: k is increased by 1 so that k=3. Since k=3 is equal to the cardinality of set K1, which is 3, pseudo-code 3 ends.

[End of Pseudo-Code 3]

Therefore, referring to FIGS. 16C and 16D, the terminal may determine M_{A,c} of 4 PDSCH reception candidate occasions j=0, j=1, j=2, and j=3. The size of the Type-1 HARQ-ACK codebook may be determined according to the number of PDSCH reception candidate occasions. The actual number of bits per PDSCH reception candidate occasion may be determined according to a configuration, such as the number of transport blocks included in each PDSCH, the number of code block groups (CBGs) included in each PDSCH, or spatial bundling.

<Type-1 HARQ-ACK Codebook for Multi-PDSCH Reception and Time-Domain Bundling>

In the described example of FIG. 16D, the terminal includes 4 PDSCH reception candidate occasions for the Type-1 HARQ-ACK codebook. This is an example, and if the terminal has more rows in the TDRA table or includes more scheduling information in the rows of the TDRA table, a Type-1 HARQ-ACK codebook may include a larger number of PDSCH reception candidate occasions. Accordingly, a problem that a size of a Type-1 HARQ-ACK codebook increases may occur. To solve this problem, time-domain bundling may be configured.

If time-domain bundling is configured for the terminal, PDSCHs scheduled for multi-PDSCH in one DCI format deliver different TBs, but the terminal may bundle HARQ-ACKs of the TBs into one HARQ-ACK bit so as to transmit the same. Here, bundling may be determined by a binary AND operation of the HARQ-ACKs of the TBs of the PDSCHs received by the terminal.

Here, PDSCHs which are not received by the terminal, for example, PDSCHs which cannot be received due to overlapping with semi-static uplink symbols may be excluded.

When multi-PDSCH scheduling and time-domain bundling are configured, the terminal may obtain a Type-1 HARQ-ACK codebook similarly to repeated PDSCH reception. The difference from repeated PDSCH reception is as follows.

In repeated PDSCH reception, if a last PDSCH is received in slot n−K_{1,k}, the terminal may repeatedly receive PDSCHs in previous N_{PDSCH}^{max} slots. That is, PDSCHs may be repeatedly received in slot n−K_{1,k}, n−K_{1,k}−1, . . . , and slot n−K_{1,k}−(N_{PDSCG}^{MAX}−1).

In multi-PDSCH reception, if a last PDSCH is received in slot n−K_{1,k}, previous slots may be determined according to K0 values of scheduling information. For example, if one row of the TDRA table has two pieces of scheduling information and the K0 values are K0_1 and K0_2 (≥K0_1), a PDSCH according to first scheduling information and a PDSCH according to second scheduling information may be received in slot n−K_{1,k}−Delta_K₁ and slot n−K_{1,k}−Delta_K2, respectively. Here, Delta_Kᵢ represents a difference between a K0 value of i-th scheduling information and a K0 value of last scheduling information (a largest K0 value due to being the last scheduling information). That is, Delta_K₁=K0_2−K0_1 and Delta_K₂=K0_2−K0_2. In general, Delta_Kᵢ is represented as follows. Delta_K₁=K0_max−K0_i. Here, K0_i is an i-th K0 value of multiple pieces of scheduling information, and K0_max is a K0 value (largest K0 value) of the last scheduling information.

In repeated PDSCH reception, an SLIV of each slot is the same. That is, an SLIV of one piece of scheduling information is applied to multiple slots.

In multi-PDSCH reception, an SLIV of each slot may be indicated according to multiple pieces of scheduling information. Accordingly, the SLIV of each slot may be different according to multiple pieces of scheduling information.

In repeated PDSCH reception, a PDSCH of each slot repeatedly receives the same TB. Accordingly, in repeated PDSCH reception, one HARQ-ACK for the TB may be generated without separate HARQ-ACK bundling.

In multi-PDSCH reception, a different TB may be received for a PDSCH of each slot. Therefore, in multi-PDSCH reception, separate TB HARQ-ACK may be generated for each PDSCH. If time-domain bundling is configured, one HARQ-ACK may be generated by bundling HARQ-ACKs of the TBs.

In consideration of the difference between repeated PDSCH reception and multi-PDSCH reception, pseudo-code 2 may be modified to pseudo-code 4 as follows.

[Pseudo-Code 4: (Multi-PDSCH Scheduling, Time-Domain Bundling Configuration)]
Preparation operation: Set R is a set of multiple pieces of scheduling information (slot information (hereinafter, K0 value) to which a PDSCH is mapped, and start symbol and length information (hereinafter, a starting and length value (SLIV)) configured in a time domain resource assignment (TDRA) table. If the terminal monitors one or more DCI formats, and the DCI formats use different TDRA tables, the set R is generated based on all TDRA tables.
Operation 0: M_{A,c} is initialized to an empty set. k is initialized to 0. j is initialized to 0.
Operation 1: A k-th largest K1 value is selected from configured set K1. (For example, if k=0, a largest K1 value is selected from the set K1, and if k=1, a second largest K1 value is selected from the set K1.) The K1 value is K_{1,k}.
Operation 2: If a symbol corresponding to start symbol and length information (SLIV) belonging to each row of set R and a symbol configured for uplink in a higher layer overlap in each of slots determined by K0 values of respective rows of set R and a slot (slot n−K_{1,k}) corresponding to a K_{1,k} value of the row of set R, the row may be excluded from set R. The slots determined by the K0 values of respective row include slot n−K_{1,k}−Delta_Kᵢ (i=0, 1, . . . , the number of pieces of scheduling information in row−1), and Delta_Kᵢ=K0_max−K0_i. Here, K0_i is an i-th K0 value of multiple pieces of scheduling information, and K0_max is a K0 value (largest K0 value) of the last scheduling information.
Operation 3-1 (if the terminal has only UE capability of receiving a maximum of one unicast PDSCH in one slot): If determined set R is not an empty set, j is added as a new PDSCH reception candidate occasion to set M_{A,c}. When one of PDSCH candidates of set R is received, the terminal may place HARQ-ACK of the PDSCH in the new PDSCH candidate occasion of j. j is increased by 1.
Operation 3-2 (if the terminal has UE capability of receiving more than one unicast PDSCH in one slot): Set R′ is generated by gathering only last scheduling information of determined set R. For an SLIV that ends first in determined set R′ and SLIVs which overlap the SLIV in time, j is added as a new PDSCH reception candidate occasion to set M_{A,c}. When one of PDSCH candidates having the SLIV is received, the terminal may place HARQ-ACK of the PDSCH in the new PDSCH candidate occasion of j. j is increased by 1. The SLIVs are excluded from set R′. Operation 3-2 is repeated until set R′ becomes an empty set.
Operation 4: k is increased by 1. If k is smaller than the cardinality of set K1, operations are started again from operation 2, and if k is equal to or greater than the cardinality of set K1, pseudo-code 4 ends.

[End of Pseudo-Code 4]

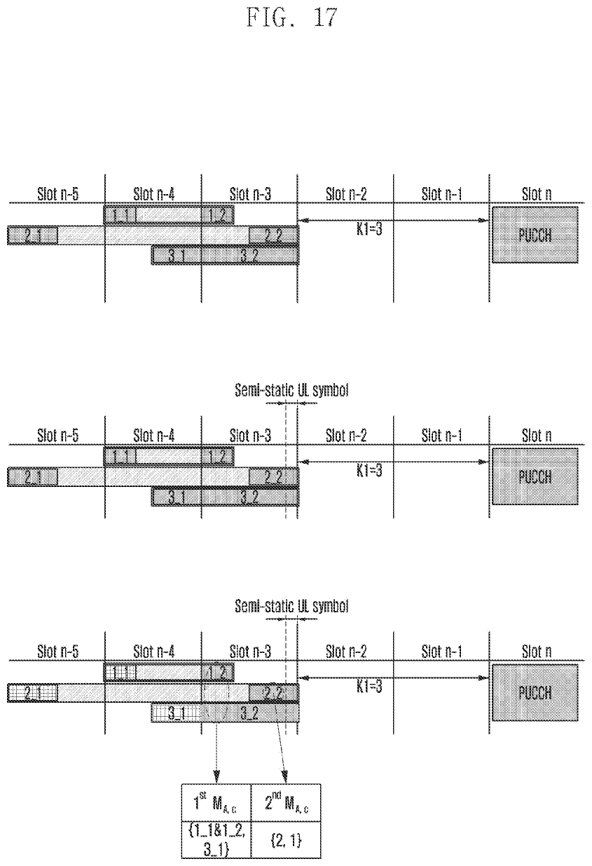

FIG. 17 is a diagram illustrating an example for describing a pseudo-code for generating an HARQ-ACK codebook by configuring/applying time-domain bundling for PDSCHs repeatedly received in multiple slots, according to various embodiments of the disclosure.

Aforementioned pseudo-code 4 will be described with reference to FIG. 17 as an example. PUCCH transmission including HARQ-ACK information may be performed in slot n. For example, the HARQ-ACK information may be generated in the form of the Type-1 HARQ-ACK codebook.

As in described Table 28, the terminal may be configured with a TDRA table having rows including multiple pieces of scheduling information.

The terminal may determine PDSCH reception candidate occasion M_{A,c}, based on the K1 value and set R. Referring to FIG. 17, pseudo code 4 may be interpreted as follows. In the following description, it is assumed that the terminal has UE capability of receiving more than one unicast PDSCH in one slot.
Operation 0: M_{A,c} is initialized to an empty set. k is initialized to 0. j is initialized to 0.

Operation 1: A k-th (k=0) largest K1 value is selected from configured set K1. The K1 value is K_{1,0}=3.

Operation 2: If a symbol corresponding to start symbol and length information (SLIV) belonging to each row of set R and a symbol configured for uplink in a higher layer overlap in each of slots determined by K0 values of respective rows of set R and a slot (e.g., slot n−3) corresponding to a K_{1,k} value of the row of set R, the row may be excluded from set R. The slots determined by the K0 values of respective row include slot n−K_{1,k}−Delta_Kᵢ (i=0, 1, . . . , the number of pieces of scheduling information in row−1), and Delta_Kᵢ=K0_max−K0_i. Here, K0_i is an i-th K0 value of multiple pieces of scheduling information, and K0_max is a K0 value (largest K0 value) of the last scheduling information.

For a first row, since K0_0=0 and K0_1=1, Delta_K₀=1 and Delta_K₁=0. Therefore, in each of slot (n−3)−(Delta_K₀)=slot n−4 and slot (n−3)−(Delta=slot n−3, both SLIVs according to two pieces of scheduling information in the first row do not overlap a semi-static uplink symbol, the first row may not be excluded from set R.

For a second row, since K0_0=0 and K0_1=1, Delta_K₀=2 and Delta_K₁=0. Therefore, in each of slot (n−3)−(Delta_K₀)=slot n−5 and slot (n−3)−(Delta_K₁)=slot n−3, a second SLIV of two SLIVs according to two pieces of scheduling information in the second row overlaps a semi-static uplink symbol but a first SLIV of the two SLIVs does not overlap the semi-static uplink symbol, the second row may not be excluded from set R.

For a third row, since K0_0=0 and K0_1=1, Delta_K₀=1 and Delta_K₁=0. Therefore, in each of slot (n−3)−(Delta_K₀)=slot n−4 and slot (n−3)−(Delta=slot n−3, a second SLIV of two SLIVs according to two pieces of scheduling information in the third row overlaps a semi-static uplink symbol but a first SLIV of the two SLIVs does not overlap the semi-static uplink symbol, the third row may not be excluded from set R.

Therefore, set R may include rows 1, 2, and 3.
Operation 3-2 (if the terminal has UE capability of receiving more than one unicast PDSCH in one slot):

Set R′ is generated by gathering only last scheduling information of determined set R. In set R′, row 1 includes SLIV 1_2, row 2 includes SLIV 2_, and row 3 includes SLIV 3_2. For an SLIV that ends first in determined set R′ and SLIVs which overlap the SLIV in time, j=0 is added as a new PDSCH reception candidate occasion to set M_{A,c}. Here, the SLIV that ends first is SLIV 1_2 (0,4) of row 1, and an SLIV overlapping the SLIV is SLIV 3_2 (0,14) of row 3. Therefore, if j=0 is added to M_{A,c} and the terminal receives a PDSCH scheduled with SLIV 1_2 (0,4) of row 1 or SLIV 3_2 (0,14) of row 3, HARQ-ACK of the PDSCH may be included in a position corresponding to first (j=0) M_{A,c} in the Type-1 HARQ-ACK codebook.

Here, HARQ-ACKs of PDSCHs scheduled together are bundled. For example, if the terminal receives a PDSCH scheduled with SLIV 1_2 (0,4) of row 1, HARQ-ACK of the PDSCH and HARQ-ACK of a PDSCH scheduled with SLIV 1_1 (0,4), which is scheduled together with the PDSCH, are bundled. For example, if the terminal receives a PDSCH scheduled with SLIV 3_2 (0,14) of row 3, HARQ-ACK of the PDSCH and HARQ-ACK of a PDSCH scheduled with SLIV 3_1 (7,7), which is scheduled together with the PDSCH, are bundled. If some PDSCHs overlap the semi-static uplink, HARQ-ACKs of the PDSCHs are excluded from bundling. For example, since SLIV 3_2 (0,14) overlaps the semi-static uplink symbol, HARQ-ACK of the PDSCH corresponding to SLIV 3_2 is excluded from bundling.

j is increased by 1 so that j=1. The SLIVs of rows 1 and 3 are excluded from set R′ so that R′={2}. Set R is not an empty set, and operation 3-2 is thus repeated.

For an SLIV that ends first in determined set R′ and SLIVs which overlap the SLIV in time, j=1 is added as a new PDSCH reception candidate occasion to set M_{A,c}. Here, the SLIV that ends first is SLIV 2_2 (7,7) of row 2, and there is no SLIV overlapping the SLIV. Therefore, if j=1 is added to M_{A,c}, and the terminal receives a PDSCH scheduled with SLIV 2_2 (7,7) of row 2, HARQ-ACK of the PDSCH may be included in a position corresponding to the second (j=1) M_{A,c} in the type-1 HARQ-ACK codebook.

Here, HARQ-ACKs of PDSCHs scheduled together are bundled. For example, if the terminal receives a PDSCH scheduled with SLIV 2_2 (7,7) of row 2, HARQ-ACK of the PDSCH and HARQ-ACK of a PDSCH scheduled with SLIV 2_1 (0,7), which is scheduled together with the PDSCH, are bundled. If some PDSCHs overlap the semi-static uplink, HARQ-ACKs of the PDSCHs are excluded from bundling. For example, since SLIV 2_2 (7,7) overlaps the semi-static uplink symbol, HARQ-ACK of the PDSCH corresponding to SLIV 2_2 is excluded from bundling.

j is increased by 1 so that j=2. The SLIVs of row 2 are excluded from set R′ so that set R′ is an empty set. Since set R′ is an empty set, operation 3-2 ends.
Operation 4: k is increased by 1 so that k=1. Since k=1 is equal to the cardinality of set K1, which is 1, pseudo-code 4 ends.

Therefore, referring to FIG. 17, the terminal may determine M_{A,c} in which two PDSCH reception candidate occasions are j=0 and j=1. The size of the Type-1 HARQ-ACK codebook may be determined according to the number of PDSCH reception candidate occasions. The actual number of bits per PDSCH reception candidate occasion may be determined according to a configuration, such as the number of transport blocks included in each PDSCH, the number of code block groups (CBGs) included in each PDSCH, or spatial bundling.

The aforementioned pseudo-code for the Type-1 HARQ-ACK codebook for single PDSCH reception and multi-PDSCH reception is described in 9.1.2.1 of 3GPP standard document TS38.213. In the disclosure, for description, the pseudo-code of v17.0.0 of the standard document will be described. The pseudo-code is as shown in Table 30.

```
TABLE 30
  while r < C(R)
  if the UE is not provided enableTimeDomainHARQ-Bundling and is
  provided tdd-UL-DL-ConfigurationCommon, or tdd-UL-DL-
  ConfigurationDedicated and, for each slot from slot └(n_{U} − K_{1,k}) ·
  2^{μ}^{_{DL}}^{-μ}^{_{UL}}┘ + n_{D} − N_{PDSCH}^{repeat,max} + 1 to slot └(n_{U} − K_{1,k}) · 2^{μ}^{_{DL}}^{-μ}^{_{UL}}┘ +
  n_{D}, at least one symbol of the PDSCH time resource derived by row r
  is configured as UL where K_{1,k} is the k-th slot timing value in set K₁,
  or if HARQ-ACK information for PDSCH time resource derived by
  row r in slot └(n_{U} − K_{1,k}) · 2^{μ}^{_{DL}}^{-μ}^{_{UL}}┘ + n_{D} cannot be provided in slot n_{U}
    R = R\r;
  elseif the UE is provided enableTimeDomainHARQ-Bundling and tdd-
  UL-DL-ConfigurationCommon, or tdd-UL-DL-
  ConfigurationDedicated and, for each slot └(n_{U} − K_{1,k}) · 2^{μ}^{_{DL}}^{-μ}^{_{UL}}┘ +
  n_{D} − ΔK_{0,r}(d), at least one symbol of the PDSCH time resource
  derived by row r of set R′ is configured as UL, where
  $d = 0 , 1 , … , C ( Δ {K}_{0 , r} ) - 1 , Δ {K}_{0 , r} = {max}_{{K}_{0}} ( {K}_{0 , r} ) - {K}_{0 , r} , and C ( Δ {K}_{0 , r} )$
  is the cardinality of ΔK_{0,r}.
    R = R\r;
    R′ = R′\r;
  else
    r = r + 1;
  end if
end while
```

<Type-1 HARQ-ACK CB for Multi-PDSCH Reception, Time-Domain Bundling, and Repeated PDSCH Reception>

In the above, repeated PDSCH reception is not considered in the method of generating a Type-1 HARQ-ACK codebook for multi-PDSCH reception and the method of generating a Type-1 HARQ-ACK codebook for multi-PDSCH reception and time-domain bundling.

The disclosure relates to a method of generating a Type-1 HARQ-ACK codebook when multi-PDSCH reception and repeated PDSCH reception are configured for a terminal Unless otherwise mentioned, in the following descriptions, it may be assumed that time-domain bundling is configured.

As described above, if the terminal is configured with “PDSCH-Config includes pdsch-TimeDomainAllocationListForMultiPDSCH-r17” that is TDRA table configuration information for multi-PDSCH scheduling, “PDSCH-Config includes pdsch-TimeDomainAllocationListForMultiPDSCH-r17” is applicable to DCI format 1_1. However, if “PDSCH-Config includes pdsch-TimeDomainAllocationListForMultiPDSCH-r17” cannot be applied to DCI format 1_0 or DCI format 1_2. Therefore, DCI format 1_0 and DCI format 1_2 cannot be used for multi-PDSCH scheduling.

In addition, as described above, if the terminal is configured with “pdsch-AggregationFactor in pdsch-config” or “pdsch-AggregationFactor in sps-Config”, a PDSCH scheduled in DCI format 1_1 or DCI format 1_2 may be repeatedly received in multiple slots according to the configuration. However, if multi-PDSCH scheduling (PDSCH-Config includes pdsch-TimeDomainAllocationListForMultiPDSCH-r17) is configured in DCI format 1_1, “pdsch-AggregationFactor in pdsch-config” and “pdsch-AggregationFactor in sps-Config” are applied only in DCI format 1_2. That is, the PDSCH scheduled in DCI format 1_1 is not repeatedly received by ignoring the configuration, and the PDSCH scheduled in DCI format 1_2 may be repeatedly received according to the above configuration.

Therefore, a Type-1 HARQ-ACK codebook needs to include HARQ-ACK information for PDSCH reception in one slot scheduled in DCI format 1_0, PDSCH reception for delivering different TBs in multiple slots scheduled in DCI format 1_0, and PDSCH reception for delivering the same TB in multiple slots scheduled in DCI format 1_2. A method for this is disclosed.

Unless otherwise additionally mentioned, in the following descriptions, set R may refer to a union of rows of TDRA tables of all DCI formats.

[Method 1: Differentially Applying the Number of Repetitions, Based on a DCI Format TDRA Table to which an SLIV of a Row of Set R Belongs]

As one method of the disclosure, a terminal may determine a DCI format TDRA table to which an SLIV of each row of set R belongs. Based on the determination, the terminal may determine the number of repetitions (e.g., N_{PDSCH}^{max}) to be applied to the SLIV of each row. The terminal may determine whether the row is to be excluded from set R, based on the number of repetitions. For example, when determining whether the row is to be excluded, the terminal may determine the same based on a semi-static uplink symbol.

As a specific example, descriptions are provided based on Table 31 which is a TDRA table including only single-scheduling information, and Table 32 which is a TDRA table including multiple pieces of scheduling information. Tables 31 and 32 are only examples for convenience of explanation, and do not limit the technical scope of the disclosure. Accordingly, row configurations and values of each TDRA table may be different. A third DCI format of the terminal may include two rows of the TDRA table as in Table 31. In addition, a fourth DCI format of the terminal may include three rows of the TDRA table as in Table 32. For reference, the third DCI format is a DCI format that does not support multi-PDSCH scheduling, and the fourth DCI format is a DCI format that supports multi-PDSCH scheduling.

Repeated PDSCH reception may be applied to the third DCI format. That is, the terminal may repeatedly receive a PDSCH scheduled in the third DCI format in N_{PDSCH}^{max} slots. However, repeated PDSCH reception cannot be applied to the fourth DCI format. That is, the terminal does not repeatedly receive the PDSCH scheduled in the fourth DCI format. This also applies to a row (e.g., index 3 of Table 32) having single-scheduling information in the fourth DCI format.

The terminal may generate Table 33 by using the union of the TDRA tables. For reference, row 2 of Table 31 and row 3 of Table 32 include the same SLIV and the same K0 value so as to be represented by the same index. Here, the indices are newly assigned.

TABLE 31

| Index | K0 | SLIV (S, L) |
|---|---|---|
| 1 | 0 | SLIV 1 (0, 7) |
| 2 | 0 | SLIV 2 (7, 7) |

TABLE 32

| | First scheduling | | Second scheduling | |
|---|---|---|---|---|
| | information | | information | |
| Index | K0 | SLIV (S, L) | K0 | SLIV (S, L) |
| 1 | 0 | SLIV 1_1 (0, 4) | 1 | SLIV 1_2 (0, 4) |
| 2 | 0 | SLIV 2_1 (0, 7) | 2 | SLIV 2_2 (7, 7) |
| 3 | 0 | SLIV 3_1 (7, 7) | | |

TABLE 33

| | First scheduling | | Second scheduling | |
|---|---|---|---|---|
| | information | | information | |
| Index | K0 | SLIV (S, L) | K0 | SLIV (S, L) |
| 1 | 0 | SLIV 1_1 (0, 4) | 1 | SLIV 1_2 (0, 4) |
| 2 | 0 | SLIV 2_1 (0, 7) | 2 | SLIV 2_2 (7, 7) |
| 3 | 0 | SLIV 3_1 (7, 7) | | |
| 4 | 0 | SLIV 4_1 (0, 7) | — | — |

The terminal may generate set R including indices of the union of the TDRA tables. That is, set R may include {1, 2, 3, 4}.

The terminal may determine a DCI format to which scheduling information of each index belongs. For example, for index 1, it may be determined that scheduling information belongs to the TDRA table of the fourth DCI format. For index 2, it may be determined that scheduling information belongs to the TDRA table of the fourth DCI format. For index 3, it may be determined that scheduling information belongs to the TDRA table of the third DCI format and the TDRA table of the fourth DCI format. For index 4, it may be determined that scheduling information belongs to the TDRA table of the third DCI format.

If the terminal determines that a row of set R belongs only to the fourth DCI format, N_{PDSCH}^{max}=1 may be determined. N_{PDSCH}^{max}=1 may indicate that a PDSCH is not repeatedly received.

If the terminal determines that a row of set R belongs only to the third DCI format, N_{PDSCH}^{max} may be determined based on pdsch-AggregationFactor. A method of determining N_{PDSCH}^{max} by the terminal is as follows. For example, if the terminal is configured with “pdsch-AggregationFactor in PDSCH-Config”, the terminal may use a value of “pdsch-AggregationFactor in PDSCH-Config” as N_{PDSCH}^{max}. If the terminal is configured with “pdsch-AggregationFactor-r16 in SPS-Config”, the terminal may use a value of “pdsch-AggregationFactor in PDSCH-Config” as N_{PDSCH}^{max}. If the terminal is configured with both “pdsch-AggregationFactor in PDSCH-Config” and “pdsch-AggregationFactor-r16 in SPS-Config”, the terminal may use a larger value among the values of “pdsch-AggregationFactor in PDSCH-Config” and “pdsch-AggregationFactor-r16 in SPS-Config” as N_{PDSCH}^{max}.

For reference, a row of set R may belong to both the third DCI format and the fourth DCI format. For example, row 3 of Table 33 may belong to both the third DCI format and the fourth DCI format. In this case, the terminal may use a larger value among the obtained N_{PDSCH}^{max} values, as N_{PDSCH}^{max}. In other words, the N_{PDSCH}^{max} value of the third DCI format may be used.

In the description of the disclosure, the terminal assumes two DCI formats, but the DCI formats may be extended to two or more. Even in this case, the terminal may identify a DCI format to which a row of set R belongs, and may obtain an N_{PDSCH}^{max} value of each DCI format.

For example, the third DCI format may include DCI format 1_1, and the fourth DCI format may include DCI format 1_0 or DCI format 1_2.

As another example, the third DCI format may include DCI format 1_0 or DCI format 1_1, and the fourth DCI format may include DCI format 1_2.

[Pseudo-Code 5: (Multi-PDSCH Scheduling, Time-Domain Bundling Configuration, and Repeated PDSCH Reception Configuration—Method 1)]
Preparation operation: Set R is a set of multiple pieces of scheduling information (slot information (hereinafter, K0 value) to which a PDSCH is mapped, and start symbol and length information (hereinafter, a starting and length value (SLIV)) configured in a time domain resource assignment (TDRA) table. If the terminal monitors one or more DCI formats, and the DCI formats use different TDRA tables, the set R is generated based on all TDRA tables.
Operation 0: M_{A,c}, is initialized to an empty set. k is initialized to 0. j is initialized to 0.
Operation 1: A k-th largest K1 value is selected from configured set K1. (For example, if k=0, a largest K1 value is selected from the set K1, and if k=1, a second largest K1 value is selected from the set K1.) The K1 value is K_{1,k}.
Operation 2: A row may be excluded from set R according to the following two conditions.

Condition 1) If a row of set R belongs to the third DCI format, and if a symbol corresponding to start symbol and length information (SLIV) belonging to each row of set R and a symbol configured for uplink in a higher layer overlap in each of previous N_{PDSCH}^{max} slots (slot n−K_{1,k}−(N_{PDSCH}^{max}−1), slot n−K_{1,k}−(N_{PDSCH}^{max}−1)+1, . . . , slot n−K_{1,k}) from a slot (slot n−K_{1,k}) corresponding to a K_{1,k} value of the row of set R, the row may be excluded from set R. Here, N_{PDSCH}^{max} is a value determined based on pdsch-AggregationFactor.

Conditions 2) If aforementioned condition 1 is not satisfied (i.e., if a row belongs to the fourth DCI format), and if a symbol corresponding to start symbol and length information (SLIV) belonging to each row of set R and a symbol configured for uplink in a higher layer overlap in each of slots determined by K0 values of respective rows of set R and a slot (slot n−K_{1,k}) corresponding to a K_{1,k} value of the row of set R, the row may be excluded from set R. The slots determined by the K0 values of respective row include slot n−K_{1,k}−Delta_Kᵢ (i=0, 1, . . . , the number of pieces of scheduling information in row−1), and Delta_Kᵢ=K0_max−K0_i. Here, K0_i is an i-th K0 value of multiple pieces of scheduling information, and K0_max is a K0 value (largest K0 value) of the last scheduling information.
Operation 3-1 (if the terminal has only UE capability of receiving a maximum of one unicast PDSCH in one slot): If determined set R is not an empty set, j is added as a new PDSCH reception candidate occasion to set M_{A,c}. When one of PDSCH candidates of set R is received, the terminal may place HARQ-ACK of the PDSCH in the new PDSCH candidate occasion of j. j is increased by 1.
Operation 3-2 (if the terminal has UE capability of receiving more than one unicast PDSCH in one slot): Set R′ is generated by collecting only last scheduling information of determined set R. For an SLIV that ends first in determined set R′ and SLIVs which overlap the SLIV in time, j is added as a new PDSCH reception candidate occasion to set M_{A,c}. When one of PDSCH candidates having the SLIV is received, the terminal may place HARQ-ACK of the PDSCH in the new PDSCH candidate occasion of j. j is increased by 1. The SLIVs are excluded from set R′. Operation 3-2 is repeated until set R′ becomes an empty set.
Operation 4: k is increased by 1. If k is smaller than the cardinality of set K1, operations are started again from operation 2, and if k is equal to or greater than the cardinality of set K1, pseudo-code 5 ends.

[End of Pseudo-Code 5]

The pseudo-code according to method 1 of the disclosure may be as shown in Table 34 or Table 35.

```
TABLE 34
<Pseudo code #1>
  while r < C(R)
    Set X = N_{PDSCH}^{repeat,max} if PDSCH-
    TimeDomainResourceAllocationListForMultiPDSCH is not provided
    or if PDSCH-TimeDomainResourceAllocationListForMultiPDSCH is
    provided and the PDSCH time resource derived by row r is associated
    with DCI format 1_2, if monitored, or X=1 otherwise.
    if the UE is not provided enableTimeDomainHARQ-Bundling and is
    provided tdd-UL-DL-ConfigurationCommon, or tdd-UL-DL-
    ConfigurationDedicated and, for each slot from slot └(n_{U} − K_{1,k}).
    2^{μ}^{_{DL}}^{-u}^{_{UL}}┘ + n_{D} − X + 1 to slot └(n_{U} − K_{1,k}) · 2^{μ}^{_{DL}}^{-μ}^{_{UL}}┘ + n_{D}, at
    least one symbol of the PDSCH time resource derived by row r is
    configured as UL where K_{1,k} is the k-th slot timing value in set K₁, or
    if HARQ-ACK information for PDSCH time resource derived by row
    r in slot └(n_{U} − K_{1,k}) · 2^{μ}^{_{DL}}^{-μ}^{_{UL}}┘ + n_{D} cannot be provided in slot n_{U},
      R = R\r;
    elseif the UE is provided enableTimeDomainHARQ-Bundling and
    tdd-UL-DL-ConfigurationCommon, or tdd-UL-DL-
    ConfigurationDedicated and,
      if the PDSCH time resource derived by row r is associated with
      DCI format 1_2, if monitored, and if for each slot from slot
      └(n_{U} − K_{1,k}) · 2^{μ}^{_{DL}}^{-μ}^{_{UL}}┘ + n_{D} − X + 1 to slot └n_{U} − K_{1,k}).
      2^{μ}^{_{DL}}^{-μ}^{_{UL}}┘ + n_{D}, at least one symbol of the PDSCH time resource
      derived by row r is configured as UL where K_{1,k} is the k-the slot
      timing value in set K₁,
        R = R\r;
        R′ = R′\r;
      else for each slot └(n_{U} − K_{1,k}) · 2^{μ}^{_{DL}}^{-μ}^{_{UL}}┘ + n_{D} − ΔK_{0,r}(d), at
      least one symbol of the PDSCH time resource derived by row r of
      set R′ is configured as UL, where
      $d = 0 , 1 , . . . , C ( Δ {K}_{0 , r} ) - 1 , Δ {K}_{0 , r} = {max}_{{K}_{0}} ( {K}_{0 , r} ) - {K}_{0 , r} ,$
      and C(ΔK_{0,r}) is the cardinality of ΔK_{0,r}.
        R = R\r;
        R′ = R′\r;
      endif
    else
      r = r + 1;
    end if
end while
```

```
TABLE 35
<Pseudo code #2>
    while r < C(R)
      if the UE is not provided PDSCH-
      TimeDomainResourceAllocationListForMultiPDSCH and is provided
      tdd-UL-DL-ConfigurationCommon, or tdd-UL-DL-
      ConfigurationDedicated and, for each slot from slot [(n_{U} − K_{1,k}) ·
      2^{μ}^{_{DL}} ^{-μ}^{_{UL}}┘ + n_{D} − N_{PDSCH}^{repeat,max} + 1 to slot └(n_{U} − K_{1,k}) · 2^{μ}^{_{DL}} ^{-μ}^{_{UL}}┘ +
      n_{D}, at least one symbol of the PDSCH time resource derived by row r
      is configured as UL
        R = R\r;
      elseif the UE is provided PDSCH-
      TimeDomainResourceAllocationListForMultiPDSCH and if the UE is
      not provided enableTimeDomainHARQ-Bundling
        if the UE is provided tdd-UL-DL-ConfigurationCommon, or tdd-
        UL-DL-ConfigurationDedicated and for each slot from slot
        └(n_{U} − K_{1,k}) · 2^{μ}^{_{DL}} ^{-μ}^{_{UL}}┘ + n_{D} − X + 1 to slot └(n_{U} − K_{1,k}) ·
        2^{μ}^{_{DL}} ^{-μ}^{_{UL}}┘ + n_{D}, at least one symbol of the PDSCH time resource
        derived by row r is configured as UL or if HARQ-ACK
        information for PDSCH time resource derived by row r in slot
        └(n_{U} − K_{1,k}) · 2^{μ}^{_{DL}} ^{-μ}^{_{UL}}┘ + n_{D} cannot be provided in slot n_{U},
        where X = N_{PDSCH}^{repeat, max} if the PDSCH time resource derived by row
        r is associated with DCI format 1_2, if monitored, or X=1
        otherwise.
          R = R\r;
      elseif the UE is provided PDSCH-
      TimeDomainResourceAllocationListForMultiPDSCH and
      enableTimeDomainHARQ-Bundling
        if the UE is provided tdd-UL-DL-ConfigurationCommon, or tdd-
        UL-DL-ConfigurationDedicated and for each slot └(n_{U} − K_{1,k}) ·
        2^{μ}^{_{DL}} ^{-μ}^{_{UL}}┘ + n_{D} − ΔK_{0,r}(d), at least one symbol of the PDSCH
        time resource derived by row r of set R′ is configured as UL, where
        d = 0,1, ...,C(ΔK_{0,r}) − 1
          R = R\r;
          R′ = R′\r;
        endif
      else
        r = r + 1;
      end if
  end while
```

[Method 2: Differentially Applying the Number of Repetitions According to the Number of SLIVs in Rows of Set R]

As one method of the disclosure, a terminal may determine the number of SLIVs of each row of set R. Based on the determination, the terminal may determine the number of repetitions (e.g., N_{PDSCH}^{max}) to be applied to the SLIV of each row. The terminal may determine whether the row is to be excluded from set R, based on the number of repetitions. For example, when determining whether the row is to be excluded, the terminal may determine the same based on a semi-static uplink symbol.

As a specific example, descriptions are provided based on Table 31 which is a TDRA table including only single-scheduling information, and Table 32 which is a TDRA table including multiple pieces of scheduling information. The third DCI format of the terminal may include two rows of the TDRA table as in Table 31. In addition, the fourth DCI format of the terminal may include three rows of the TDRA table as in Table 32.

Repeated PDSCH reception may be applied to the third DCI format. That is, the terminal may repeatedly receive a PDSCH scheduled in the third DCI format in N_{PDSCH}^{max} slots. However, repeated PDSCH reception cannot be applied to the fourth DCI format. That is, the terminal does not repeatedly receive the PDSCH scheduled in the fourth DCI format. This is also applied to a row having single-scheduling information in the fourth DCI format.

The terminal may generate Table 33 by using the union of the TDRA tables. The terminal may generate set R including indices of the union of the TDRA tables. That is, set R may include {1, 2, 3, 4}.

The terminal may determine the number of piece of scheduling information (e.g., SLIV) of each index. For example, for index 1, it may be determined that two pieces of scheduling information are included. For index 2, it may be determined that two pieces of scheduling information are included. For index 3, it may be determined that one piece of scheduling information is included. For index 4, it may be determined that one piece of scheduling information is included.

The terminal may determine the number of repetitions (e.g., N_{PDSCH}^{max}), based on the number of pieces of scheduling information included in each row of set R. If the terminal determines that two or more pieces of scheduling information belong to a row of set R, N_{PDSCH}^{max}=1 may be determined. N_{PDSCH}^{max}=1 may indicate that a PDSCH is not repeatedly received.

If the terminal determines that one piece of scheduling information belongs to a row of set R, N_{PDSCH}^{max} may be determined based on pdsch-AggregationFactor. A method of determining N_{PDSCH}^{max} by the terminal is as follows. For example, if the terminal is configured with pdsch-AggregationFactor in PDSCH-Config, the terminal may use, as N_{PDSCH}^{max}, a value of pdsch-AggregationFactor in PDSCH-Config. If the terminal is configured with pdsch-AggregationFactor-r16 in PDSCH-Config, the terminal may use, as N_{PDSCH}^{max}, a value of pdsch-AggregationFactor-r16 in SPS-Config. If the terminal is configured with both pdsch-AggregationFactor in PDSCH-Config and pdsch-AggregationFactor-r16 in SPS-Config, the terminal may use, as N_{PDSCH}^{max}, a larger value among the values of pdsch-AggregationFactor in PDSCH-Config and pdsch-AggregationFactor-r16 in SPS-Config.

[Pseudo-Code 6: (Multi-PDSCH Scheduling, Time-Domain Bundling Configuration, and Repeated PDSCH Reception Configuration—Method 2)]
Preparation operation: Set R is a set of multiple pieces of scheduling information (slot information (hereinafter, K0 value) to which a PDSCH is mapped, and start symbol and length information (hereinafter, a starting and length value (SLIV)) configured in a time domain resource assignment (TDRA) table. If the terminal monitors one or more DCI formats, and the DCI formats use different TDRA tables, the set R is generated based on all TDRA tables.
Operation 0: M_{A,c} is initialized to an empty set. k is initialized to 0. j is initialized to 0.
Operation 1: A k-th largest K1 value is selected from configured set K1. (For example, if k=0, a largest K1 value is selected from the set K1, and if k=1, a second largest K1 value is selected from the set K1.) The K1 value is K_{1,k}.
Operation 2: A row may be excluded from set R according to the following two conditions.

Condition 1) If a row of set R includes one piece of scheduling information, and if a symbol corresponding to start symbol and length information (SLIV) belonging to each row of set R and a symbol configured for uplink in a higher layer overlap in each of previous N_{PDSCH}^{max} slots (slot n−K_{1,k}−(N_{PDSCH}^{max}−1), slot n−K_{1,k}−(N_{PDSCH}^{max}−1)+1, . . . , slot n−K_{1,k}) from a slot (slot n−K_{1,k}) corresponding to a K_{1,k} value of the row of set R, the row may be excluded from set R. Here, N_{PDSCH}^{max} is a value determined based on pdsch-AggregationFactor.

Conditions 2) If aforementioned condition 1 is not satisfied (i.e., if a row includes multiple pieces of scheduling information), and if a symbol corresponding to start symbol and length information (SLIV) belonging to each row of set R and a symbol configured for uplink in a higher layer overlap in each of slots determined by K0 values of respective rows of set R and a slot (slot n−K_{1,k}) corresponding to a K_{1,k} value of the row of set R, the row may be excluded from set R. The slots determined by the K0 values of respective row include slot n−K_{1,k}−Delta_Kᵢ (i=0, 1, . . . , the number of pieces of scheduling information in row−1), and Delta_Kᵢ=K0_max−K0_i. Here, K0_i is an i-th K0 value of multiple pieces of scheduling information, and K0_max is a K0 value (largest K0 value) of the last scheduling information.
Operation 3-1 (if the terminal has only UE capability of receiving a maximum of one unicast PDSCH in one slot): If determined set R is not an empty set, j is added as a new PDSCH reception candidate occasion to set M_{A,c}. When one of PDSCH candidates of set R is received, the terminal may place HARQ-ACK of the PDSCH in the new PDSCH candidate occasion of j. j is increased by 1.
Operation 3-2 (if the terminal has UE capability of receiving more than one unicast PDSCH in one slot): Set R′ is generated by collecting only last scheduling information of determined set R. For an SLIV that ends first in determined set R′ and SLIVs which overlap the SLIV in time, j is added as a new PDSCH reception candidate occasion to set M_{A,c}. When one of PDSCH candidates having the SLIV is received, the terminal may place HARQ-ACK of the PDSCH in the new PDSCH candidate occasion of j. j is increased by 1. The SLIVs are excluded from set R′. Operation 3-2 is repeated until set R′ becomes an empty set.
Operation 4: k is increased by 1. If k is smaller than the cardinality of set K1, operations are started again from operation 2, and if k is equal to or greater than the cardinality of set K1, pseudo-code 6 ends.

[End of Pseudo-Code 6]

A pseudo-code according to method 2 described above may be as in Table 36.

```
TABLE 36
  <Pseudo-code #3>
  while r < C(R)
  if the UE is not provided enableTimeDomainHARQ-Bundling and is
provided tdd-UL-DL-ConfigurationCommon, or tdd-UL-DL-
ConfigurationDedicated and, for each slot from slot └(n_{U} − K_{1,k}) · 2^{μ}^{_{DL}}^{-μ}^{_{UL}}┘ +
n_{D} − N_{PDSCH}^{repeat,max} + 1 to slot └(n_{U} − K_{1,k}) · 2^{μ}^{_{DL}}^{-μ}^{_{UL}}┘ + n_{D}, at least one symbol of
the PDSCH time resource derived by row r is configured as UL where K_{1,k} is the k-
th slot timing value in set K₁, or if HARQ-ACK information for PDSCH time
resource derived by row r in slot └(n_{U} − K_{1,k}) · 2^{μ}^{_{DL}}^{-μ}^{_{UL}}┘ + n_{D} cannot be provided
in slot n_{U}
  R = R\r;
  elseif the UE is provided enableTimeDomainHARQ-Bundling and tdd-UL-
DL-ConfigurationCommon, or tdd-UL-DL-ConfigurationDedicated and, for each
slot └(n_{U} − K_{1,k}) · 2^{μ}^{_{DL}}^{-μ}^{_{UL}}┘ + n_{D} − ΔK_{0,r}(d), at least one symbol of the PDSCH
time resource derived by row r of set R′ is configured as UL, where
$d = 0 , 1 , … , C ( Δ {K}_{0 , r} ) - 1 , Δ {K}_{0 , r} = {max}_{{K}_{0}} ( {K}_{0 , r} ) - {K}_{0 , r} ,$
and C(ΔK_{0,r}) is the cardinality of
ΔK_{0,r} and if the UE is configured to monitor DCI format 1_2 and the row r of set R
contains single SLIV, for each slot from slot └(n_{U} − K_{1,k}) · 2^{μ}^{_{DL}}^{-μ}^{_{UL}}┘ + n_{D} −
N_{PDSCH}^{repeat,max} + 1 to slot └(n_{U} − K_{1,k}) · 2^{μ}^{_{DL}}^{-μ}^{_{UL}}┘ + n_{D} at least one symbol of the
PDSCH time resource derived by row r of set R is configured as UL.
  R = R\r;
  R′ = R′\r;
  else
  r = r + 1;
  end if
  end while
```

[Method 3: Generating Set R by Considering N_{PDSCH}^{Max}]

As one method of the disclosure, when generating set R, the terminal may generate set R by considering N_{PDSCH}^{max}. Here, if a row of the TDRA table includes single-scheduling information and performs repeated reception according to N_{PDSCH}^{max}, the row may be considered to include N_{PDSCH}^{max} pieces of scheduling information so as to be included in set R. The terminal may generate a Type-1 HARQ-ACK codebook with the aforementioned pseudo-code, based on set R.

More specifically, descriptions are provided based on Table 31 which is a TDRA table including only single-scheduling information, and Table 32 which is a TDRA table including multiple pieces of scheduling information. The third DCI format of the terminal may include two rows of the TDRA table as in Table 31. In addition, the fourth DCI format of the terminal may include three rows of the TDRA table as in Table 32. For reference, the third DCI format is a DCI format that does not support multi-PDSCH scheduling, and the fourth DCI format is a DCI format that supports multi-PDSCH scheduling.

Repeated PDSCH reception may be applied to the third DCI format. That is, the terminal may repeatedly receive a PDSCH scheduled in the third DCI format in N_{PDSCH}^{max} slots. However, repeated PDSCH reception cannot be applied to the fourth DCI format. That is, the terminal does not repeatedly receive the PDSCH scheduled in the fourth DCI format. This is also applied to a row having single scheduling information in the fourth DCI format.

Table 31, which is a TDRA table including only single-scheduling information, may be represented as a TDRA table having multiple pieces of scheduling information as in Table 37 according to the number, N_{PDSCH}^{max}, of repetitions. Here, N_{PDSCH}^{max}=4 is assumed for convenience of description. That is, single-scheduling information appears to be four pieces of scheduling information. Here, first scheduling information is the same as single-scheduling information, and a K0 value of n-th scheduling information may be sequentially increased by 1 from the first scheduling information. That is, if a K0 value of the first scheduling information is K0_0, the K0 value of the n-th scheduling information is (K0_0)+n+1. In addition, SLIVs of all scheduling information may be the same as single-scheduling information.

TABLE 37

| | First | | Second | | Third | | Fourth | |
|---|---|---|---|---|---|---|---|---|
| | scheduling | | scheduling | | scheduling | | scheduling | |
| | information | | information | | information | | information | |
| | | SLIV | | SLIV | | SLIV | | SLIV |
| Index | K0 | (S, L) | K0 | (S, L) | K0 | (S, L) | K0 | (S, L) |
| 1 | 0 | SLIV 3_1 | 1 | SLIV 3_2 | 2 | SLIV 3_3 | 3 | SLIV 3_4 |
| | | (7, 7) | | (7, 7) | | (7, 7) | | (7, 7 ) |
| 2 | 0 | SLIV 4_1 | 1 | SLIV 4_2 | 2 | SLIV 4_3 | 3 | SLIV 4_4 |
| | | (0, 7) | | (0, 7) | | (0, 7) | | (0, 7) |

The terminal may generate Table 38 by using the union of the TDRA tables (e.g., the union of Table 32 and Table 37). Here, the indices are newly assigned.

TABLE 38

| | | | Second | | Third | | Fourth | |
|---|---|---|---|---|---|---|---|---|
| | First scheduling | | scheduling | | scheduling | | scheduling | |
| | information | | information | | information | | information | |
| | | SLIV | | SLIV | | SLIV | | SLIV |
| Index | K0 | (S, L) | K0 | (S, L) | K0 | (S, L) | K0 | (S, L) |
| 1 | 0 | SLIV 1_1 | 1 | SLIV 1_2 | — | — | — | — |
| | | (0, 4) | | (0, 4) | | | | |
| 2 | 0 | SLIV 2_1 | 2 | SLIV 2_2 | — | — | — | — |
| | | (0, 7) | | (7, 7) | | | | |
| 3 | 0 | SLIV 3_1 | — | — | — | — | — | — |
| | | (7, 7) | | | | | | |
| 4 | 0 | SLIV 3_1 | 1 | SLIV 3_2 | 2 | SLIV 3_3 | 3 | SLIV 3_4 |
| | | (7, 7) | | (7, 7) | | (7, 7) | | (7, 7) |
| 5 | 0 | SLIV 4_1 | 1 | SLIV 4_2 | 2 | SLIV 4_3 | 3 | SLIV 4_4 |
| | | (0, 7) | | (0, 7) | | (0, 7) | | (0, 7) |

In Table 38, repeated PDSCH reception has already been considered. Therefore, the terminal may generate a Type-1 HARQ-ACK CB by using existing pseudo-code 4 described above.

[Method 4: Assuming that One SLIV of Set R is for Repeated PDSCH Reception]

In aforementioned method 2, a row including one SLIV is found, and whether to exclude the row from set R is determined by applying the number of repetitions (e.g., N_{PDSCH}^{max}) to the one SLIV. However, in the above procedure, the terminal needs additional terminal complexity to find the row including one SLIV. In addition, in aforementioned method 1, it is required to determine whether a row is included in the third DCI format or is included in the fourth DCI format. If a row is included in the third DCI format, the terminal determines whether to exclude the row from set R, by applying the number of repetitions (e.g., N_{PDSCH}^{max}) to the SLIV included in the row. For reference, if included in the third DCI format, the row may include one SLIV. Here, the procedure requires additional terminal complexity in order for the terminal to determine whether each row is included in the third DCI format or is included in the fourth DCI format.

In the first and second methods, the additional terminal complexity may cause an increase in cost in terminal implementation, so that a method capable of solving this problem is required.

As one method of the disclosure, when a row includes one or multiple SLIVs, the terminal may select one SLIV from among the one or multiple SLIVs. The terminal may determine whether it is possible to receive the one SLIV according to repeated PDSCH reception scheduling. For example, based on the first condition, the terminal may determine that it is impossible to receive the one SLIV according to repeated PDSCH reception scheduling. Here, if the one SLIV overlaps a semi-static UL symbol in all slots of the number (e.g., N_{PDSCH}^{max}) of repetitions, it may be determined that it is impossible to receive the one SLIV according to repeated PDSCH reception scheduling. Based on the determination under the first condition, whether to exclude the row from set R may be determined.

As one method of the disclosure, when a row includes one or multiple SLIVs, the terminal may determine whether it is possible to receive the one or multiple SLIVs according to multi-PDSCH scheduling. For example, based on the second condition, if the one or multiple SLIVs overlap a semi-static UL symbol in slots in which the one or multiple SLIVs are received, the terminal may determine that it is impossible to receive the one or multiple SLIVs according to multi-PDSCH scheduling. Based on the determination under the second condition, whether to exclude the row from set R may be determined.

As one method of the disclosure, the terminal may determine whether to exclude a row from set R, based on the first condition and the second condition. That is, if it is determined, based on the first condition, that reception is impossible according to repeated PDSCH reception scheduling, and if it is determined, based on the second condition, that reception is impossible according to multi-PDSCH scheduling, the row may be excluded from set R. In other words, the row may be excluded from set R only if both conditions are satisfied. Even if one condition is not satisfied, if another condition is satisfied, the row may not be excluded from set R.

The biggest difference between the first and second methods and the aforementioned one method is that, when determining whether reception is possible according to repeated PDSCH reception scheduling, the terminal determines neither the number of SLIVs included in each row nor a DCI format in which an SLIV is included. Instead, the terminal may select one SLIV among SLIVs included in a row, and the terminal may consider the SLIV to be an SLIV included in the third DCI format of the first method or to be an SLIV of the second method.

As a specific example, descriptions are provided based on Table 31 which is a TDRA table including only single-scheduling information, and Table 32 which is a TDRA table including multiple pieces of scheduling information. The terminal may generate a TDRA table by gathering rows of Table 31 and rows of Table 32. This may be as in Table 33. A set of indices of rows in the TDRA table may be set R. That is, set R may be configured so that R={1, 2, 3, 4}. Here, the indices are an example and may be assigned by the terminal

Rows 1 and 2 of Table 33 generated by the terminal include multiple SLIVs, and rows 3 and 4 include one SLIV. As described above, multiple SLIVs may be used for multi-PDSCH scheduling, and one SLIV may be used for repeated PDSCH reception.

According to an example of the disclosure, the terminal may select one SLIV from rows (rows 1 to 2) having multiple SLIVs. For example, the one SLIV may be a last SLIV among multiple SLIVs. Here, the last may be the last in the order of scheduling information. Alternatively, the last here may be the last in terms of a scheduled time. That is, the last may be an SLIV of scheduling information having a largest K0 value of the scheduling information.

According to an example of the disclosure, the terminal may select one SLIV from rows (rows 1 to 2) having multiple SLIVs and may generate a new TDRA table by gathering the SLIV and one SLIV from rows (rows 3 to 4) having one SLIV. The new TDRA table is as in Table 39. For reference, in Table 39, it is assumed that last scheduling information is selected. For reference, a set of indices of rows of the TDRA table may be referred to as R_one. That is, set R_one may be configured so that set R_one={1, 2, 3, 4}. For reference, the indices of set R_one and set R may correspond to each other. In other words, one selected SLIV among SLIVs of a row of index i in set R may be an SLIV of a row of index i in set R.

TABLE 39

| | Selected scheduling | |
|---|---|---|
| | information | |
| Index | K0 | SLIV (S, L) |
| 1 | 1 | SLIV 1_2 (0, 4) |
| 2 | 2 | SLIV 2_2 (7, 7) |
| 3 | 0 | SLIV 3_1 (7, 7) |
| 4 | 0 | SLIV 4_1 (0, 7) |

According to an example of the disclosure, the terminal may apply repeated PDSCH reception, based on the new TDRA table (e.g., Table 39) generated by gathering the one SLIV. That is, it may be assumed that one SLIV of each row of the new TDRA table (e.g., Table 39) is received in N_{PDSCH}^{max} slots. If the one SLIV does not overlap a semi-static UL symbol in at least one of the N_{PDSCH}^{max} slots, the terminal may not exclude the row from set R. In addition, the row may not be excluded from set R_one.

According to an example of the disclosure, the terminal may apply multi-PDSCH reception, based on the TDRA table (e.g., Table 33) obtained by gathering all scheduling information. That is, it may be assumed that one or multiple SLIVs in each row of the TDRA table (e.g., Table 33) are received in slots scheduled for reception. If the one or multiple SLIVs do not overlap a semi-static UL symbol in at least one of the slots scheduled for reception, the terminal may not exclude the row from set R. In addition, the row may not be excluded from set R_one.

According to an example of the disclosure, the terminal may apply repeated PDSCH reception, based on the new TDRA table (e.g., Table 39) generated by gathering the one SLIV. It may be assumed that one SLIV of a row of the new TDRA table (e.g., Table 39) is received in N_{PDSCH}^{max} slots. The terminal may apply multi-PDSCH reception, based on the TDRA table (e.g., Table 33) obtained by gathering all scheduling information. That is, it may be assumed that one or multiple SLIVs in each row of the TDRA table (e.g., Table 33) are received in slots scheduled for reception. If one SLIV of a row of the new TDRA table (e.g., Table 39) overlaps a semi-static UL symbol in all N_{PDSCH}^{max} slots, and if one or multiple SLIVs of a row of the TDRA table (e.g., Table 33) overlap a semi-static UL symbol in all slots scheduled for the one or multiple SLIVs, the terminal may exclude the row from set R. In addition, the row may be excluded from set R_one.

N_{PDSCH}^{max} may be determined based on pdsch-AggregationFactor. A method of determining N_{PDSCH}^{max} by the terminal may be as follows. For example, if the terminal is configured with pdsch-AggregationFactor in PDSCH-Config, the terminal may use, as N_{PDSCH}^{max}, a value of pdsch-AggregationFactor in PDSCH-Config. If the terminal is configured with pdsch-AggregationFactor-r16 in PDSCH-Config, the terminal may use, as N_{PDSCH}^{max}, a value of pdsch-AggregationFactor-r16 in SPS-Config. If the terminal is configured with both pdsch-AggregationFactor in PDSCH-Config and pdsch-AggregationFactor-r16 in SPS-Config, the terminal may use, as N_{PDSCH}^{max}, a larger value among the values of pdsch-AggregationFactor in PDSCH-Config and pdsch-AggregationFactor-r16 in SPS-Config.

[Pseudo-Code 7: (Multi-PDSCH Scheduling, Time-Domain Bundling Configuration, and Repeated PDSCH Reception Configuration—Method 4)]
Preparation operation 1: Set R is a set of scheduling information (slot information (hereinafter, K0 value) to which a PDSCH is mapped, and start symbol and length information (hereinafter, a starting and length value (SLIV)) configured in a time domain resource assignment (TDRA) table. If the terminal monitors one or more DCI formats, and the DCI formats use different TDRA tables, the set R is generated based on all TDRA tables.
Preparation operation 2: Set R_one may be generated by selecting only one piece of scheduling information (e.g., SLIV) in each row of set R. That is, if row i of set R includes multiple pieces of scheduling information, row i of set R_one may include only one of the multiple pieces of scheduling information. Here, the one piece of scheduling information may be last scheduling information.
Operation 0: M_{A,c} is initialized to an empty set. k is initialized to 0. j is initialized to 0.
Operation 1: A k-th largest K1 value is selected from configured set K1. (For example, if k=0, a largest K1 value is selected from the set K1, and if k=1, a second largest K1 value is selected from the set K1.) The K1 value is K_{1,k}.
Operation 2: If a row satisfies both of the following conditions, the row may be excluded from set R and set R_one.

Condition 1) A symbol corresponding to start symbol and length information (SLIV) of one piece of scheduling information belonging to a row of set R_one and a symbol configured for uplink in a higher layer overlap in each of previous N_{PDSCH}^{max} slots (slot n−K_{1,k}−(N_{PDSCH}^{max}−1), slot n−K_{1,k}−(N_{PDSCH}^{max}−1)+1, . . . , slot n−K_{1,k}) from a slot (slot n−K_{1,k}) corresponding to a K_{1,k} value. Here, N_{PDSCH}^{max} is a value determined based on pdsch-AggregationFactor.

Conditions 2: A symbol corresponding to start symbol and length information (SLIV) belonging to each row of set R and a symbol configured for uplink in a higher layer overlap in each of slots determined by K0 values of respective rows of set R and a slot (slot n−K_{1,k}) corresponding to a K_{1,k} value of the row of set R. The slots determined by the K0 values of the rows include slot n−K_{1,k}−Delta_Kᵢ (i=0, 1, . . . , the number of pieces of scheduling information in row−1), and Delta_Kᵢ=K0_max−K0_i. Here, K0_i is an i-th K0 value of multiple pieces of scheduling information, and K0_max is a K0 value (largest K0 value) of the last scheduling information.
Operation 3-1 (if the terminal has only UE capability of receiving a maximum of one unicast PDSCH in one slot): If determined set R is not an empty set, j is added as a new PDSCH reception candidate occasion to set M_{A,c}. When one of PDSCH candidates of set R is received, the terminal may place HARQ-ACK of the PDSCH in the new PDSCH candidate occasion of j. j is increased by 1.
Operation 3-2 (if the terminal has UE capability of receiving more than one unicast PDSCH in one slot): R_last is generated by gathering only last scheduling information of determined set R. For an SLIV that ends first in determined set R_last and SLIVs which overlap the SLIV in time, j is added as a new PDSCH reception candidate occasion to set M_{A,c}. When one of PDSCH candidates having the SLIV is received, the terminal may place HARQ-ACK of the PDSCH in the new PDSCH candidate occasion of j. j is increased by 1. The SLIVs are excluded from set R′. Operation 3-2 is repeated until set R_last becomes an empty set. For reference, if set R_one includes only last scheduling information of set R, set R_last may be the same as set R_one. Therefore, operation 3-2 may be performed based on set R_one.
Operation 4: k is increased by 1. If k is smaller than the cardinality of set K1, operations are started again from operation 2, and if k is equal to or greater than the cardinality of set K1, pseudo-code 7 ends.

In aforementioned pseudo-code 7, in operation 2, condition 1 may be applied only when N_{PDSCH}^{max} is greater than 1. If N_{PDSCH}^{max}=1, operation 2 may be determined based only on condition 2. That is, if a row satisfies only condition 2, the row may be excluded from set R and set R_one.

A pseudo-code according to aforementioned method 4 may be as in Table 40. Here, set R′ is the same as set R of the disclosure.

```
TABLE 40
<Pseudo-code #4>
  while r < C(R)
    if the UE is not provided enableTimeDomainHARQ-Bundling and is
    provided tdd-UL-DL-ConfigurationCommon, or tdd-UL-DL-
    ConfigurationDedicated and, for each slot from slot └(n_{U} − K_{1,k}) ·
    2^{μ}^{_{DL}}^{-μ}^{_{UL}}┘ + n_{D} − N_{PDSCH}^{repeat,max} + 1 to slot
    └(n_{U} − K_{1,k}) · 2^{μ}^{_{DL}}^{-μ}^{_{UL}}┘ +
    n_{D}, at least one symbol of the PDSCH time resource derived by row r
    is configured as UL where K_{1,k} is the k-th slot timing value in set K₁,
    or if HARQ-ACK information for PDSCH time resource derived by
    row r in slot └(n_{U} − K_{1,k}) · 2^{μ}^{_{DL}}^{-μ}^{_{UL}}┘ + n_{D} cannot be provided in slot
    n_{U}
      R = R\r;
    elseif the UE is provided enableTimeDomainHARQ-Bundling and
    tdd-UL-DL-ConfigurationCommon, or tdd-UL-DL-
    ConfigurationDedicated and, for each slot
    └(n_{U} − K_{1,k}) · 2^{μ}^{_{DL}}^{-μ}^{_{UL}}┘ +
    n_{D} − ΔK_{0,r}(d), at least one symbol of the PDSCH time resource
    derived by row r of set R′ is configured as UL, where
    $d = 0 , 1 , … , C ( Δ {K}_{0 , r} ) - 1 , Δ {K}_{0 , r} = {max}_{{K}_{0}} ( {K}_{0 , r} ) - {K}_{0 , r} ,$
    and C(ΔK_{0,r}) is the
    cardinality of ΔK_{0,r} and for each slot from slot └(n_{U} − K_{1,k}) ·
    2^{μ}^{_{DL}}^{-μ}^{_{UL}}┘ + n_{D} − N_{PDSCH}^{repeat,max} + 1 to slot
    └(n_{U} − K_{1,k}) · 2^{μ}^{_{DL}}^{-μ}^{_{UL}}┘ +
    n_{D} at least one symbol of the PDSCH time resource derived by row r
    of set Rₒₙₑ is configured as UL.
      Rₒₙₑ = R\r;
      R′ = R′\r;
    else
      r = r + 1;
    end if
  end while
```

[Method 5: HARQ-ACK Transmission for Repeated PDSCH Reception is not Possible Via Type-1 HARQ-ACK Codebook]

As another method of the disclosure, HARQ-ACK of repeated PDSCH reception may not be transmitted via a Type-1 HARQ-ACK codebook. That is, the terminal may not configure HARQ-ACK of repeated PDSCH reception with a Type-1 HARQ-ACK codebook. This may be implemented with an appropriate configuration of a base station.

For example, if the terminal is configured with a Type-1 HARQ-ACK codebook and configured with multi-PDSCH scheduling, the terminal may be configured with only one of time-domain bundling and repeated PDSCH reception. That is, if time-domain bundling is configured, it may be assumed that the terminal does not perform repeated PDSCH reception. That is, a Type-1 HARQ-ACK codebook may be generated by assuming N_{PDSCH}^{max}=1. Conversely, if repeated PDSCH reception is configured, it may be assumed that time-domain bundling is not configured.

If the terminal is configured with multi-PDSCH scheduling, a codebook other than the Type-1 HARQ-ACK codebook may be configured for time-domain bundling and repeated PDSCH reception. As an example, a Type-2 HARQ-ACK codebook may be configured.

Therefore, if the terminal is configured with the Type-1 HARQ-ACK codebook and configured with multi-PDSCH scheduling, the terminal may not expect to be configured with both time-domain bundling and repeated PDSCH reception.

[Relating to Non-Numerical K1 (NNK1) Value]

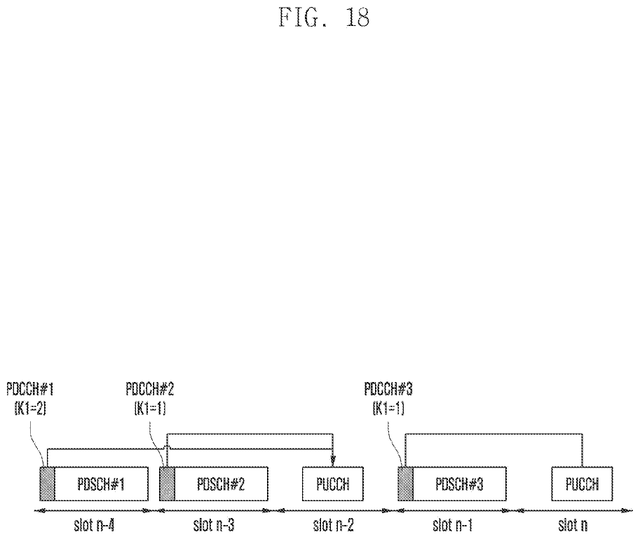

Referring to FIG. 18, a terminal may transmit HARQ-ACK information indicating successful reception of a PDSCH via an uplink. Here, HARQ-ACK information may be transmitted via a PUCCH or a PUSCH. A slot in which a PUCCH or PUSCH for transmission of HARQ-ACK information is transmitted and a slot in which a PDSCH is received may be included in the DCI format. The slot in which the PUCCH or PUSCH is transmitted may be referred to as a K1 value or PDSCH-to-HARQ feedback timing in DCI.

FIG. 18 is a diagram illustrating that a terminal transmits, via an uplink, HARQ-ACK information indicating successful reception of a PDSCH according to an embodiment of the disclosure.

Referring to FIG. 18, the terminal may receive multiple PDSCHs, and each PDSCH may be scheduled in each DCI format. In addition, each DCI format may include a K1 value. The terminal may receive three PDSCHs in slot n−4, slot n−3, and slot n−1. Here, each of the three PDSCHs may have a DCI format for scheduling. For convenience, it may be assumed that the DCI format is received via a PDCCH in the same slot as that for a PDSCH. The terminal may be indicated with 2 as a K1 value for a DCI format for scheduling of PDSCH #1 received in slot n−4. In this case, the terminal may transmit HARQ-ACK information of PDSCH #1 received in slot n−4, in slot n−4+K1 value=slot n−4+2=slot n−2 Similarly, the terminal may be indicated with 1 as a K1 value for a DCI format for scheduling of DSCH #2 received in slot n−3. Accordingly, HARQ-ACK information of PDSCH #1 of slot n−4 and that of PDSCH #2 of slot n−3 may be transmitted on a PUCCH or PUSCH in slot n−2. In addition, the terminal may be indicated with 1 as a K1 value for a DCI format for scheduling of PDSCH #3 received in slot n−1. Accordingly, HARQ-ACK information of PDSCH #3 of slot n−1 may be transmitted on a PUCCH or PUSCH in slot n.

In this way, a K1 value indicating transmission of HARQ-ACK information in a specific slot may be referred to as a numerical K1 value or an applicable K1 value.

Referring to FIG. 18, the terminal may not be able to transmit a PUCCH or PUSCH under a specific condition. For example, if a cell (or carrier) for transmission of a PUCCH to PUSCH is an unlicensed band, the terminal should succeed in listen-before-talk (LBT) in order to perform uplink transmission. However, if LBT fails in slot n−2, the terminal cannot transmit a PUCCH in slot n−2. The terminal cannot transmit the PUCCH, and thus a base station cannot receive HARQ-ACK information of PDSCH #1 or that of PDSCH #2, so that PDSCH #1 or PDSCH #2 need to be retransmitted. This may cause reduction of downlink capacity of a network and downlink resource consumption.

To solve this problem, the DCI format may transmit a K1 value that does not designate a slot, instead of a K1 value indicating transmission of HARQ-ACK information in a specific slot. This K1 value may be referred to as a non-numerical K1 (NNK1) value or an inapplicable K1 value. A method of HARQ-ACK transmission using a non-numerical K1 value (inapplicable K1 value) is illustrated in FIG. 18.

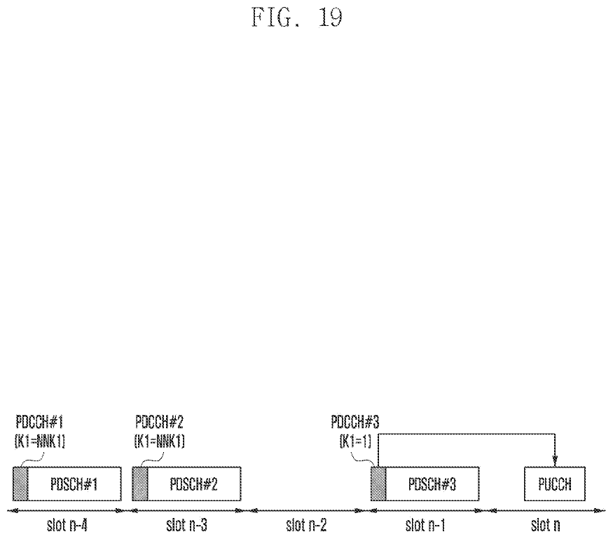

FIG. 19 is a diagram illustrating that a terminal receives multiple PDSCHs scheduled in multiple DCI formats according to an embodiment of the disclosure.

Referring to FIG. 19, the terminal may receive multiple PDSCHs, and each PDSCH may be scheduled in each DCI format. In addition, each DCI format may include a K1 value. The terminal may receive three PDSCHs in slot n−4, slot n−3, and slot n−1. Here, each of the three PDSCHs may have a DCI format for scheduling. For convenience, it may be assumed that the DCI format is received via a PDCCH in the same slot as that for a PDSCH. The terminal may be indicated with a non-numerical K1 as a K1 value for a DCI format for scheduling of PDSCH #1 received in slot n−4. In this case, the terminal may not specify a slot in which HARQ-ACK information of the PDSCH #1 is transmitted. Similarly, the terminal may be indicated with a non-numerical K1 as a K1 value for a DCI format for scheduling of PDSCH #2 received in slot n−3. Therefore, a slot in which HARQ-ACK information of PDSCH #2 is transmitted may not be specified. In addition, the terminal may be indicated with 1 as a K1 value for a DCI format for scheduling of PDSCH #3 received in slot n−1. Accordingly, HARQ-ACK information of PDSCH #3 of slot n−1 may be transmitted on a PUCCH or PUSCH in slot n. In this case, the terminal may transmit HARQ-ACK information of the PDSCHs (PDSCH #1, PDSCH #2), for which the HARQ-ACK information has not been transmitted due to the described indication of the non-numerical K1, in the PUCCH or PUSCH in which the HARQ-ACK information of the PDSCH #3 is transmitted. That is, when a slot for transmission of HARQ-ACK information is not specified due to indication of a non-numerical K1 value, if a slot for transmission HARQ-ACK information is specified in DCI that is received later, the HARQ-ACK information may be transmitted in the specified slot.

[Relating to Type-3/Enhanced Type-3 HARQ-ACK Codebook]

A Type-3 HARQ-ACK codebook (or one-shot codebook) is a scheme of reporting all HARQ-ACK information about the number of HARQ processes and all serving cells, the number of TBs for each HARQ process, and the number of CBGs for each TB, which are configured for the terminal. For example, if there are 2 serving cells, 16 HARQ processes for each serving cell, 1 TB for each HARQ process, and 2 CBGs for each TB, the terminal reports a total of 64 (=2*16*1*2) HARQ-ACK information bits.

The Type-3 HARQ-ACK codebook may list HARQ-ACK information bits in a sequential order. The sequential order may be as follows.

HARQ-ACK information may be arranged in ascending order of indices of the serving cells.

Within the same serving cell, HARQ-ACK information may be arranged in ascending order of the HARQ processes.

If an identical HARQ process includes multiple TBs (i.e., for 2-TB transmission), HARQ-ACK information of a first TB may be arranged at a position preceding HARQ-ACK information of a second TB.

If an identical TB includes multiple CBGs (i.e., for CBG-based PDSCH transmission), CBG indices may be arranged in ascending order.

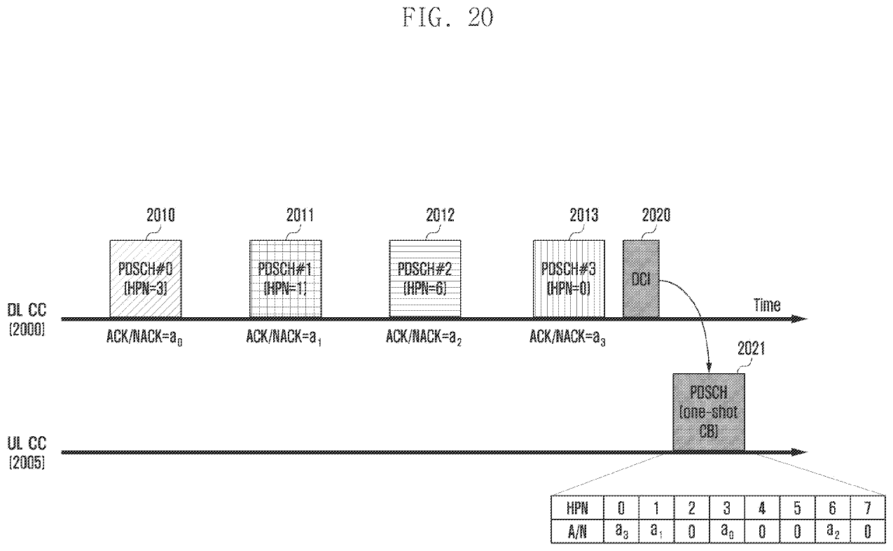

FIG. 20 is a diagram illustrating type-3 HARQ-ACK codebook transmission of a terminal configured with a downlink serving cell (DL CC) and an uplink serving cell (UL CC) according to an embodiment of the disclosure.

Referring to FIG. 20, it is assumed that a terminal is configured with one downlink serving cell (DL CC) 2000 and one uplink serving cell (UL CC) 2005. Here, the uplink serving cell is a cell for transmission of a PUCCH 2021. It is assumed that the terminal is configured to have 8 HARQ processes in the downlink serving cell 2000, and one PDSCH is configured for transmission of only one TB. In addition, it is assumed that no CBG-based transmission is configured. A Type-3 HARQ-ACK codebook may be generated according to the number of HARQ processes and all serving cells, and the number of TBs for each HARQ process. Therefore, since the terminal is configured with 8 HARQ processes in one serving cell and 1 TB per HARQ process, the Type-3 HARQ-ACK codebook may include 8 bits of HARQ-ACK information.

The terminal may arrange 8 bits of the type-3 HARQ-ACK codebook in ascending order of the HARQ processes in the downlink serving cell 2000. Since the terminal is configured with 8 HARQ processes in the downlink serving cell 2000,

HARQ-ACK information of HARQ process 0 may be located at a first place in the Type-3 HARQ-ACK codebook,

HARQ-ACK information of HARQ process 1 may be located at a second place in the Type-3 HARQ-ACK codebook,

HARQ-ACK information of HARQ process 2 may be located at a third place in the Type-3 HARQ-ACK codebook,

HARQ-ACK information of HARQ process 3 may be located at a fourth place in the Type-3 HARQ-ACK codebook,

HARQ-ACK information of HARQ process 4 may be located at a fifth place in the Type-3 HARQ-ACK codebook,

HARQ-ACK information of HARQ process 5 may be located at a sixth place in the Type-3 HARQ-ACK codebook,

HARQ-ACK information of HARQ process 6 may be located at a seventh place in the Type-3 HARQ-ACK codebook, and

HARQ-ACK information of HARQ process 7 may be located at a last place in the Type-3 HARQ-ACK.

Referring to FIG. 20, the terminal may receive 4 PDSCHs in the downlink serving cell 2000. In chronological order, the terminal may receive PDSCH #0 2010, PDSCH #1 2011, PDSCH #2 2012, and PDSCH #3 2013. It is assumed that PDSCH #0 is indicated with an HARQ process number of 3, and HARQ-ACK information of PDSCH #0 is a₀. It is assumed that PDSCH #1 is indicated with an HARQ process number of 1, and HARQ-ACK information of PDSCH #1 is a₁. It is assumed that PDSCH #2 is indicated with an HARQ process number of 6, and HARQ-ACK information of PDSCH #1 is a₂. In addition, it is assumed that PDSCH #3 is indicated with an HARQ process number of 0, and HARQ-ACK information of PDSCH #3 is a₃. The terminal may include the HARQ-ACK information of a₀, a₁, a₂, and a₃ in the Type-3 HARQ-ACK codebook according to the HARQ process numbers. That is, since the HARQ process number of PDSCH #0 is 3, a₀ which is HARQ-ACK of PDSCH #0 may be included in a fourth bit of the Type-3 HARQ-ACK codebook. Since the HARQ process number of PDSCH #1 is 1, a₁ which is HARQ-ACK of PDSCH #1 may be included in a second bit of the Type-3 HARQ-ACK codebook. Since the HARQ process number of PDSCH #2 is 6, a₂ which is HARQ-ACK of PDSCH #2 may be included in a seventh bit of the Type-3 HARQ-ACK codebook. Finally, since the HARQ process number of PDSCH #3 is 0, a₃ which is HARQ-ACK of PDSCH #3 may be included in a first bit of the Type-3 HARQ-ACK codebook. For reference, in the Type-3 HARQ-ACK codebook, NACK (or 0) may be included for an HARQ process number for which reception has failed or an HARQ process number for which feedback has already been transmitted to a base station.

The terminal may receive DCI 2020 indicating transmission of the Type-3 HARQ-ACK codebook in the downlink serving cell 2000. The terminal may receive, from the DCI, a PUCCH 2021 resource for transmission of the Type-3 HARQ-ACK codebook. The terminal may transmit the 8-bit Type-3 HARQ-ACK codebook in the PUCCH resource.

According to a separate configuration, in the Type-3 HARQ-ACK codebook, in addition to HARQ-ACK information, it may be possible to report an NDI value recently received by the terminal for each HARQ process and for all serving cells. Based on a corresponding NDI value, the base station may determine whether a PDSCH received for each HARQ process of the terminal is determined to be initial transmission or is determined to be retransmission.

When there is no separate report of a corresponding NDI value, if HARQ-ACK information has already been reported for a specific HARQ process before the base station receives the DCI for requesting the Type-3 HARQ-ACK codebook, the terminal maps a corresponding HARQ process to NACK, and otherwise maps an HARQ-ACK information bit to a PDSCH received for each corresponding HARQ process.

The number of serving cells, the number of HARQ processes, the number of TBs, and the number of CBGs may be configured separately, and if there is no separate configuration, the terminal may consider each of the number of serving cells to be 1, the number of HARQ processes to be 8, the number of TB to be 1, and the number of CBG to be 1. In addition, the number of HARQ processes may be different for each serving cell. The number of TBs may have different values for each serving cell or for each BWP within a serving cell. In addition, the number of CBGs may be different for each serving cell.

One of reasons that the Type-3 HARQ-ACK codebook is needed may be occurrence of a case where the terminal cannot transmit a PUCCH or PUSCH including HARQ-ACK information for a PDSCH due to a channel access failure or overlapping with another channel having high priority. Therefore, it is reasonable for the base station to request reporting of only corresponding HARQ-ACK information without needing to reschedule a separate PDSCH. Accordingly, the terminal may be able to schedule transmission of the Type-3 HARQ-ACK codebook and a PUCCH resource in which the codebook is to be transmitted, via a higher signal or an L1 signal (e.g., a specific field in DCI) from the base station.

The terminal may include, in DCI format, an indicator indicating transmission of the Type-3 HARQ-ACK codebook. The indicator may indicate 0 or 1.

If the terminal receives a DCI format including 1 as a value of a field for requesting transmission of the Type-3 HARQ-ACK codebook, the terminal determines a PUCCH or PUSCH resource for transmission of the Type-3 HARQ-ACK codebook in a specific slot indicated by the DCI format. In addition, the terminal multiplexes only the Type-3 HARQ-ACK codebook within the PUCCH or PUSCH of the corresponding slot. The terminal may assume that the DCI format is not for PDSCH scheduling. That is, fields for PDSCH transmission in the DCI format may not be used for PDSCH scheduling. Furthermore, the fields that are not used for PDSCH scheduling may be used for other purposes.

The Type-3 HARQ-ACK codebook should include HARQ-ACK information of all HARQ processes and all serving cells, based on information configured for the terminal. Therefore, an HARQ-ACK information bit for a PDSCH of an HARQ process, which is not actually used, should also be included as NACK in the codebook. Accordingly, there is a disadvantage that a Type-3 HARQ-ACK codebook size is large. Therefore, there is a possibility that uplink transmission coverage or transmission reliability decreases as an uplink control information bit size increases. An HARQ-ACK codebook having a size smaller that that of the Type-3 HARQ-ACK codebook is required. This codebook is referred to as an enhanced Type-3 HARQ-ACK codebook. As an example, an enhanced Type-3 HARQ-ACK codebook may be configured as follows.
Type A: a subset of a total set of (configured) serving cells
Type B: a subset of a total set of (configured) HARQ process numbers
Type C: a subset of a total set of (configured) TB indices
Type D: a subset of a total set of (configured) CBG indices
Type E: a combination of at least two of types A to D

The enhanced Type-3 HARQ-ACK codebook may have characteristics of at least one of types A to E, and may be configured by one or multiple sets. The enhanced Type-3 HARQ-ACK codebook may include the entire set of types A to E instead of a subset. As for the meaning of multiple sets, for example, it is possible that type A and type B exist, or that different subsets exist even when type A exists.

The terminal may be indicated with a type of the Enhanced Type-3 HARQ-ACK codebook by a higher signal, an L1 signal, or a combination thereof. For example, as in Table 41, it may be possible that a set configuration for HARQ-ACK information bits to be reported in each enhanced Type-3 HARQ-ACK codebook is indicated via a higher signal, and one of these values is indicated by an L1 signal. As in Table 41, it may be possible to individually configure a type of the enhanced Type-3 HARQ-ACK codebook configured for each index via a higher signal. For convenience, such a table may be referred to as an enhanced Type-3 HARQ-ACK codebook type table.

For a specific index (index 3 in Table 41) of the enhanced Type-3 HARQ-ACK codebook type table, use of the Type-3 HARQ-ACK codebook for reporting all HARQ-ACK information bits is also possible. If not separately indicated by a higher signal or if there is no higher signal, it may be determined that the Type-3 HARQ-ACK codebook is used based on a default value (e.g., ACK or NACK states for all HARQ process numbers).

TABLE 41
Enhanced Type-3 HARQ-ACK codebook type table

| Index | Type3 |
|---|---|
| 1 | Serving cell i, HARQ process numbers (#1 to #8), TB 1 |
| 2 | Serving cell i, HARQ process numbers (#9 to #12), TB 1 |
| 3 | Type-3 HARQ-ACK codebook |
| . . . | . . . |

If the terminal receives a value indicated by index 1, the terminal reports an enhanced Type-3 HARQ-ACK codebook including a total of 8 bits of HARQ-ACK information for serving cell i, HARQ process numbers (#1 to #8), and TB 1 according to Table 41. If the terminal receives a value indicated by index 2, the terminal reports a total of 4 bits of HARQ-ACK information bits for serving cell i, HARQ process numbers (#9 to #12), and TB 1 according to Table 41. If the terminal receives a value indicated by index 3, the terminal calculates a total number of HARQ-ACK bits by considering a serving cell set, a total number of HARQ processes per serving cell i, the number of TBs per HARQ process, and the number of CBGs per TB according to Table 41. Table 41 is only an example, and a total number of indices may be more or fewer than this, and a range of an HARQ process value indicated by each index and/or information included in the enhanced Type-3 HARQ-ACK codebook may be different. In addition, Table 41 may be information indicated by a higher signal, and a specific index may be notified via DCI. Selection of the specific index in Table 41 may be indicated by a combination of or at least one of an HARQ process number, MCS, NDI, RV, frequency resource allocation information, or time resource allocation information in DCI fields. A size of a DCI bit field indicating the specific index of Table 41 may be determined by ┌log 2(Nₜₒₜₐₗ^{index})┐. Here, Nₜₒₜₐₗ^{index} denotes a total number of indices of Table 41 configured via a higher signal.

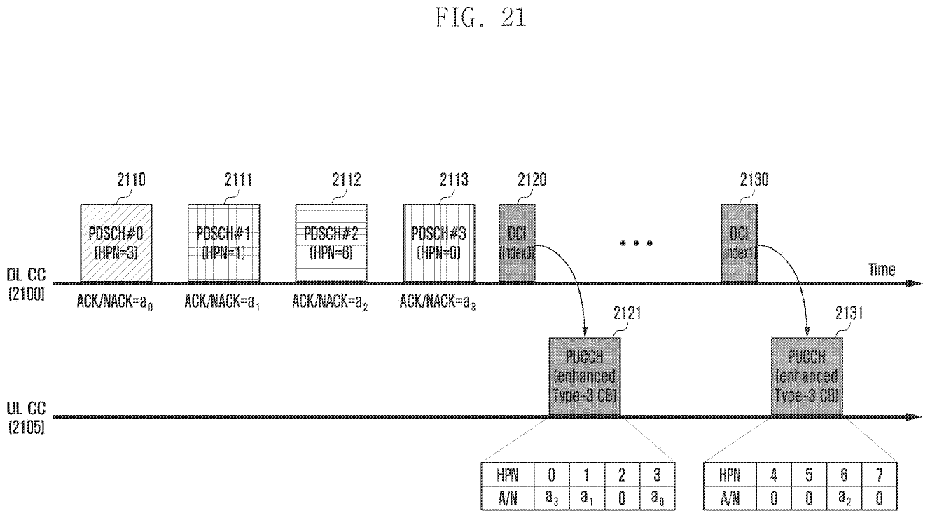

FIG. 21 illustrates enhanced type-3 HARQ-ACK codebook transmission when an enhanced type-3 HARQ-ACK codebook is configured for a terminal according to an embodiment of the disclosure.

Serving cell configuration, HARQ process number configuration, etc. of the terminal are the same as those in FIG. 20. Reference numbers 2100, 2105, 2110, 2111, 2112, and 2113 are substantially similar to 2000, 2005, 2010, 2011, 2012, and 2013 of FIG. 20, and descriptions thereof will not be repeated. Unlike in FIG. 20, the terminal is configured with enhanced Type-3 HARQ-ACK codebook transmission. For example, if index 0 is indicated by DCI 2120 for triggering enhanced Type-3 HARQ-ACK codebook transmission, an enhanced Type-3 HARQ-ACK codebook 2121 to be transmitted by the terminal includes only HARQ-ACK information for HARQ processes of {0, 1, 2, 3} among 8 HARQ processes, and may not include HARQ-ACK information for HARQ processes of {4, 5, 6, 7}. For example, if index 1 is indicated by DCI 2130 for triggering enhanced Type-3 HARQ-ACK codebook transmission, an enhanced Type-3 HARQ-ACK codebook 2131 to be transmitted by the terminal includes only HARQ-ACK information for HARQ processes of {4, 5, 6, 7} among 8 HARQ processes, and may not include HARQ-ACK information for HARQ processes of {0, 1, 2, 3}. Although not illustrated in FIG. 21, another index other than indices 0 and 1 may be further indicated, and if the index is indicated, an enhanced Type-3 HARQ-ACK codebook including only HARQ-ACK information for an HARQ process corresponding to the index may be transmitted.

<Type-1 HARQ-ACK CB Based on Set K1 Except for an NNK1 Value>

The disclosure relates to a method of Type-1 HARQ-ACK codebook generation when a Type-1 HARQ-ACK codebook and a Type-3 HARQ-ACK codebook are concurrently received.

The terminal may receive a DCI format to be monitored from the base station. For example, the DCI format may include at least one of DCI format 1_0, DCI format 1_1, and DCI format 1_2. The DCI format may include DCI that enables PDSCH scheduling. The DCI format is not for PDSCH schedule, but may include a DCI format indicating a specific operation to the terminal. For example, the DCI format may be a DCI format for terminating semi-persistent scheduling (SPS) PDSCH reception and configured grant (CG) PUSCH transmission, may be a DCI format supporting SCell dormancy, or may be a DCI format indicating a transmission configuration index (TCI). The terminal may transmit, via a PUCCH or a PUSCH, the DCI format or HARQ-ACK information for a PDSCH scheduled by the DCI format.

Each DCI format may include a DCI field for indicating a slot in which HARQ-ACK information is transmitted. In addition, for the terminal, candidate values for indicating a slot in which HARQ-ACK information is transmitted may be configured in each DCI format. For example, candidate values for indicating a slot for transmission of HARQ-ACK information of a PDSCH associated with DCI format 1_0 or DCI format 1_0 may be {1, 2, 3, 4, 5, 6, 7, 8} when the HARQ-ACK information is transmitted via an uplink with a subcarrier spacing of 15 kHz, 30 kHz, 60 kHz, or 120 kHz, the candidate values may be {7, 8, 12, 16, 20, 24, 28, 32} when the HARQ-ACK information is transmitted in an uplink with a subcarrier spacing of 480 kHz, and the candidate values may be {13, 16, 24, 32, 40, 48, 56, 64} when the HARQ-ACK information is transmitted in an uplink with a subcarrier spacing of 960 kHz. In DCI format 1_0, the DCI field for indicating a slot for transmission of HARQ-ACK information may be fixed to 3 bits.

For DCI format 1_1, the terminal may receive at least one of the following configurations from the base station.

As a first configuration, dl-DataToUL-ACK may be configured. The configuration may include one to eight values from one of {0, 1, 2, 3, 4, 5, 6, 7, 8, 9, 10, 11, 12, 13, 14, 15}.

As a second configuration, dl-DataToUL-ACK-r16 may be configured. The configuration may include one to eight values from one of {−1, 0, 1, 2, 3, 4, 5, 6, 7, 8, 9, 10, 11, 12, 13, 14, 15}.

As a third configuration, dl-DataToUL-ACK-r17 may be configured. The configuration may include one to eight values from one of {−1, 0, 1, . . . , 127}.

If the terminal is configured with the third configuration among the first configuration, the second configuration, or the third configuration, the terminal may determine, according to the third configuration, the configured value(s) as candidate values for indicating DCI format 1_1 or a slot for transmission of HARQ-ACK information of the PDSCH associated with DCI format 1_1, and may disregard the first configuration and the second configuration. In addition, if the terminal is configured with the second configuration without being configured with the third configuration, the terminal may determine, according to the second configuration, the configured value(s) as candidate values for indicating DCI format 1_1 or a slot for transmission of HARQ-ACK information of the PDSCH associated with DCI format 1_1, and may disregard the first configuration. If the terminal is configured with only the first configuration, the terminal may determine, according to the first configuration, the configured value(s) as candidate values for indicating DCI format 1_1 or a slot for transmission of HARQ-ACK information of the PDSCH associated with DCI format 1_1. In DCI format 1_1, the number of bits of the DCI field for indicating a slot for transmission of HARQ-ACK information may be determined according to the number of candidate values. That is, the number of bits of the DCI field may be determined by ceil(log 2 (the number of candidate values)). Here, ceil(x) is a rounding-up function that returns a smallest integer among integers greater than or equal to x.

For DCI format 1_2, the terminal may be configured with at least one of the following configurations from the base station.

As a fourth configuration, dl-DataToUL-ACK-DCI-1-2-r16 may be configured. The configuration may include one to eight values from one of {0, 1, 2, 3, 4, 5, 6, 7, 8, 9, 10, 11, 12, 13, 14, 15}.

As a fifth configuration, dl-DataToUL-ACK-DCI-1-2-r17 may be configured. The configuration may include one to eight values from one of {0, 1, 2, 3, 4, 5, 6, 7, 8, 9, 10, 11, 12, 13, 14, 15}.

If the terminal is configured with the fifth configuration among the fourth configuration and the fifth configuration, the terminal may determine, according to the fifth configuration, the configured value(s) as candidate values for indicating DCI format 1_2 or a slot for transmission of HARQ-ACK information of the PDSCH associated with DCI format 1_2, and may disregard the fourth configuration. In addition, if the terminal is configured with only the fourth configuration, the terminal may determine, according to the fourth configuration, the configured value(s) as candidate values for indicating DCI format 1_2 or a slot for transmission of HARQ-ACK information of the PDSCH associated with DCI format 1_2. In DCI format 1_2, the number of bits of the DCI field for indicating a slot for transmission of HARQ-ACK information may be determined according to the number of candidate values. That is, the number of bits of the DCI field may be determined by ceil(log 2 (the number of candidate values)). Here, ceil(x) is a rounding-up function that returns a smallest integer among integers greater than or equal to x.

For reference, in the above descriptions, the candidate values for indicating a slot for transmission of HARQ-ACK information may be referred to as a K1 value.

Among the candidate values for indicating a slot for transmission of HARQ-ACK information, “−1” may be referred to as a non-numerical K1 (NNK1) value or an inapplicable K1 value. “−1” is a value used for convenience and may be replaced with any negative number, a symbol, or the like other than “−1”. Among the candidate values for indicating a slot for transmission of HARQ-ACK information, a value except for “−1” (that is, a value equal to or greater than 0) may be referred to as a numerical K1 value or an applicable K1 value.

The terminal may generate set K1 to generate a Type-1 HARQ-ACK codebook. Set K1 may be a set of candidate values for indicating HARQ-ACK information. More specifically, set kl may be generated as follows.

If the terminal is configured to monitor DCI format 1_0 and is not configured to monitor DCI format 1_1 and DCI format 1_2, set K1 may be {1, 2, 3, 4, 5, 6, 7, 8} when the HARQ-ACK information is transmitted via an uplink with a subcarrier spacing of 15 kHz, 30 kHz, 60 kHz, or 120 kHz, set K1 may be {7, 8, 12, 16, 20, 24, 28, 32} when the HARQ-ACK information is transmitted in an uplink with a subcarrier spacing of 480 kHz, and set K1 may be {13, 16, 24, 32, 40, 48, 56, 64} when the HARQ-ACK information is transmitted in an uplink with a subcarrier spacing of 960 kHz.

If the terminal is configured to monitor DCI format 1_1 without being configured to monitor DCI format 1_2, set K1 may include values configured according to the first configuration, the second configuration, or the third configuration. Here, values of the third configuration may be included in set K1 if the third configuration is configured, value of the second configuration may be included in set K1 if the second configuration is configured without the third configuration being configured, and values of the first configuration may be included if only the first configuration is configured.

If the terminal is configured to monitor DCI format 1_2 without being configured to monitor DCI format 1_1, set K1 may include values configured according to the fourth configuration or the fifth configuration. Here, if the fifth configuration is configured, values of the fifth configuration may be included in set K1, and if only the fourth configuration is configured, values of the fourth configuration may be included in set K1.

If the terminal is configured to monitor both DCI format 1_1 and DCI format 1_2, set K1 may be determined to be a union of configuration values of one of the first, second, and third configurations and configuration values of one of the fourth and fifth configurations. Here, one configuration among the first, second, and third configurations may be determined as follows. If the third configuration is configured, the third configuration may be the one configuration, if the second configuration is configured without the third configuration being configured, the second configuration may be the one configuration, and if only the first configuration is configured, the first configuration may be the one configuration. Here, one configuration among the fourth and fifth configurations may be determined as follows. If the fifth configuration is configured, the fifth configuration may be the one configuration, and if only the fourth configuration is configured, the fourth configuration may be the one configuration.

The aforementioned second configuration or third configuration may include at least one non-numerical K1 value (inapplicable K1 value). Accordingly, the terminal may include the non-numerical K1 value in set K 1.

The disclosure proposes a method of generating a type-1 HARQ-ACK codebook if a non-numerical K1 value is included in set K1.

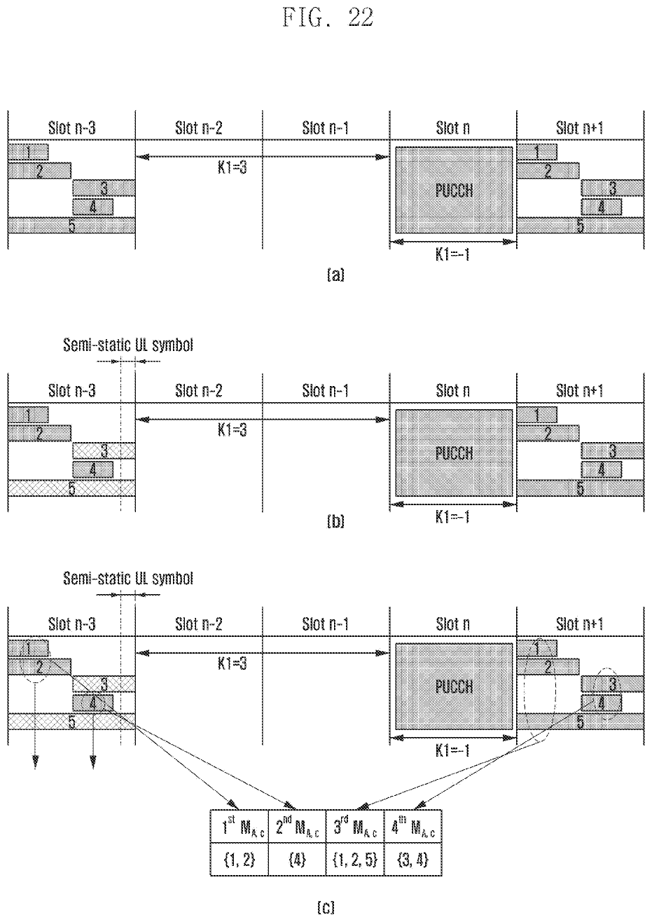

FIG. 22 is a diagram illustrating a method of generating a Type-1 HARQ-ACK codebook if a non-numerical K1 value is included in set K1. Here, set K1 is assumed to be {4, 2}, a TDRA table is assumed to be Table 26, and single PDSCH scheduling is assumed according to various embodiments of the disclosure.

Referring to aforementioned pseudo-code 1, a procedure of generating a Type-1 HARQ-ACK codebook by the terminal is as follows.
Operation 0: M_{A,c} is initialized to an empty set. k is initialized to 0. j is initialized to 0.

Operation 1: A k-th (k=0) largest K1 value is selected from configured set K1. In an example of FIG. 22, the K1 value is K_{1,0}=2.

Operation 2: If a symbol corresponding to start symbol and length information (SLIV) belonging to each row of set R and a symbol configured for uplink in a higher layer overlap in slot n−K_{1,0}=slot n−2, the row may be excluded from set R. Referring to FIG. 22 part [b], if some symbols of slot n−2 are semi-static UL symbols configured via a higher layer, rows including SLIVs overlapping the symbol may be excluded from set R. Referring to FIG. 22 part [b], last two symbols of slot n−2 may be semi-static uplink symbols, in which case SLIV (7,7) in row 3 and SLIV (0,14) in row 5 overlap with the semi-static uplink symbol so as to be excluded from set R. Set R may include rows 1, 2, and 4.
Operation 3-2 (if the terminal has UE capability of receiving more than one unicast PDSCH in one slot):

For an SLIV that ends first in determined set R and SLIVs which overlap the SLIV in time, j=0 is added as a new PDSCH reception candidate occasion to set M_{A,c}. Here, the SLIV that ends first is SLIV (0,4) of row 1, and an SLIV overlapping the SLIV is SLIV (0,7) of row 2. Therefore, if j=0 is added to M_{A,c} and the terminal receives a PDSCH scheduled with SLIV (0,4) of row 1 or SLIV (0,7) of row 2, HARQ-ACK of the PDSCH may be included in a position corresponding to first (j=0) M_{A,c} in the Type-1 HARQ-ACK codebook. j is increased by 1 so that j=1. the SLIVs of rows 1 and 2 are excluded from set R so that R={4}. Set R is not an empty set, and operation 3-2 is thus repeated.

For an SLIV that ends first in determined set R and SLIVs which overlap the SLIV in time, j=1 is added as a new PDSCH reception candidate occasion to set M_{A,c}. Here, the SLIV that ends first is SLIV (7,4) of row 4, and there is no SLIV overlapping the SLIV. Therefore, if j=1 is added to M_{A,c} and the terminal receives a PDSCH scheduled with SLIV (7,4) of row 4, HARQ-ACK of the PDSCH may be included in a position corresponding to second (j=1) M_{A,c} in the Type-1 HARQ-ACK codebook. j is increased by 1 so that j=2. The SLIV of row 4 is excluded from set R, and thus set R is an empty set. Therefore, operation 3-2 may end.
Operation 4: k is increased by 1 so that k=1. Since k=1 is smaller than the cardinality of set K1, which is 2, operation 1 is performed.
Operation 1: A k-th (k=1) largest K1 value is selected from configured set K1. In the example of FIG. 22, the K1 value is K1,0=−1.
Operation 2: If a symbol corresponding to start symbol and length information (SLIV) belonging to each row of set R and a symbol configured for uplink in a higher layer overlap in slot n−K_{1,1}=slot n+1, the row may be excluded from set R. Referring to FIG. 22 part [b], if some symbols of slot n+1 are semi-static UL symbols configured via a higher layer, rows including SLIVs overlapping the symbol may be excluded from set R. Referring to FIG. 22 part [b], all symbols of slot n+1 may not overlap semi-static uplink symbols. Therefore, set R may include rows 1, 2, 3, 4, and 5.
Operation 3-2 (if the terminal has UE capability of receiving more than one unicast PDSCH in one slot):

For an SLIV that ends first in determined set R and SLIVs which overlap the SLIV in time, j=2 is added as a new PDSCH reception candidate occasion to set M_{A,c}. Here, the SLIV that ends first is SLIV (0,4) of row 1, and the SLIVs overlapping the SLIV is SLIV (0,7) of row 2 and SLIV (0,14) of row 5. Therefore, if j=2 is added to M_{A,c}, and the terminal receives a PDSCH scheduled with SLIV (0,4) of row 1, SLIV (0,7) of row 2, or SLIV (0,14) of row 5, HARQ-ACK of the PDSCH may be included in a position corresponding to the third (j=2) M_{A,c} in the Type-1 HARQ-ACK codebook. j is increased by 1 so that j=3. The SLIVs of rows 1, 2, and 5 are excluded from set R so that R={3, 4}. Set R is not an empty set, and operation 3-2 is thus repeated.

For the SLIV that ends first in determined set R and the SLIVs which overlap the SLIV in time, j=3 is added as a new PDSCH reception candidate occasion to set M_{A,c}. Here, the SLIV that ends first is SLIV (7,4) of row 4, and an SLIV overlapping the SLIV is SLIV (7,7) of row 3. Therefore, if j=3 is added to M_{A,c}, and the terminal receives a PDSCH scheduled with SLIV (7,4) of row 4 or SLIV (7,7) of row 3, HARQ-ACK of the PDSCH may be included in a position corresponding to the fourth (j=3) M_{A,c} in the Type-1 HARQ-ACK codebook. j is increased by 1 so that j=4. The SLIVs of rows 3 and 4 are excluded from set R, and thus set R is an empty set. Therefore, operation 3-2 may end (FIG. 22 part [c]).
Operation 4: k is increased by 1 so that k=2. Since k=2 is equal to the cardinality of set K1, which is 2, pseudo-code 1 ends.

Therefore, referring to FIG. 22 part [c], the terminal may determine M_{A,c} of 4 PDSCH reception candidate occasions j=0, j=1, j=2, and j=3. The size of the Type-1 HARQ-ACK codebook may be determined according to the number of PDSCH reception candidate occasions. The actual number of bits per PDSCH reception candidate occasion may be determined according to a configuration, such as the number of transport blocks included in each PDSCH, the number of code block groups (CBGs) included in each PDSCH, or spatial bundling.

Referring to FIG. 22, a terminal transmits a PUCCH including a type-1 HARQ-ACK codebook in slot n. However, M_{A,c} of j=2 and j=3, corresponding to −1 as a K1 value, are slots after slot n. Therefore, in the type-1 HARQ-ACK codebook, HARQ-ACK information of M_{A,c} of j=2 and j=3, corresponding to −1 as the K1 value, may always be NACK. This is non-causal because HARQ-ACK of a PDSCH which will be received in a future slot is transmitted to a PUCCH of a past slot.

### Embodiment 1: Excluding a Non-Numerical K1 Value from Set K1

As an embodiment of the disclosure, only a numerical K1 value may be included in set K1. In other words, in obtained set K1, a value corresponding to a non-numerical K1 value may be excluded from set K1.

More specifically, the terminal may generate set K1 via the following.

If the terminal is configured to monitor DCI format 1_0 and is not configured to monitor DCI format 1_1 and DCI format 1_2, set K1 may be {1, 2, 3, 4, 5, 6, 7, 8} when the HARQ-ACK information is transmitted via an uplink with a subcarrier spacing of 15 kHz, 30 kHz, 60 kHz, or 120 kHz, set K1 may be {7, 8, 12, 16, 20, 24, 28, 32} when the HARQ-ACK information is transmitted in an uplink with a subcarrier spacing of 480 kHz, and set K1 may be {13, 16, 24, 32, 40, 48, 56, 64} when the HARQ-ACK information is transmitted in an uplink with a subcarrier spacing of 960 kHz.

If the terminal is configured to monitor DCI format 1_1 without being configured to monitor DCI format 1_2, set K1 may include values configured according to the first configuration, the second configuration, or the third configuration. Here, a numerical K1 value (applicable K1 value) among values of the third configurations may be included in set K1 if the third configuration is configured, a numerical K1 value (applicable K1 value) among values of the second configuration may be included in set K1 if the second configuration is configured without the third configuration being configured, and values of the first configuration may be included in set K1 if only the first configuration is configured.

If the terminal is configured to monitor DCI format 1_2 without being configured to monitor DCI format 1_1, set K1 may include values configured according to the fourth configuration or the fifth configuration. Here, if the fifth configuration is configured, values of the fifth configuration may be included in set K1, and if only the fourth configuration is configured, values of the fourth configuration may be included in set K1.

If the terminal is configured to monitor both DCI format 1_1 and DCI format 1_2, set K1 may be determined to be a union of configuration values of one of the fourth and fifth configurations and the numerical K1 value (applicable K1 value) among configuration values of one of the first, second, and third configurations. Here, one configuration among the first, second, and third configurations may be determined as follows. If the third configuration is configured, the third configuration may be the one configuration, if the second configuration is configured without the third configuration being configured, the second configuration may be the one configuration, and if only the first configuration is configured, the first configuration may be the one configuration. Here, one configuration among the fourth and fifth configurations may be determined as follows. If the fifth configuration is configured, the fifth configuration may be the one configuration, and if only the fourth configuration is configured, the fourth configuration may be the one configuration.

Obtained set K1 includes only numerical K1 values (applicable K1 values), a Type-1 HARQ-ACK codebook may be generated based on set K1.

The Type-1 HARQ-ACK codebook generated based on obtained set K1 cannot include HARQ-ACK information of a DCI format including a non-numerical K1 values (inapplicable K1 value). In other words, the terminal may not transmit a DCI format including a non-numerical K1 value (inapplicable K1 value) or HARQ-ACK information of a PDSCH related to the DCI format via the Type-1 HARQ-ACK codebook. The DCI format including a non-numerical K1 value (inapplicable K1 value) or the HARQ-ACK information of a PDSCH related to the DCI format may be transmitted via a separate HARQ-ACK codebook. The separate HARQ-ACK codebook may be a type-3 HARQ-ACK codebook. In other words, if DCI that triggers type-3 HARQ-ACK codebook transmission is received, the terminal may transmit the type-3 HARQ-ACK codebook in a slot indicated by the DCI. In this case, the type-3 HARQ-ACK codebook may include the DCI format including a non-numerical K1 value (inapplicable K1 value) or the HARQ-ACK information of a PDSCH related to the DCI format.

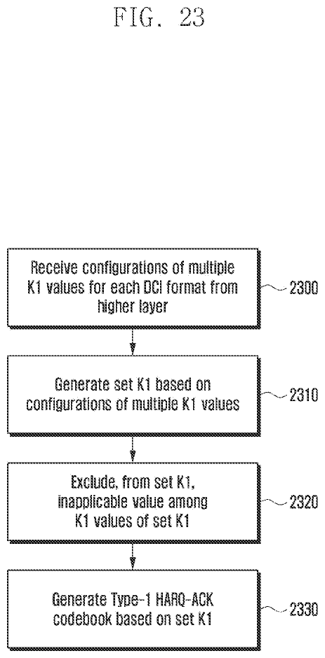

FIG. 23 is a diagram illustrating an operation of a terminal according to an embodiment of the disclosure.

Referring to FIG. 23, in a first operation 2300, a terminal may receive configurations of multiple K1 values for each DCI format from a higher layer. Here, the DCI format may include DCI format 1_0, DCI format 1_1, or DCI format 1_2. Here, the configurations of multiple K1 values may be received for each DCI format. For example, for DCI format 1_1, a first configuration, a second configuration, and a third configuration may be received. For example, for DCI format 1_2, a fourth configuration and a fifth configuration may be received.

In a second operation 2310, the terminal may generate set K1, based on the configurations of multiple K1 values. Descriptions of the generation method are provided in the above.

In a third operation 2320, the terminal may determine whether there is a non-numerical K1 value (inapplicable K1 value) among the K1 values of set K1 generated in the second operation, and if the non-numerical K1 value exists, the value may be excluded from set K1.

In a fourth operation 2330, the terminal may generate a Type-1 HARQ-ACK codebook, based on set K1 obtained in the third operation.

### Embodiment 1-1: Excluding Some Numerical K1 Values from Set K1

In embodiment 1 described above, a value corresponding to a non-numerical K1 value (inapplicable K1 value) is excluded from set K1. Further, by generalization, the terminal may exclude some K1 values from set K1. Here, some K1 values may include at least one of the following.

Non-Numerical K1 Value (Inapplicable K1 Value)

K1 values that do not satisfy a PDSCH processing procedure time

K1 values configured to be excluded (i.e., not used) from set K1 via a higher layer

Here, the PDSCH processing procedure time is a minimum time for the terminal to receive a PDSCH, generate valid HARQ-ACK information, and transmit the same via a PUCCH or a PUSCH, and may represented as follows.

T_{proc,1}=(N₁+d_{1,1}+d₂)(2048+144)κ2^{μ}T_{c}+Tₑₓₜ
N₁: The number of symbols determined according to UE processing capability 1 or 2 and numerology μ according to capability of the terminal. If UE processing capability 1 is reported according to a capability report of the terminal, N₂ may have values of Table 42, and if UE processing capability 2 is reported and it is configured, via higher layer signaling, that UE processing capability 2 is available, N₂ may have values of Table 43.

TABLE 42

| | PDSCH decoding time N₁ [symbols] | |
|---|---|---|
| | dmrs-AdditionalPosition = | dmrs-AdditionalPosition = |
| | ‘pos0’ in | ‘pos0’ in |
| | DMRS-DownlinkConfig in | DMRS-DownlinkConfig in |
| | dmrs-DownlinkForPDSCH- | dmrs-DownlinkForPDSCH- |
| | MappingTypeA and dmrs- | MappingTypeA and dmrs- |
| | DownlinkForPDSCH- | DownlinkForPDSCH- |
| | MappingTypeB if either higher | MappingTypeB if either higher |
| | layer parameter is configured, | layer parameter is configured, |
| | and in dmrs- | and in dmrs- |
| | DownlinkForPDSCH- | DownlinkForPDSCH- |
| | MappingTypeA-DCI-1-2 and | MappingTypeA-DCI-1-2 and |
| | dmrs-DownlinkForPDSCH- | dmrs-DownlinkForPDSCH- |
| | MappingTypeB-DCI-1-2 if | MappingTypeB-DCI-1-2 if |
| | either higher layer parameter is | either higher layer parameter is |
| μ | configured | configured |
| 0 | 8 | 8 |
| 1 | 10 | 10 |
| 2 | 17 | 17 |
| 3 | 20 | 20 |
| 5 | 80 | 80 |
| 6 | 160 | 160 |

TABLE 43

| | PDSCH decoding time N₁ [symbols] |
|---|---|
| | dmrs-AdditionalPosition = ‘pos0’ in |
| | DMRS-DownlinkConfig in |
| | dmrs-DownlinkForPDSCH-MappingTypeA and dmrs- |
| | DownlinkForPDSCH-MappingTypeB |
| | if either higher layer parameter is |
| | configured, and in dmrs-DownlinkForPDSCH- |
| | MappingTypeA-DCI-1-2 |
| | and dmrs-DownlinkForPDSCH- |
| | MappingTypeB-DCI-1-2 if either higher |
| μ | layer parameter is configured |
| 0 | 3 |
| 1 | 4.5 |
| 2 | 9 for frequency range 1 |

d_{1,1}: the number of symbols according to a length of PDSCH
κ: 64
μ: μ follows a value at which T_{proc,1} is larger among μ_{PDCCH}, μ_{PDSCH}, and μ_{UL}, μ_{PDCCH} refers to a numerology of a downlink in which a PDCCH including DCI for PDSCH scheduling is received, μ_{PDSCH} refers to a numerology of a downlink in which a PDSCH is received, and μ_{UL} refers to a numerology of an uplink in which a PUCCH or PUSCH for transmission of HARQ-ACK is transmitted.
   T_{c}: 1/(Δfₘₐₓ*N_{f}), Δfₘₐₓ=480*10³ Hz, where N_{f}=4096.
d₂: If OFDM symbols of a PUCCH having a low priority index and a PUSCH having a high priority index and a PUCCH overlap in time, a d₂ value of the PUSCH having the high priority index is used. Otherwise, d₂ is 0.
Tₑₓₜ: When the terminal uses a shared spectrum channel access scheme, the terminal calculates Tₑₓₜ to apply the same to a PUSCH preparation procedure time. Otherwise, Tₑₓₜ is assumed to be 0.

If a PDSCH does not satisfy a PDSCH processing procedure time, the terminal transmits invalid HARQ-ACK information for the PDSCH.

Therefore, if the terminal is indicated with a K1 value that does not satisfy the PDSCH processing procedure time, the terminal may assume that HARQ-ACK information corresponding to the K1 value is invalid HARQ-ACK information. Accordingly, K1 values that do not satisfy the PDSCH processing procedure time may be excluded from set K1. More specifically, when the number of symbols in one slot is N_{symbol}, the K1 values to be excluded from set K1 may be determined based on a ratio of N₁ and N_{symbol}. For example, if a K1 value is smaller than or is equal to or smaller than f(N₁/N_{symbol}), f(N₁+d_{1,1})/N_{symbol}), or f((N₁+d_{1,1}+d₁₂)/N_{symbol}), the K1 value may be excluded from set K1. Where f(x) may be at least one of f(x)=x, f(x)=floor(x), or f(x)=ceil(x).

A base station may configure, via a higher layer signal, some K1 values not to be used for generation of the Type-1 HARQ-ACK codebook. That is, the terminal may be configured with a value or values from a higher layer signal, and may exclude the value or values from set K1. Alternatively, the terminal may be configured K1 values included in set K1 from a higher layer. That is, unlike in the previous method of determining set K1, a higher layer may directly configure K1 values to be included in set K1. In this case, HARQ-ACK information of a DCI format including values other than those included in set K1 may not be transmitted via the Type-1 HARQ-ACK codebook.

### Embodiment 2: Defining Termination Conditions in Pseudo-Code

In an embodiment of the disclosure, when generating set K1, the terminal may generate set K1 by including a non-numerical K1 value (inapplicable K1 value), wherein whether a K1 value is a non-numerical K1 value is determined in a pseudo-code for generating a type-1 HARQ-ACK codebook. According to the determination, a PDSCH reception candidate occasion may be included for the numerical K1 value (applicable K1 value), but otherwise (i.e., the K1 value is a non-numerical K1 value (inapplicable K1 value)), a PDSCH reception candidate occasion may not be included.

For convenience, descriptions will be provide based on pseudo-code 1. However, the same may be applied to other pseudo-codes.

[Pseudo-Code 1: (No Repeated PDSCH Reception)—Adding NNK1—First Method]
Preparation operation: Set R is a set of scheduling information (slot information (hereinafter, K0 value) to which a PDSCH is mapped, and start symbol and length information (hereinafter, a starting and length value (SLIV)) configured in a time domain resource assignment (TDRA) table. If the terminal monitors one or more DCI formats, and the DCI formats use different TDRA tables, the set R is generated based on all TDRA tables.
Operation 0: M_{A,c} is initialized to an empty set. k is initialized to 0. j is initialized to 0.
Operation 1: A k-th largest K1 value is selected from configured set K1. (For example, if k=0, a largest K1 value is selected from the set K1, and if k=1, a second largest K1 value is selected from the set K1.) The K1 value is K_{1,k}. If the K1 value is a non-numerical K1 value (inapplicable K1 value), operation 4 is performed. If the K1 value is a numerical K1 value (applicable K1 value), subsequent operation 2 is performed.
Operation 2: If a symbol corresponding to start symbol and length information (SLIV) belonging to each row of set R and a symbol configured for uplink in a higher layer overlap in a slot (slot n−K1,k) corresponding to a value of K_{1,k}, the row may be excluded from set R.
Operation 3-1 (if the terminal has only UE capability of receiving a maximum of one unicast PDSCH in one slot): If determined set R is not an empty set, j is added as a new PDSCH reception candidate occasion to set M_{A,c}. When one of PDSCH candidates of set R is received, the terminal may place HARQ-ACK of the one PDSCH in the new PDSCH candidate occasion of j. j is increased by 1.
Operation 3-2 (if the terminal has UE capability of receiving more than one unicast PDSCH in one slot): For an SLIV that ends first in determined set R and SLIVs which overlap the SLIV in time, j is added as a new PDSCH reception candidate occasion to set M_{A,c}. When one of PDSCH candidates having the SLIV is received, the terminal may place HARQ-ACK of the one PDSCH in the new PDSCH candidate occasion of j. j is increased by 1. The SLIVs are excluded from set R. Operation 3-2 is repeated until set R becomes an empty set.
Operation 4: k is increased by 1. If k is smaller than the cardinality of set K1, operations are started again from operation 2, and if k is equal to or greater than the cardinality of set K1, pseudo-code 1 ends.

[End of Pseudo-Code 1]

When pseudo-code 1 is compared to previous pseudo-code 1, “if the K1 value is a non-numerical K1 value (inapplicable K1 value), operation 4 is performed. Otherwise (if the K1 value is a numerical K1 value (applicable K1 value)), subsequent operation 2 is performed” has been added in operation 1. That is, whenever a K1 value is selected from set K1, it may be determined whether the selected K1 value is a numerical K1 value or a non-numerical K1 value. For reference, since a non-numerical K1 value has a negative number, the conditions may be replaced as follows. “If the K1 value is smaller than 0, operation 4 is performed. Otherwise (if the K1 value is greater than or equal to 0), subsequent operation 2 is performed”.

The disclosure provides a method of generating a Type-1 HARQ-ACK codebook when a terminal is configured with an HARQ-ACK timing value including an inapplicable K1 value in a wireless communication system.

A terminal may be configured with an RRC parameter for HARQ-ACK timing from a higher layer. The RRC parameter may be divided into an applicable K1 value and an inapplicable K1 value. The terminal may be configured with a Type-1 HARQ-ACK codebook from a higher layer. Here, the terminal may generate the Type-1 HARQ-ACK codebook, based on the configured HARQ-ACK timing.

More specifically, the applicable K1 value may be determined to be 0 or a value greater than 0. The inapplicable K1 value may be determined to be a negative number. The terminal may generate the Type-1 HARQ-ACK codebook by using only the applicable K1 value. In addition, the terminal may not transmit, via the Type-1 HARQ-ACK codebook, HARQ-ACK of a PDSCH scheduled by DCI in which the inapplicable K1 value is indicated as a K1 value.

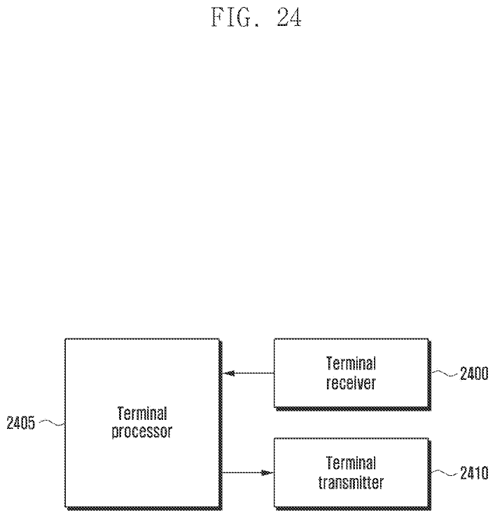

FIG. 24 is a diagram illustrating a structure of a terminal in the wireless communication system according to an embodiment of the disclosure.

Referring to FIG. 24, a terminal may include a transceiver which refers to a terminal receiver 2400 and a terminal transmitter 2410, a memory (not shown), and a terminal processor 2405 (or a terminal controller or processor). According to the communication method of the terminal described above, the transceiver 2400 or 2410, the memory, and the terminal processor 2405 of the terminal may operate. However, the elements of the terminal are not limited to the aforementioned examples. For example, the terminal may include more or fewer elements compared to the aforementioned elements. In addition, the transceiver, the memory, and the processor may be implemented in the form of one chip.

The transceiver may transmit a signal to or receive a signal from a base station. Here, the signal may include control information and data. To this end, the transceiver may include an RF transmitter configured to perform up-conversion and amplification of a frequency of a transmitted signal, an RF receiver configured to perform low-noise amplification of a received signal and down-conversion of a frequency, and the like. However, this is only an embodiment of the transceiver, and the elements of the transceiver are not limited to the RF transmitter and the RF receiver.

The transceiver may receive a signal and output the same to the processor via a radio channel and may transmit, via a radio channel, a signal output from the processor.

The memory may store a program and data necessary for operation of the terminal. The memory may store control information or data included in a signal transmitted or received by the terminal. The memory may include a storage medium or a combination of storage media, such as ROM, RAM, hard disk, CD-ROM, and DVD. There may be multiple memories.

The processor may control a series of procedures so that the terminal operates according to the aforementioned embodiments. For example, the processor may receive DCI including two layers and control the elements of the terminal to concurrently receive multiple PDSCHs. There may be multiple processors, and the processors may control the elements of the terminal by executing programs stored in the memory.

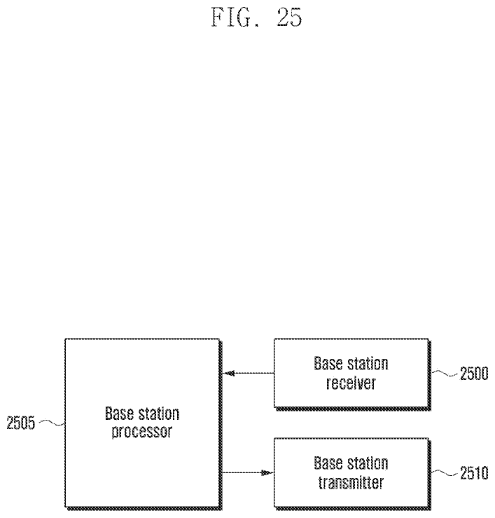

FIG. 25 is a diagram illustrating a structure of a base station in the wireless communication system according to an embodiment of the disclosure.

Referring to FIG. 25, a base station may include a transceiver, which refers to a base station receiver 2530 and a base station transmitter 2510, a memory (not shown), and a base station processor 2505 (or a base station controller or processor). According to the communication method of the base station described above, the transceiver (e.g., receiver 2500 or transmitter 2510), the memory, and the base station processor 2505 of the base station may operate. However, the elements of the base station are not limited to the above examples. For example, the base station may include more or fewer elements compared to the aforementioned elements. In addition, the transceiver, the memory, and the processor may be implemented in the form of one chip.

The transceiver may transmit a signal to or receive a signal from a terminal. Here, the signal may include control information and data. To this end, the transceiver may include an RF transmitter configured to perform up-conversion and amplification of a frequency of a transmitted signal, an RF receiver configured to perform low-noise amplification of a received signal and down-conversion of a frequency, and the like. However, this is only an embodiment of the transceiver, and the elements of the transceiver are not limited to the RF transmitter and the RF receiver.

The transceiver may receive a signal and output the same to the processor via a radio channel and may transmit, via a radio channel, a signal output from the processor.

The memory may store a program and data necessary for operation of the base station. The memory may store control information or data included in a signal transmitted or received by the base station. The memory may include a storage medium or a combination of storage media, such as ROM, RAM, hard disk, CD-ROM, and DVD. There may be multiple memories.

The processor may control a series of procedures so that the base station operates according to the aforementioned embodiments of the disclosure. For example, the processor may configure DCI of two layers including allocation information for multiple PDSCHs, and may control each element of the base station to transmit the DCI. There may be multiple processors, and the processors may control the elements of the base station by executing programs stored in the memory.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Further, the above respective embodiments may be employed in combination, as necessary. For example, a part of one embodiment of the disclosure may be combined with a part of another embodiment to operate a base station and a terminal. As an example, a part of embodiment 1 of the disclosure may be combined with a part of embodiment 2 to operate a base station and a terminal. Furthermore, although the above embodiments have been described based on the FDD LTE system, the embodiments may be applied to other communication systems, and other variants based on the technical idea of the embodiments may also be implemented in other systems such as TDD LTE, 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in the methods of the disclosure, some or all of the contents of each embodiment may be combined without departing from the essential spirit and scope of the disclosure.

While the disclosure has been shown and described. with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
receiving, from a base station, information on a list of timing values associated with a physical downlink shared channel (PDSCH) to hybrid automatic repeat request acknowledgement (HARQ-ACK);
receiving a PDSCH from the base station;
determining a set of slot timing values based on the information, wherein an inapplicable value in the list of timing values is excluded from the set of slot timing values; and
transmitting, to the base station, a physical uplink control channel (PUCCH) including a Type-1 HARQ-ACK codebook associated with the PDSCH based on the set of slot timing values.

2. The method of claim 1, wherein the inapplicable value in the list of timing values corresponds to a value −1.

3. The method of claim 1, wherein the Type-1 HARQ-ACK codebook included in the PUCCH transmitted in slot n is based on n−k, where k is a slot timing value from the set of slot timing values.

4. The method of claim 1,
wherein, in case that the UE is configured to monitor physical downlink control channel (PDCCH) for downlink control information (DCI) format 1_1 and is not configured to monitor PDCCH for DCI format 1_2, the list of timing values is configured based on one of three configurations associated with the DCI format 1_1, and
wherein two of the three configurations associated with the DCI format 1_1 includes the inapplicable value.

5. The method of claim 1, wherein, in case that the UE is configured to monitor PDCCH for DCI format 1_2 and is not configured to monitor PDCCH for downlink control information (DCI) format 1_1, the list of timing values is configured based on one of two configurations associated with the DCI format 1_2.

6. The method of claim 1,
wherein, in case that the UE is configured to monitor PDCCH for downlink control information (DCI) format 1_1 and DCI format 1_2, the list of timing values is configured based on a union of one of three configurations associated with the DCI format 1_1 and one of two configurations associated with the DCI format 1_2, and
wherein two of the three configurations associated with the DCI format 1_1 includes the inapplicable value.

7. A method performed by a base station in a communication system, the method comprising:
transmitting, to a user equipment (UE), information on a list of timing values associated with a physical downlink shared channel (PDSCH) to hybrid automatic repeat request acknowledgement (HARQ-ACK);
transmitting a PDSCH to the UE; and
receiving, from the UE, a physical uplink control channel (PUCCH) including a Type-1 HARQ-ACK codebook associated with the PDSCH based on a set of slot timing values based on a set of information, wherein an inapplicable value in the list of timing values is excluded from the set of slot timing values.

8. The method of claim 7, wherein the inapplicable value in the list of timing values corresponds to a value −1.

9. The method of claim 7, wherein the Type-1 HARQ-ACK codebook included in the PUCCH received in slot n is based on slot n−k, where k is a slot timing value from the set of slot timing values.

10. The method of claim 7,
wherein, in case that the UE is configured to monitor physical downlink control channel (PDCCH) for downlink control information (DCI) format 1_1 and is not configured to monitor PDCCH for DCI format 1_2, the list of timing values is configured based on one of three configurations associated with the DCI format 1_1, and
wherein two of the three configurations associated with the DCI format 1_1 includes the inapplicable value.

11. The method of claim 7, wherein, in case that the UE is configured to monitor PDCCH for downlink control information (DCI) format 1_2 and is not configured to monitor PDCCH for DCI format 1_1, the list of timing values is configured based on one of two configurations associated with the DCI format 1_2.

12. The method of claim 7,
wherein, in case that the UE is configured to monitor PDCCH for downlink control information (DCI) format 1_1 and DCI format 1_2, the list of timing values is configured based on a union of one of three configurations associated with the DCI format 1_1 and one of two configurations associated with the DCI format 1_2, and
wherein two of the three configurations associated with the DCI format 1_1 includes the inapplicable value.

13. A user equipment (UE) in a communication system, the UE comprising:
a transceiver; and
at least one processor configured to:
receive, from a base station, information on a list of timing values associated with a physical downlink shared channel (PDSCH) to hybrid automatic repeat request acknowledgement (HARQ-ACK),
receive a PDSCH from the base station,
determine a set of slot timing values based on the information, wherein an inapplicable value in the list of timing values is excluded from the set of slot timing values, and
transmit, to the base station, a physical uplink control channel (PUCCH) including a Type-1 HARQ-ACK codebook associated with the PDSCH based on the set of slot timing values.

14. The UE of claim 13, wherein the inapplicable value in the list of timing values corresponds to a value −1.

15. The UE of claim 13, wherein the Type-1 HARQ-ACK codebook included in the PUCCH transmitted in slot n is based on n−k, where k is a slot timing value from the set of slot timing values.

16. The UE of claim 13,
wherein, in case that the UE is configured to monitor physical downlink control channel (PDCCH) for downlink control information (DCI) format 1_1 and is not configured to monitor PDCCH for DCI format 1_2, the list of timing values is configured based on one of three configurations associated with the DCI format 1_1,
wherein, in case that the UE is configured to monitor PDCCH for DCI format 1_2 and is not configured to monitor PDCCH for DCI format 1_1, the list of timing values is configured based on one of two configurations associated with the DCI format 1_2,
wherein, in case that the UE is configured to monitor PDCCH for DCI format 1_1 and DCI format 1_2, the list of timing values is configured based on a union of one of three configurations associated with the DCI format 1_1 and one of two configurations associated with the DCI format 1_2, and
wherein two of the three configurations associated with the DCI format 1_1 includes the inapplicable value.

17. A base station in a communication system, the base station comprising:
a transceiver; and
at least one processor configured to:
transmit, to a user equipment (UE), information on a list of timing values associated with a physical downlink shared channel (PDSCH) to hybrid automatic repeat request acknowledgement (HARQ-ACK),
transmit a PDSCH to the UE, and
receive, from the UE, a physical uplink control channel (PUCCH) including a Type-1 HARQ-ACK codebook associated with the PDSCH based on a set of slot timing values based on the information, wherein an inapplicable value in the list of timing values is excluded from the set of slot timing values.

18. The base station of claim 17, wherein the inapplicable value in the list of timing values corresponds to a value −1.

19. The base station of claim 17, wherein the Type-1 HARQ-ACK codebook included in the PUCCH received in slot n is based on n−k, where k is a slot timing value from the set of slot timing values.

20. The base station of claim 17,
wherein, in case that the UE is configured to monitor physical downlink control channel (PDCCH) for downlink control information (DCI) format 1_1 and is not configured to monitor PDCCH for DCI format 1_2, the list of timing values is configured based on one of three configurations associated with the DCI format 1_1,
wherein, in case that the UE is configured to monitor PDCCH for DCI format 1_2 and is not configured to monitor PDCCH for DCI format 1_1, the list of timing values is configured based on one of two configurations associated with the DCI format 1_2,
wherein, in case that the UE is configured to monitor PDCCH for DCI format 1_1 and DCI format 1_2, the list of timing values is configured based on a union of one of three configurations associated with the DCI format 1_1 and one of two configurations associated with the DCI format 1_2, and
wherein two of the three configurations associated with the DCI format 1_1 includes the inapplicable value.
